(19) United States
(12) Patent Application Publication
(10) Pub. No.: US 2016/0173802 A1
(43) Pub. Date: Jun. 16, 2016

(54) SOLID-STATE IMAGING DEVICE, IMAGING APPARATUS, AND METHOD FOR DRIVING THE SAME

(71) Applicant: Panasonic Intellectual Property Management Co., Ltd., Osaka (JP)

(72) Inventors: JUNICHI MATSUO, Osaka (JP); SEI SUZUKI, Osaka (JP); TAKUYA ASANO, Hyogo (JP)

(21) Appl. No.: 15/047,609

(22) Filed: Feb. 18, 2016

Related U.S. Application Data
(63) Continuation of application No. PCT/JP2014/003076, filed on Jun. 10, 2014.

(30) Foreign Application Priority Data
Sep. 6, 2013 (JP) 2013-185724

(51) Int. Cl. H04N 5/378; H04N 5/376; H04N 5/235

(52) U.S. Cl. CPC H04N 5/378; H04N 5/2353; H04N 5/3765

(57) ABSTRACT

Provided are an imaging apparatus with reduced variations in ranging results and increased ranging precision, and its driving method. The imaging apparatus includes a near-infrared light source and a solid-state imaging device. The solid-state imaging device includes a photoelectric conversion region in which a plurality of photoelectric converters is arranged in a matrix, a plurality of vertical transfer units for transferring signal charges generated in the photoelectric converters in a direction perpendicular to a row direction of the photoelectric conversion region, a plurality of horizontal transfer units for transferring the signal charges in a direction horizontal to the row direction of the photoelectric conversion region, and a plurality of charge detectors for amplifying and outputting the signal charges. In one frame scanning period, a plurality of signal charges generated in one of the plurality of photoelectric converters is individually output from an identical one of the plurality of charge detectors.

### BACKGROUND OF THE INVENTION

1. Field of the Invention

The present disclosure relates to imaging apparatuses for acquiring images of a subject present in a predetermined range position (images for measuring a distance).

2. Description of the Related Art

In recent years, televisions, game machines, and the like have been equipped with distance measurement cameras for detecting movements of a subject's (person's) body or hands by irradiating an imaging target space with infrared light, for example. Solid-state imaging devices for acquiring images for measuring a distance used in the distance measurement cameras, so-called distance measurement image sensor, have been known (refer to PTL 1, for example).

A solid-state imaging device shown in PTL 1 includes, per pixel, one photoelectric converter and four packets (memory cells) 1004a, 1004b, 1004c, 1004d. The solid-state imaging device uses a TOF (Time Of Flight) method as the operating principle of a distance measurement camera, performs sampling four times on one cycle of irradiation light, and reads signals A1, A2, A3, A4, for example, into the respective packets, and stores signals A1, A2, A3, A4.

For uses in game machines, machine vision, and the like, in which subjects move at high speeds, distance measurement image sensors capable of operating at high frame rates have been demanded.

A solid-state imaging device shown in PTL 2 is a CCD (Charge Coupled Device) imaging element for acquiring visible images, and includes two horizontal transfer units and two charge detectors to increase the signal transfer rate to achieve a high frame rate.

### CITATION LIST

### Patent Literatures

PTL 1: Japanese Patent No. 3,723,215

PTL 2: Japanese Examined Patent Publication No. 1105-060303

There is a technology that makes the distance measurement image sensor in PTL 1 have a higher frame rate, using the technology in PTL 2, to increase the frame rate of distance measurement cameras. In this technology, signal charges A1 to A4 output from one photoelectric converter are output from different charge detectors provided in a solid-state imaging device, although signal charges A1 to A4 are output from the same photoelectric converter. For example, signal charge A1 is output from a second charge detector, and signal charge A2 from a first charge detector.

Since the charge detectors have variations in characteristics such as gains due to respective production variations, when signal charges A1 to A4 read from one photoelectric converter are output from different charge detectors, ranging results vary, degrading ranging precision.

### SUMMARY OF THE INVENTION

The present disclosure has been made in view of the above problem, and has an object of providing an imaging apparatus with reduced variations in ranging results and increased ranging precision and a method for driving the imaging apparatus.

In order to achieve the above object, an imaging apparatus according to an aspect of the present disclosure is an imaging apparatus that includes a near-infrared light source for emitting near-infrared light to a subject, and a solid-state imaging device for receiving incident light from the subject. The solid-state imaging device includes a photoelectric conversion region in which a plurality of photoelectric converters is arranged in a matrix, a plurality of vertical transfer units for transferring signal charges generated in the photoelectric converters in a direction perpendicular to a row direction of the photoelectric conversion region, a plurality of horizontal transfer units for transferring the signal charges in a direction horizontal to the row direction of the photoelectric conversion region, and a plurality of charge detectors for amplifying and outputting the signal charges. In one frame scanning period, a plurality of signal charges generated in one of the plurality of photoelectric converters is individually output from an identical one of the plurality of charge detectors.

According to this aspect, a frame rate can be increased without degrading ranging precision since the plurality of horizontal transfer units and the plurality of charge detectors are provided, and a plurality of signal charges read from one photoelectric converter is output from the same charge detector in one frame scanning period.

According to the present disclosure, an imaging apparatus with reduced variations in ranging results and increased ranging precision and a method for driving the imaging apparatus can be provided.

### BRIEF DESCRIPTION OF DRAWINGS

FIG. 1 is a schematic configuration diagram of a common distance measurement camera using a TOF method;

FIG. 2 is a first timing chart showing a general operation of the distance measurement camera in FIG. 1;

FIG. 3 is a diagram showing an operating principle of a first TOF method based on the timing chart in FIG. 2;

FIG. 4 is a second timing chart showing a general operation of the distance measurement camera in FIG. 1;

FIG. 5 is a diagram showing an operating principle of a second TOF method based on the timing chart in FIG. 4;

FIG. 6 is a diagram showing an operating principle of a third TOF method based on the timing chart in FIG. 4;

FIG. 7 is a plan view showing a configuration of a solid-state imaging device according to PTL 1;

FIG. 8 is a plan view showing a configuration of a solid-state imaging device according to PTL 2;

FIG. 9 is a plan view showing a configuration of a solid-state imaging device according to a conventional art;

FIG. 10 is a plan view showing an operation in a signal readout period of the solid-state imaging device in FIG. 9;

FIG. 11A is a plan view showing an operation in a horizontal scanning period of the solid-state imaging device in FIG. 9;

FIG. 11B is a plan view showing an operation in the horizontal scanning period of the solid-state imaging device in FIG. 9;

FIG. 11C is a plan view showing an operation in the horizontal scanning period of the solid-state imaging device in FIG. 9;

FIG. 11D is a plan view showing an operation in the horizontal scanning period of the solid-state imaging device in FIG. 9;

FIG. 12 is a schematic configuration diagram of a distance measurement camera using a solid-state imaging device;

FIG. 13A is a plan view showing a configuration of a solid-state imaging device according to a first exemplary embodiment;

FIG. 13B is a plan view showing a part of the configuration of the solid-state imaging device according to the first exemplary embodiment;

FIG. 14 is a plan view showing an operation in a signal readout period of the solid-state imaging device in FIG. 13B;

FIG. 15A is a plan view showing an operation in a horizontal scanning period of the solid-state imaging device in FIG. 13B;

FIG. 15B is a plan view showing an operation in the horizontal scanning period of the solid-state imaging device in FIG. 13B;

FIG. 15C is a plan view showing an operation in the horizontal scanning period of the solid-state imaging device in FIG. 13B;

FIG. 15D is a plan view showing an operation in the horizontal scanning period of the solid-state imaging device in FIG. 13B;

FIG. 15E is a plan view showing an operation in the horizontal scanning period of the solid-state imaging device in FIG. 13B;

FIG. 16 is a plan view showing a configuration of a solid-state imaging device according to a second exemplary embodiment;

FIG. 17 is a plan view showing an operation in a signal readout period of the solid-state imaging device in FIG. 16;

FIG. 18A is a plan view showing an operation in a horizontal scanning period of the solid-state imaging device in FIG. 16;

FIG. 18B is a plan view showing an operation in the horizontal scanning period of the solid-state imaging device in FIG. 16;

FIG. 18C is a plan view showing an operation in the horizontal scanning period of the solid-state imaging device in FIG. 16;

FIG. 18D is a plan view showing an operation in the horizontal scanning period of the solid-state imaging device in FIG. 16;

FIG. 18E is a plan view showing an operation in the horizontal scanning period of the solid-state imaging device in FIG. 16;

FIG. 19 is a plan view showing a configuration of a solid-state imaging device according to a third exemplary embodiment;

FIG. 20A is a plan view showing an operation in a signal readout period in a first frame scanning period of the solid-state imaging device in FIG. 19;

FIG. 20B is a plan view showing an operation in the signal readout period in the first frame scanning period of the solid-state imaging device in FIG. 19;

FIG. 20C is a plan view showing an operation in the signal readout period in the first frame scanning period of the solid-state imaging device in FIG. 19;

FIG. 20D is a plan view showing an operation in the signal readout period in the first frame scanning period of the solid-state imaging device in FIG. 19;

FIG. 21A is a plan view showing an operation in a horizontal scanning period in the first frame scanning period of the solid-state imaging device in FIG. 19;

FIG. 21B is a plan view showing an operation in the horizontal scanning period in the first frame scanning period of the solid-state imaging device in FIG. 19;

FIG. 21C is a plan view showing an operation in the horizontal scanning period in the first frame scanning period of the solid-state imaging device in FIG. 19;

FIG. 21D is a plan view showing an operation in the horizontal scanning period in the first frame scanning period of the solid-state imaging device in FIG. 19;

FIG. 21E is a plan view showing an operation in the horizontal scanning period in the first frame scanning period of the solid-state imaging device in FIG. 19;

FIG. 21F is a plan view showing an operation in the horizontal scanning period in the first frame scanning period of the solid-state imaging device in FIG. 19;

FIG. 21G is a plan view showing an operation in the horizontal scanning period in the first frame scanning period of the solid-state imaging device in FIG. 19;

FIG. 21H is a plan view showing an operation in the horizontal scanning period in the first frame scanning period of the solid-state imaging device in FIG. 19;

FIG. 21I is a plan view showing an operation in the horizontal scanning period in the first frame scanning period of the solid-state imaging device in FIG. 19;

FIG. 21J is a plan view showing an operation in the horizontal scanning period in the first frame scanning period of the solid-state imaging device in FIG. 19;

FIG. 21K is a plan view showing a configuration of a solid-state imaging device according to the third exemplary embodiment;

FIG. 21L is a plan view showing an operation in a signal readout period in a second frame scanning period of the solid-state imaging device in FIG. 21K;

FIG. 21M is a plan view showing an operation in the signal readout period in the second frame scanning period of the solid-state imaging device in FIG. 21K;

FIG. 21N is a plan view showing an operation in a horizontal scanning period in the second frame scanning period of the solid-state imaging device in FIG. 21K;

FIG. 21O is a plan view showing an operation in the horizontal scanning period in the second frame scanning period of the solid-state imaging device in FIG. 21K;

FIG. 21P is a plan view showing an operation in the horizontal scanning period in the second frame scanning period of the solid-state imaging device in FIG. 21K;

FIG. 21Q is a plan view showing an operation in the horizontal scanning period in the second frame scanning period of the solid-state imaging device in FIG. 21K;

FIG. 22 is a plan view showing a configuration of a solid-state imaging device according to a fourth exemplary embodiment;

FIG. 23A is a plan view showing an operation in a signal readout period of the solid-state imaging device in FIG. 22;

FIG. 23B is a plan view showing an operation in the signal readout period of the solid-state imaging device in FIG. 22;

FIG. 23C is a plan view showing an operation in the signal readout period of the solid-state imaging device in FIG. 22;

FIG. 23D is a plan view showing an operation in the signal readout period of the solid-state imaging device in FIG. 22;

FIG. 24A is a plan view showing an operation in a horizontal scanning period of the solid-state imaging device in FIG. 22;

FIG. 24B is a plan view showing an operation in the horizontal scanning period of the solid-state imaging device in FIG. 22;

FIG. 24C is a plan view showing an operation in the horizontal scanning period of the solid-state imaging device in FIG. 22;

FIG. 24D is a plan view showing an operation in the horizontal scanning period of the solid-state imaging device in FIG. 22;

FIG. 24E is a plan view showing an operation in the horizontal scanning period of the solid-state imaging device in FIG. 22;

FIG. 25 is a plan view showing a configuration of a solid-state imaging device according to a fifth exemplary embodiment;

FIG. 26A is a plan view showing an operation in a signal readout period of the solid-state imaging device in FIG. 25;

FIG. 26B is a plan view showing an operation in the signal readout period of the solid-state imaging device in FIG. 25;

FIG. 26C is a plan view showing an operation in the signal readout period of the solid-state imaging device in FIG. 25;

FIG. 26D is a plan view showing an operation in the signal readout period of the solid-state imaging device in FIG. 25;

FIG. 26E is a plan view showing an operation in the signal readout period of the solid-state imaging device in FIG. 25;

FIG. 26F is a plan view showing an operation in the signal readout period of the solid-state imaging device in FIG. 25;

FIG. 26G is a plan view showing an operation in the signal readout period of the solid-state imaging device in FIG. 25;

FIG. 26H is a plan view showing an operation in the signal readout period of the solid-state imaging device in FIG. 25;

FIG. 26I is a plan view showing an operation in the signal readout period of the solid-state imaging device in FIG. 25;

FIG. 26J is a plan view showing an operation in the signal readout period of the solid-state imaging device in FIG. 25;

FIG. 27A is a plan view showing an operation in a horizontal scanning period of the solid-state imaging device in FIG. 25;

FIG. 27B is a plan view showing an operation in the horizontal scanning period of the solid-state imaging device in FIG. 25;

FIG. 27C is a plan view showing an operation in the horizontal scanning period of the solid-state imaging device in FIG. 25;

FIG. 27D is a plan view showing an operation in the horizontal scanning period of the solid-state imaging device in FIG. 25;

FIG. 27E is a plan view showing an operation in the horizontal scanning period of the solid-state imaging device in FIG. 25;

FIG. 27F is a plan view showing an operation in the horizontal scanning period of the solid-state imaging device in FIG. 25;

FIG. 27G is a plan view showing an operation in the horizontal scanning period of the solid-state imaging device in FIG. 25;

FIG. 27H is a plan view showing an operation in the horizontal scanning period of the solid-state imaging device in FIG. 25;

FIG. 27I is a plan view showing an operation in the horizontal scanning period of the solid-state imaging device in FIG. 25;

FIG. 27J is a plan view showing an operation in the horizontal scanning period of the solid-state imaging device in FIG. 25;

FIG. 27K is a plan view showing an operation in the horizontal scanning period of the solid-state imaging device in FIG. 25;

FIG. 28A is a plan view showing a configuration of a solid-state imaging device according to a sixth exemplary embodiment;

FIG. 28B is a plan view showing a part of the configuration of the solid-state imaging device according to the sixth exemplary embodiment;

FIG. 29A is a plan view showing an operation in a signal readout period of the solid-state imaging device in FIG. 28B;

FIG. 29B is a plan view showing an operation in the signal readout period of the solid-state imaging device in FIG. 28B;

FIG. 29C is a plan view showing an operation in the signal readout period of the solid-state imaging device in FIG. 28B;

FIG. 29D is a plan view showing an operation in the signal readout period of the solid-state imaging device in FIG. 28B;

FIG. 29E is a plan view showing an operation in the signal readout period of the solid-state imaging device in FIG. 28B;

FIG. 30A is a plan view showing an operation in a horizontal scanning period of the solid-state imaging device in FIG. 28B;

FIG. 30B is a plan view showing an operation in the horizontal scanning period of the solid-state imaging device in FIG. 28B;

FIG. 30C is a plan view showing an operation in the horizontal scanning period of the solid-state imaging device in FIG. 28B;

FIG. 30D is a plan view showing an operation in the horizontal scanning period of the solid-state imaging device in FIG. 28B;

FIG. 30E is a plan view showing an operation in the horizontal scanning period of the solid-state imaging device in FIG. 28B;

FIG. 30F is a plan view showing an operation in the horizontal scanning period of the solid-state imaging device in FIG. 28B;

FIG. 30G is a plan view showing an operation in the horizontal scanning period of the solid-state imaging device in FIG. 28B;

FIG. 30H is a plan view showing an operation in the horizontal scanning period of the solid-state imaging device in FIG. 28B;

FIG. 30I is a plan view showing an operation in the horizontal scanning period of the solid-state imaging device in FIG. 28B;

FIG. 30J is a plan view showing an operation in the horizontal scanning period of the solid-state imaging device in FIG. 28B;

FIG. 30K is a plan view showing an operation in the horizontal scanning period of the solid-state imaging device in FIG. 28B;

FIG. 31 is a plan view showing a configuration of a solid-state imaging device according to a seventh exemplary embodiment;

FIG. 32A is a plan view showing a configuration of a solid-state imaging device according to an eighth exemplary embodiment;

FIG. 32B is a plan view showing a part of the configuration of the solid-state imaging device according to the eighth exemplary embodiment;

FIG. 33 is a plan view showing an operation in a signal readout period of the solid-state imaging device in FIG. 32B;

FIG. 34A is a plan view showing an operation in a horizontal scanning period of the solid-state imaging device in FIG. 32B;

FIG. 34B is a plan view showing an operation in the horizontal scanning period of the solid-state imaging device in FIG. 32B;

FIG. 34C is a plan view showing an operation in the horizontal scanning period of the solid-state imaging device in FIG. 32B;

FIG. 35A is a plan view showing a configuration of a solid-state imaging device according to a ninth exemplary embodiment;

FIG. 35B is a plan view showing a part of the configuration of the solid-state imaging device according to the ninth exemplary embodiment;

FIG. 36A is a plan view showing an operation in a signal readout period in a first frame scanning period of the solid-state imaging device in FIG. 35A;

FIG. 36B is a plan view showing an operation in the signal readout period in the first frame scanning period of the solid-state imaging device in FIG. 35A;

FIG. 37A is a plan view showing an operation in a horizontal scanning period in the first frame scanning period of the solid-state imaging device in FIG. 35A;

FIG. 37B is a plan view showing an operation in the horizontal scanning period in the first frame scanning period of the solid-state imaging device in FIG. 35A;

FIG. 37C is a plan view showing an operation in the horizontal scanning period in the first frame scanning period of the solid-state imaging device in FIG. 35A; and

FIG. 37D is a plan view showing an operation in the horizontal scanning period in the first frame scanning period of the solid-state imaging device in FIG. 35A.

### DETAILED DESCRIPTION OF THE PREFERRED EMBODIMENTS

(Findings Underlying the Present Disclosure)

Findings underlying the present disclosure will be described before exemplary embodiments of the present disclosure are described.

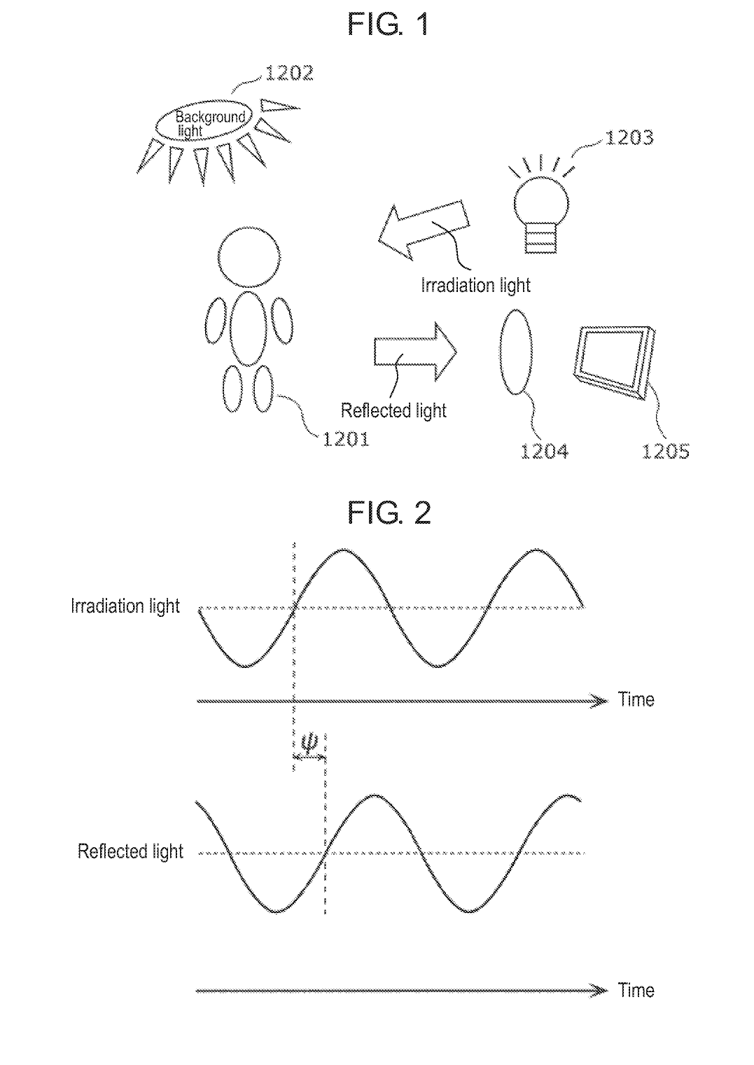

FIG. 1 is a schematic configuration diagram of a common distance measurement camera that operates by a TOF method.

As shown in FIG. 1, near-infrared light is emitted from infrared light source 1203 to subject 1201 under background light 1202. The reflected light is received by solid-state imaging device 1205 through optical lens 1204, and an image formed on solid-state imaging device 1205 is converted into an electrical signal.

FIG. 2 is a first timing chart showing a general operation of a distance measurement camera. Irradiation light intensity-modulated by a high frequency is reflected by a subject, and the reflected light is input to a solid-state imaging device with phase delay Ψ. By measuring phase delay Ψ, a distance to the subject can be determined.

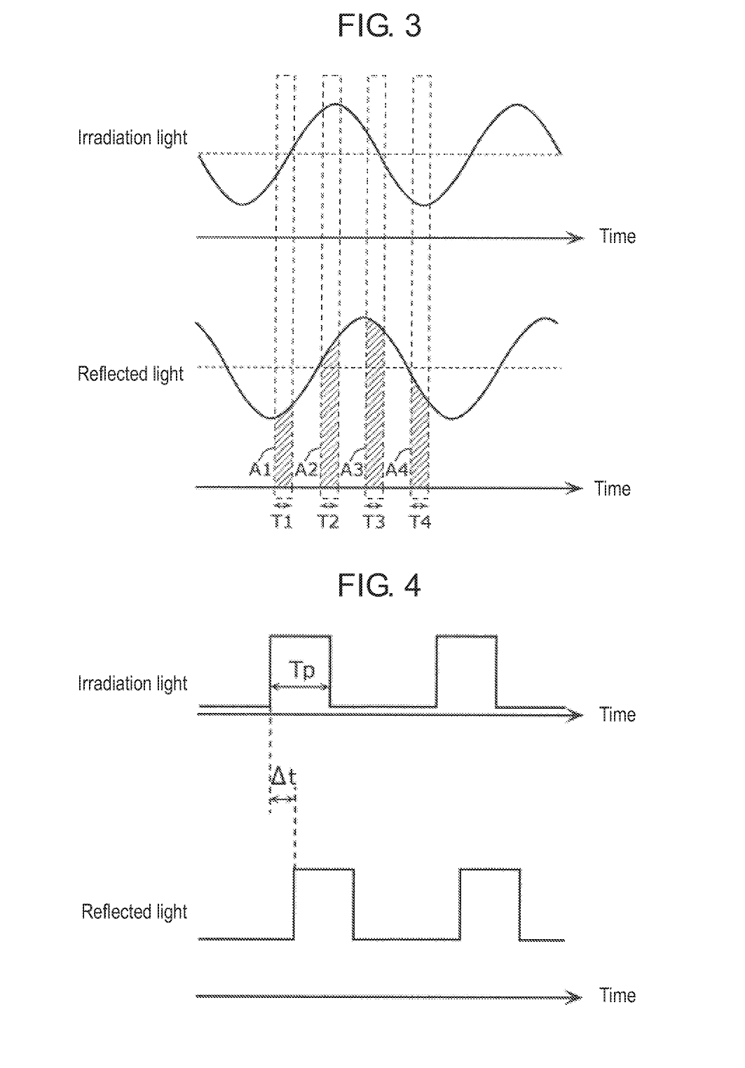

FIG. 3 is a diagram illustrating an operating principle of a distance measurement camera based on the timing chart in FIG. 2. Hereinafter, this operating principle is referred to as a first TOF method. As shown in FIG. 3, A1, A2, A3, A4 are signal amounts (signal charge amounts) acquired by the camera in exposure periods T1, T2, T3, T4 in which the phase of irradiation light is 0°, 90°, 180°, and 270°, respectively. Phase delay Ψ is given by the following expression:

Ψ=arctan {(A4−A2)/(A1−A3)}

FIG. 4 is a second timing chart showing a general operation of a distance measurement camera. Irradiation light with pulse width Tp is reflected by a subject, and the reflected light is input to a solid-state imaging device with delay time Δt. By measuring delay time Δt, a distance to the subject can be determined.

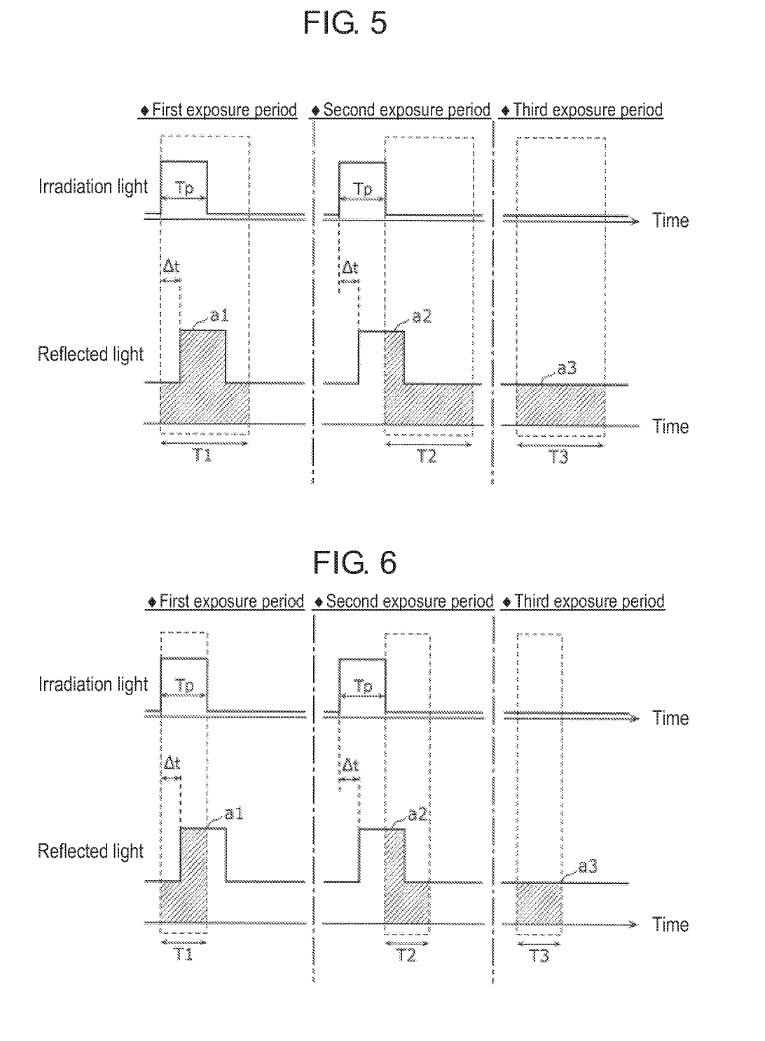

FIG. 5 is a diagram illustrating an operating principle of a distance measurement camera based on the timing chart in FIG. 4. Hereinafter, this operating principle is referred to as a second TOF method. As shown in FIG. 5, T1 is a first exposure period that starts from a rise time of irradiation light with pulse width Tp, T2 is a second exposure period that starts from a fall time of irradiation light, T3 is a third exposure period in which a near-infrared light source is turned off, and exposure periods T1 to T3 are set to a longer time than pulse width Tp. a1 is a signal amount (signal charge amount) acquired by the camera in first exposure period T1, a2 is a signal amount (signal charge amount) acquired by the camera in second exposure period T2, and a3 is a signal amount (signal charge amount) acquired by the camera in third exposure period T3. Delay time Δt is given by the following expression:

Δt=Tp{(a2−a3)/(a1−a3)}

FIG. 6 is a diagram illustrating an operating principle of a distance measurement camera based on the timing chart in FIG. 4. Hereinafter, this operating principle is referred to as a third TOF method. As shown in FIG. 6, T1 is a first exposure period that starts from a rise time of irradiation light with pulse width Tp, T2 is a second exposure period that starts from a fall time of irradiation light, T3 is a third exposure period in which a near-infrared light source is turned off, and exposure periods T1 to T3 are set to the same length as pulse width Tp. a1 is a signal amount (signal charge amount) acquired by the camera in first exposure period T1, a2 is a signal amount (signal charge amount) acquired by the camera in second exposure period T2, and a3 is a signal amount (signal charge amount) acquired by the camera in third exposure period T3. Delay time Δt is given by the following expression:

Δt=Tp{(a2−a3)/(a1+a2−2×a3)}

Solid-state imaging elements for use in distance measurement cameras using these TOF methods need to be able to perform sampling a plurality of times on one cycle of irradiation light.

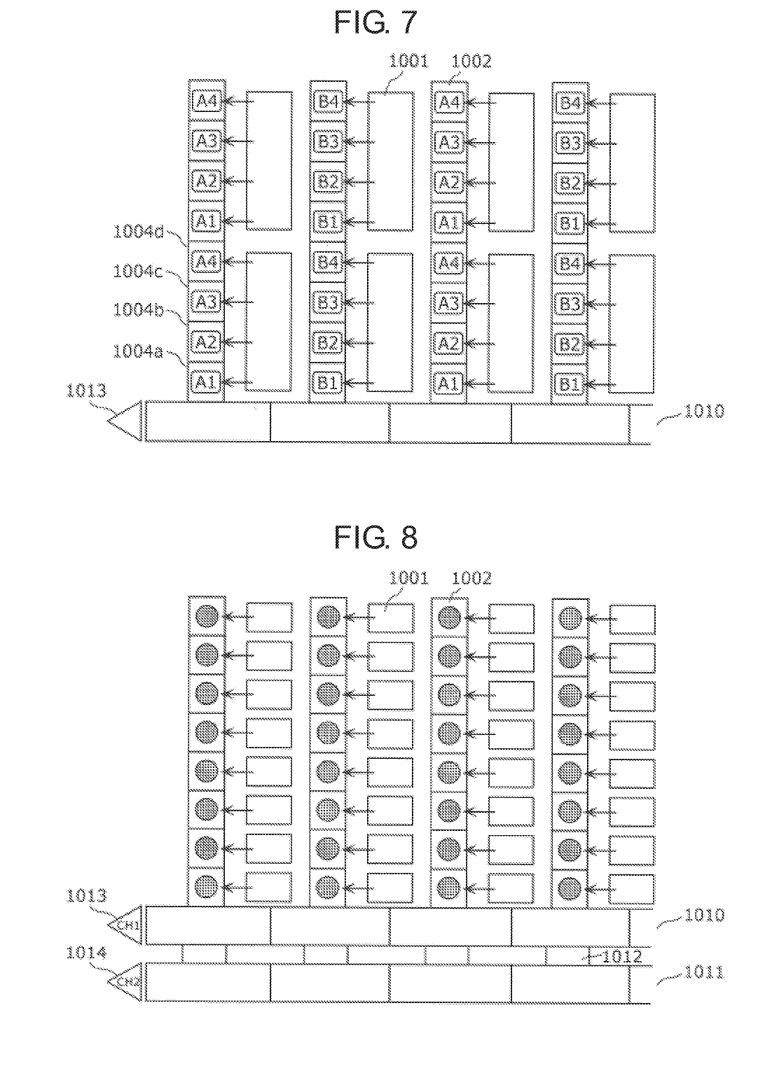

Here, the solid-state imaging device shown in PTL 1 discloses a configuration as in FIG. 7. The solid-state imaging device shown in FIG. 7 includes a plurality of photoelectric converters (photodiodes) 1001 that is arranged in a matrix on a semiconductor substrate and converts incident light into signal charges, vertical transfer units 1002 that correspond to respective photoelectric converters 1001 and transfer signal charges read from photoelectric converters 1001 in a column direction (vertical direction), horizontal transfer unit 1010 that transfers signal charges transferred by vertical transfer units 1002 in a row direction (horizontal direction), and charge detector 1013 that outputs signal charges transferred by horizontal transfer unit 1010.

The solid-state imaging device shown in PTL 1 uses the first TOF method, and includes, per pixel, one photoelectric converter and four packets (memory cells) 1004a, 1004b, 1004c, 1004d. The solid-state imaging device performs sampling four times on one cycle of irradiation light, and reads signals A1, A2, A3, A4, for example, into the respective packets, and stores signals A1, A2, A3, A4.

For uses in game machines, machine vision, and the like, in which subjects move at high speeds, distance measurement image sensors capable of operating at high frame rates have been demanded.

The solid-state imaging device shown in PTL 2 discloses a configuration as in FIG. 8. The solid-state imaging device shown in FIG. 8 includes a plurality of photoelectric converters 1001 that is arranged in a matrix on a semiconductor substrate and converts incident light into signal charges, vertical transfer units 1002 that correspond to respective photoelectric converters 1001 and transfer signal charges read from photoelectric converters 1001 in a column direction, first horizontal transfer unit 1010 and second horizontal transfer unit 1011 that transfer signal charges transferred by vertical transfer units 1002 in a row direction, inter-horizontal transfer unit 1012 that is provided between first horizontal transfer unit 1010 and second horizontal transfer unit, and transfers signal charges from first horizontal transfer unit 1010 to second horizontal transfer unit 1011, first charge detector 1013 that outputs signal charges transferred by first horizontal transfer unit 1010, and second charge detector 1014 that outputs signal charges transferred by second horizontal transfer unit 1011.

The solid-state imaging device shown in FIG. 8 is a CCD imaging element for acquiring visible images, and includes two horizontal transfer units and two charge detectors. Specifically, the solid-state imaging device shown in FIG. 8 includes first horizontal transfer unit 1010 and second horizontal transfer unit 1011, and first charge detector 1013 and second charge detector 1014. With this, a signal transfer rate is increased, and a high frame rate is achieved.

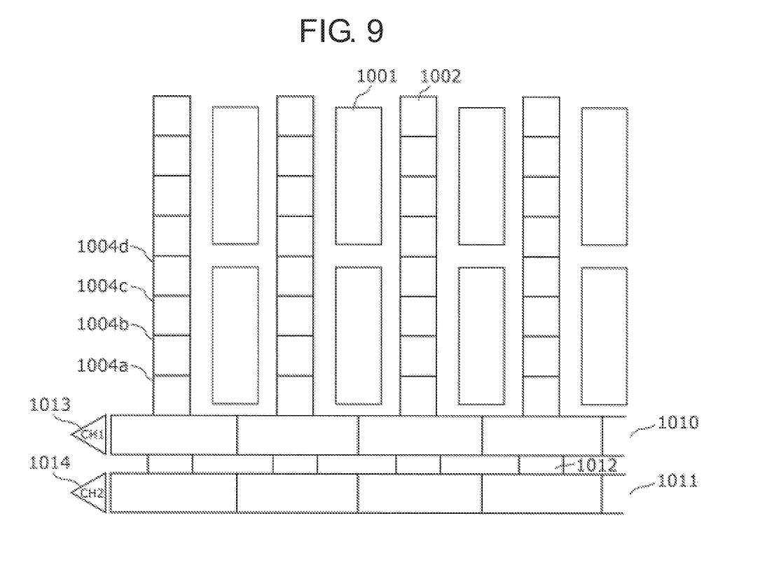

A solid-state imaging device shown in FIG. 9 shows an example in which the distance measurement image sensor disclosed in PTL 1 is made to have a higher frame rate using the technology disclosed in PTL 2, to increase a frame rate of a distance measurement camera.

The solid-state imaging device shown in FIG. 9 includes a plurality of photoelectric converters 1001 that is arranged in a matrix on a semiconductor substrate and converts incident light into signal charges, vertical transfer units 1002 that correspond to respective photoelectric converters 1001 and transfer signal charges read from photoelectric converters in a column direction, first horizontal transfer unit 1010 and second horizontal transfer units 1011 that transfer signal charges transferred by vertical transfer units 1002 in a row direction, inter-horizontal transfer unit 1012 that is provided between first horizontal transfer unit 1010 and second horizontal transfer unit 1011, and transfers signal charges from first horizontal transfer unit 1010 to second horizontal transfer unit 1011, first charge detector 1013 that outputs signal charges transferred by first horizontal transfer unit 1010, and second charge detector 1014 that outputs signal charges transferred by second horizontal transfer unit 1011.

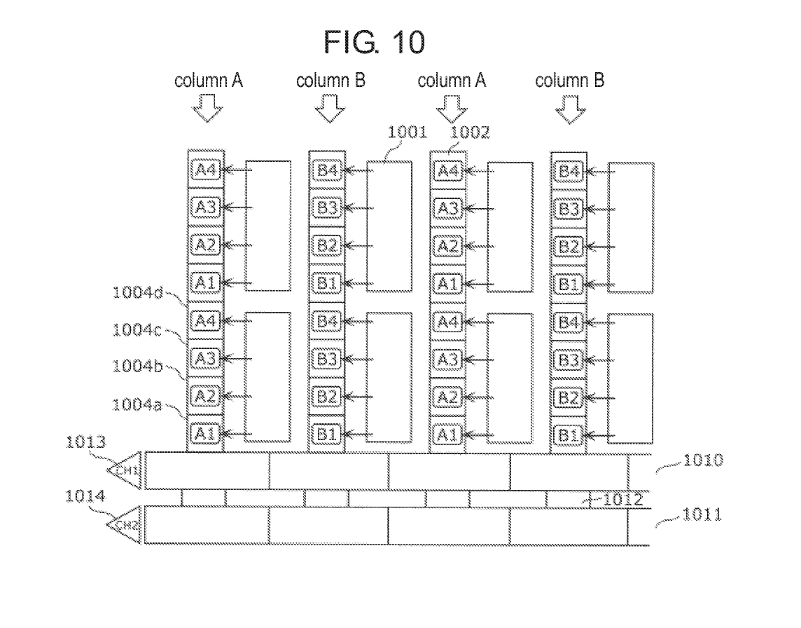

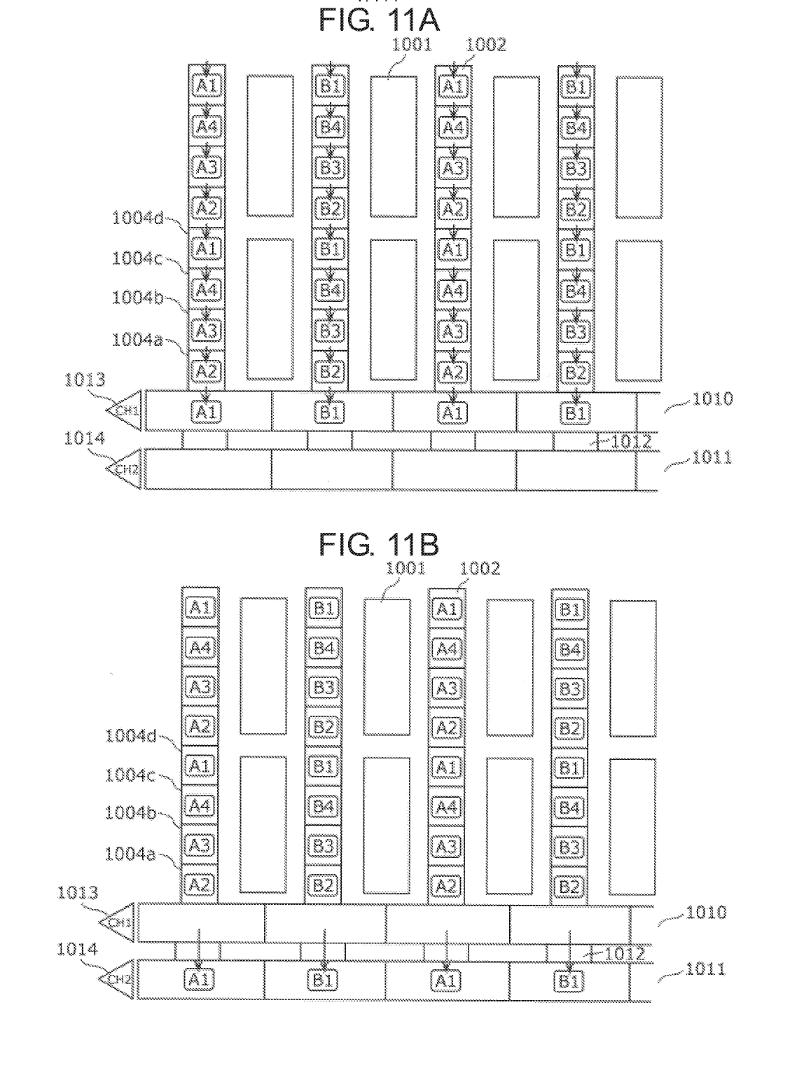

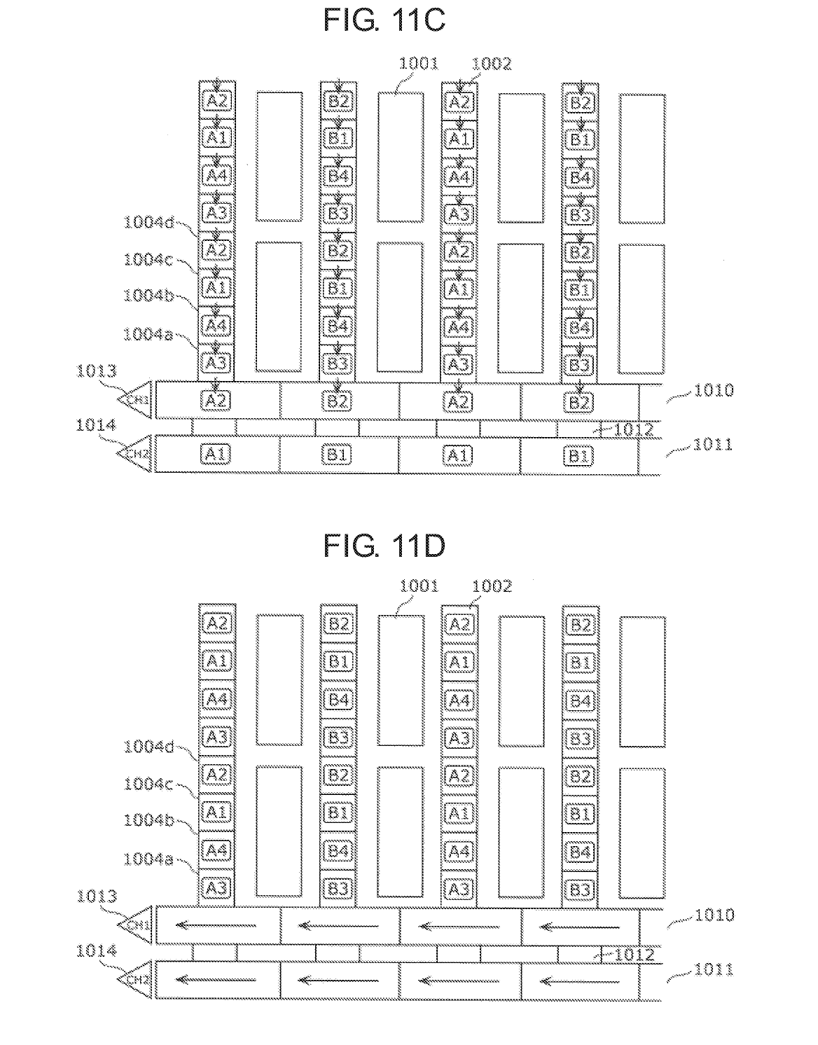

FIGS. 10 and 11A to 11D are diagrams showing an operation of the solid-state imaging device shown in FIG. 9, which uses the first TOF method. FIG. 10 shows a signal readout period, and FIGS. 11A to 11D show one cycle of a horizontal scanning period.

First, as shown in FIG. 10, signal charges are read from photoelectric converters 1001 into packets 1004a, 1004b, 1004c, 1004d and stored, to complete the readout period. Here, in the figure, A1, A2, A3, A4 are signal charges stored in vertical transfer units in rows A, and B1, B2, B3, B4 are signal charges stored in vertical transfer units 1002 in rows B.

In a horizontal transfer period, first, as shown in FIG. 11A, all signal charges stored in vertical transfer units 1002 are transferred one stage in a column direction. At this time, signal charges A1 and B1 stored in packets in vertical transfer units 1002 adjacent to first horizontal transfer unit 1010 are transferred from vertical transfer units to first horizontal transfer unit 1010.

Next, as shown in FIG. 11B, the signal charges A1 and B1 stored in first horizontal transfer unit 1010 are transferred through inter-horizontal transfer unit 1012 to second horizontal transfer unit 1011.

Next, as shown in FIG. 11C, all signal charges stored in vertical transfer units 1002 are transferred one stage in the column direction. At this time, signal charges A2 and B2 stored in packets in vertical transfer units 1002 adjacent to first horizontal transfer unit 1010 are transferred from vertical transfer units 1002 to first horizontal transfer unit 1010.

Thereafter, as shown in FIG. 11D, the signal charges stored in first horizontal transfer unit 1010 and second horizontal transfer unit 1011 are sequentially transferred to first charge detector 1013 and second charge detector 1014.

Here, when attention is paid to signal charges A1 to A4, signal charges A1 to A4 are output from different charge detectors (first charge detector 1013 and second charge detector 1014) provided in the solid-state imaging device, although signal charges A1 to A4 are output from the same photoelectric converters 1001. As shown in FIG. 11C, signal charges A1 are output from second charge detector 1014, and signal charges A2 are from first charge detector 1013. Likewise, in a subsequent horizontal scanning period, signal charges A3 are output from second charge detector 1014, and signal charges A4 are from first charge detector 1013. First charge detector 1013 and second charge detector 1014 have variations in characteristics such as gains due to respective production variations, which poses a problem that when signal charges A1 to A4 read from one photoelectric converter 1001 are output from different charge detectors, ranging results vary due to the characteristic variations of the charge detectors, degrading ranging precision.

Therefore, in a configuration provided with a plurality of horizontal transfer units and charge detectors like imaging devices shown in the following exemplary embodiments, by outputting a plurality of signal charges read from one photoelectric converter from the same charge detector, variations in ranging results are reduced and ranging precision is increased in an imaging device.

Hereinafter, exemplary embodiments to solve the above problem will be described with reference to the drawings. The exemplary embodiments will be described with reference to the accompanying drawings for the purpose of illustration, and are not intended to limit the present disclosure. In the drawings, elements showing substantially the same configurations, operations, and effects are denoted by the same reference numerals.

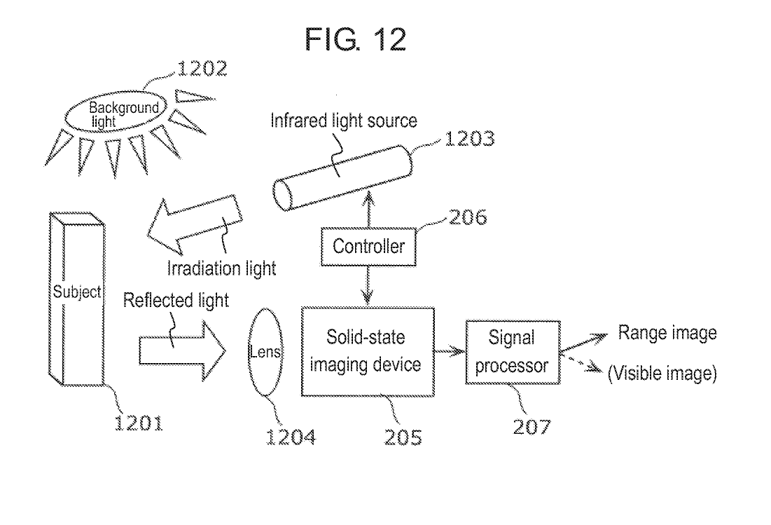

FIG. 12 is a schematic configuration diagram of a distance measurement camera provided with a solid-state imaging device. As shown in FIG. 12, near-infrared light is emitted from infrared light source 1203 to subject 1201 under background light 1202. The reflected light is received by solid-state imaging device 205 through optical lens 1204, and an image formed on solid-state imaging device 205 is converted into an electrical signal. Operations of infrared light source 1203 and solid-state imaging device 205 are controlled by controller 206. Output of solid-state imaging device 205 is converted into a image for measuring a distance by signal processor 207, and may also be converted into a visible image depending on a use. Infrared light source 1203, optical lens 1204, and solid-state imaging device 205 such as a CCD image sensor, constitute the distance measurement camera.

A solid-state imaging device as an exemplary embodiment of an imaging device preferably used in the above distance measurement camera will be described in first to ninth exemplary embodiments below.

### First Exemplary Embodiment

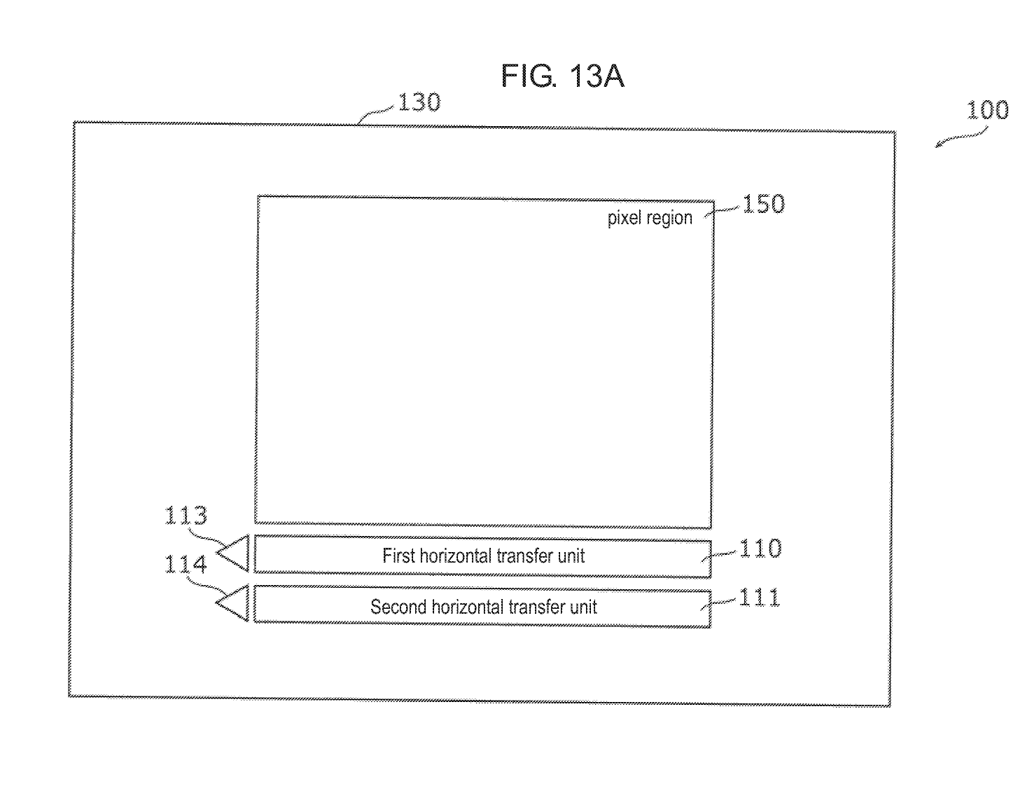

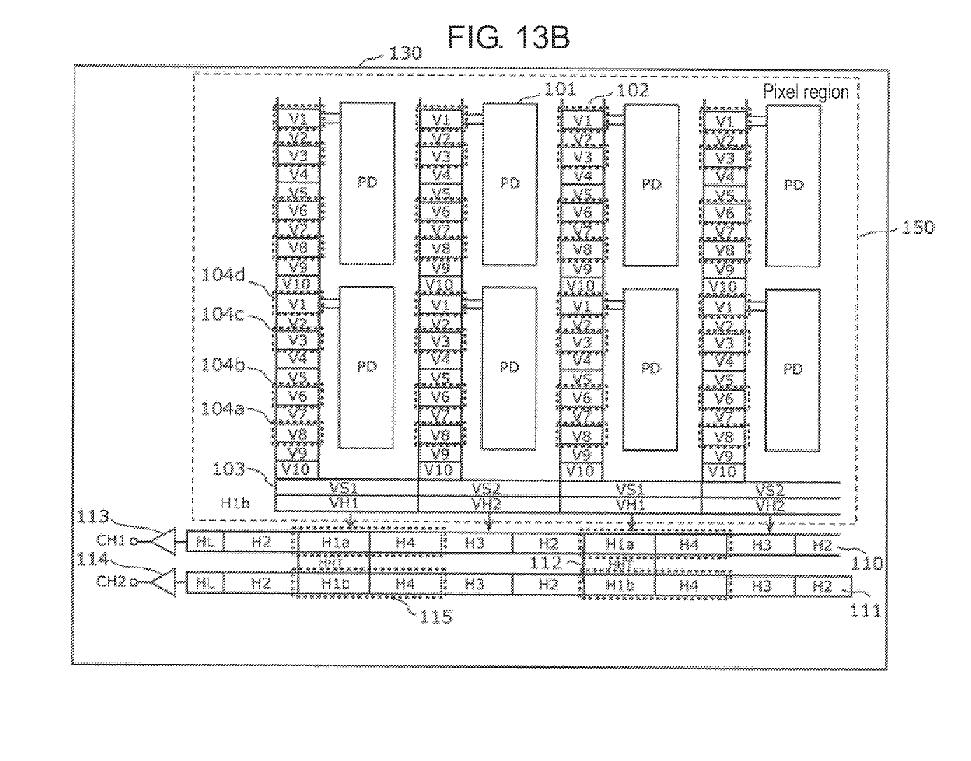

FIG. 13A is a schematic diagram showing a configuration of a solid-state imaging device according to a first exemplary embodiment. FIG. 13B is a diagram showing the configuration of the solid-state imaging device according to the first exemplary embodiment. In FIG. 13B, only components of two pixels in a vertical direction and of four pixels in a horizontal direction are shown for simplification.

As shown in FIG. 13A, solid-state imaging device 100 includes pixel region 150 on a semiconductor substrate, first horizontal transfer unit 110, second horizontal transfer unit 111, first charge detector 113, and second charge detector 114. VSUB electrode 130, to which a voltage to discharge signal charges all together to the semiconductor substrate is applied, is connected to the semiconductor substrate. In pixel region 150, a plurality of pixels is arranged in a matrix. Each pixel includes photoelectric converter 101 and vertical transfer unit 102 for photoelectric converter 101.

Specifically, as shown in FIG. 13B, solid-state imaging device 100 includes, in pixel region 150 on the semiconductor substrate, a plurality of photoelectric converters 101 that is arranged in a matrix and converts incident light into signal charges, vertical transfer units 102 that correspond to respective photoelectric converters 101, and transfer signal charges read from photoelectric converters 101 in a column direction, first horizontal transfer unit 110 and second horizontal transfer unit 111 that transfer signal charges transferred by vertical transfer units 102 in a row direction, charge controller 103 that is provided between vertical transfer units 102 and first horizontal transfer unit 110, and performs control to transfer signal charges to first horizontal transfer unit 110 at a given timing, inter-horizontal transfer unit 112 that is provided between first horizontal transfer unit 110 and second horizontal transfer unit 111, and transfers signal charges from first horizontal transfer unit 110 to second horizontal transfer unit 111, first charge detector 113 that outputs signal charges transferred by first horizontal transfer unit 110, and second charge detector 114 that outputs signal charges transferred by second horizontal transfer unit 111.

Here, solid-state imaging device 100 is a CCD imaging element. For example, solid-state imaging device 100 is of a ten-phase drive system with ten electrodes provided per pixel in vertical transfer units 102. Solid-state imaging device 100 is provided with four packets 104a to 104d per photoelectric converter 101.

Charge controller 103 is provided with electrodes to control signal charges column by column. Solid-state imaging device 100 is of a four-phase drive system with four electrodes provided per two pixels in first horizontal transfer unit 110 and second horizontal transfer unit 111. Each of first horizontal transfer unit 110 and second horizontal transfer unit 111 is provided with one packet 115 per two vertical transfer units 102. One electrode constituting a part of inter-horizontal transfer unit 112 is provided per two pixels.

Each pixel (photoelectric converter 101) is provided with a vertical overflow drain (VOD) (not shown). In the configuration, when a high voltage is applied to VSUB electrode 130 connected to the substrate, signal charges of all pixels are discharged to the substrate together.

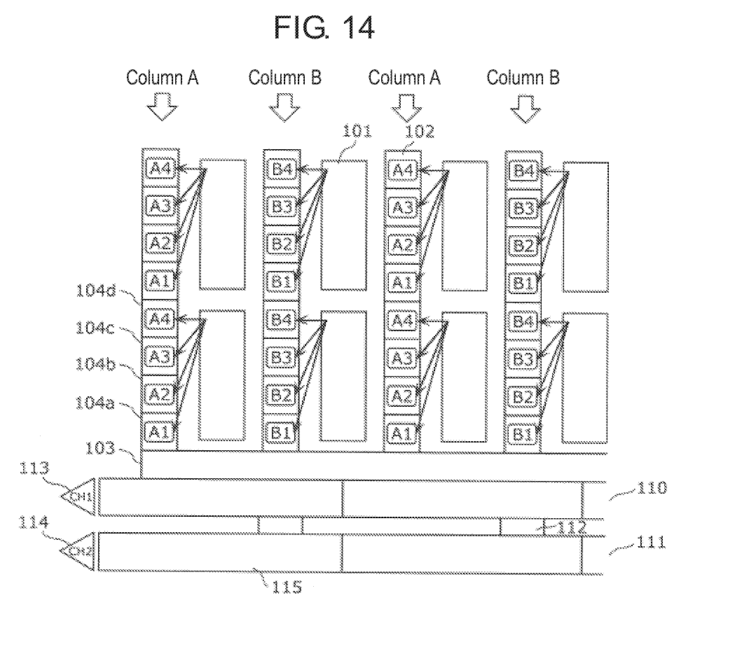

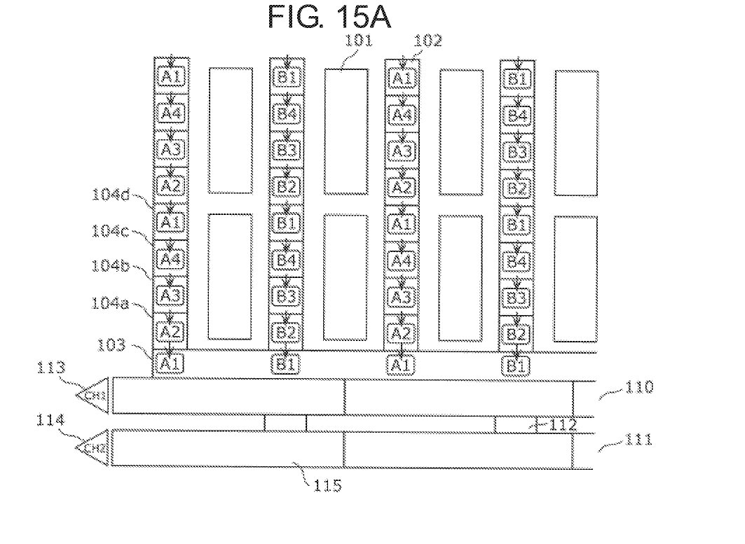

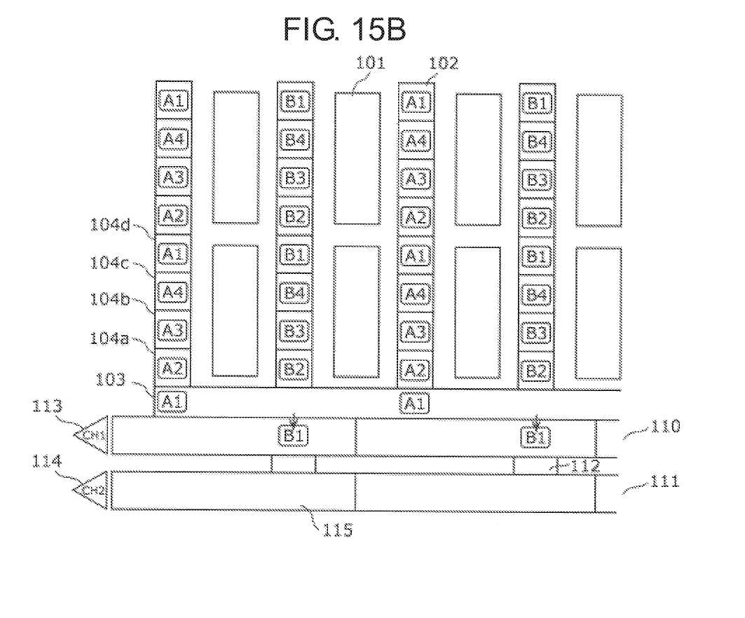

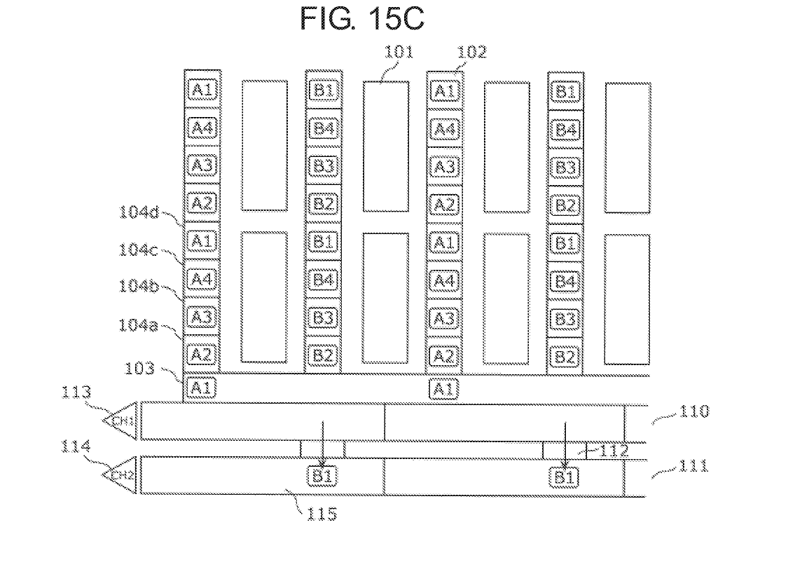

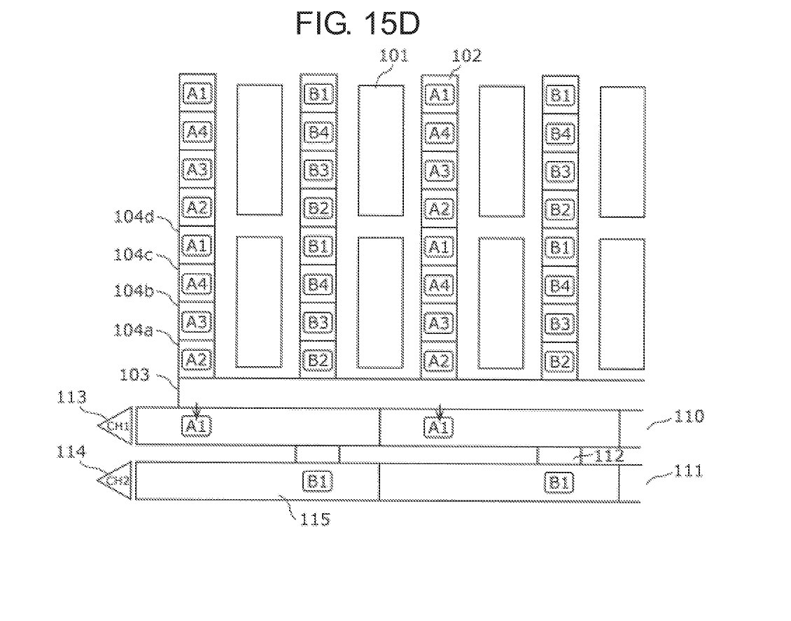

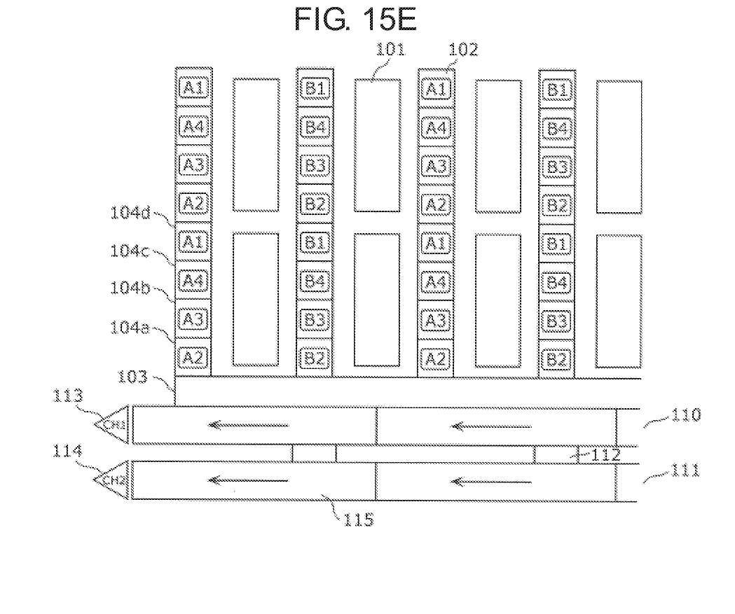

FIG. 14 and FIGS. 15A to 15E are plan views showing an operation of solid-state imaging device 100 shown in FIG. 13B, which uses the first TOF method. FIG. 14 shows an operation of solid-state imaging device in a signal readout period, and FIGS. 15A to 15E show an operation of solid-state imaging device 100 in one cycle of a horizontal scanning period.

First, as shown in FIG. 14, signal charges are read from photoelectric converters 101 into packets 104a, 104b, 104c, 104d and stored, to complete the readout period. Here, in the figure, A1, A2, A3, A4 are signal charges stored in vertical transfer units 102 in rows A, and B1, B2, B3, B4 are signal charges stored in vertical transfer units 102 in rows B.

In a horizontal transfer period, first, as shown in FIG. 15A, all signal charges stored in vertical transfer units 102 are transferred one stage in a column direction. At this time, signal charges A1 and B1 stored in packets in vertical transfer units 102 adjacent to charge controller 103 are transferred from vertical transfer units 102 to charge controller 103.

Next, as shown in FIG. 15B, only signal charges B1 of the signal charges stored in charge controller 103 are transferred to first horizontal transfer unit 110.

Next, as shown in FIG. 15C, signal charges B1 stored in first horizontal transfer unit 110 are transferred through inter-horizontal transfer unit 112 to second horizontal transfer unit 111.

Next, as shown in FIG. 15D, signal charges A1 stored in charge controller 103 are transferred to first horizontal transfer unit 110.

Thereafter, as shown in FIG. 15E, signal charges A1 and B1 stored in first horizontal transfer unit 110 and second horizontal transfer unit 111, respectively, are transferred to first charge detector 113 and second charge detector 114, respectively.

Here, when attention is paid to signal charges A1 to A4, as shown in FIG. 15D, signal charges A1 are output from first charge detector 113. Likewise, signal charges A2 to A4 output sequentially from a subsequent horizontal scanning period are all output from first charge detector 113. In solid-state imaging device 100 according to this exemplary embodiment including a horizontal transfer unit (first horizontal transfer unit 110 or second horizontal transfer unit 111) each including (½) packet 115 for one vertical transfer unit 102, and one inter-horizontal transfer unit 112, four signal charges read from one photoelectric converter 101 are output separately in four horizontal scanning periods without being added horizontally. That is, a horizontal transfer unit (first horizontal transfer unit 110 or second horizontal transfer unit 111) including (1/K) packet for one vertical transfer unit 102, and (L−1) inter-horizontal transfer unit 112 are provided, and M signal charges read from one photoelectric converter 101 are horizontally added in Ns, and are output separately in [(K·M)/(L·N)] horizontal scanning periods. When there is no horizontal addition of signal charges, N=1.

Signal charges output from solid-state imaging device 100 are converted into a image for measuring a distance by signal processor 207 (see FIG. 12), and may also be converted into a visible image depending on a use.

As above, solid-state imaging device 100 according to the first exemplary embodiment allows a plurality of signal charges read from one photoelectric converter 101 to be output from the same charge detector (first charge detector 113 or second charge detector 114) by first horizontal transfer unit 110 and second horizontal transfer unit 111 each including one packet 115 per two vertical transfer units 102. With this, a frame rate of a distance measurement camera can be increased without degrading ranging precision when solid-state imaging device 100 includes a plurality of horizontal transfer units (first horizontal transfer unit 110 and second horizontal transfer unit 111), and charge detectors (first charge detector 113 and second charge detector 114). With this, variations in ranging results can be reduced to increase ranging precision.

### Second Exemplary Embodiment

Next, a second exemplary embodiment will be described.

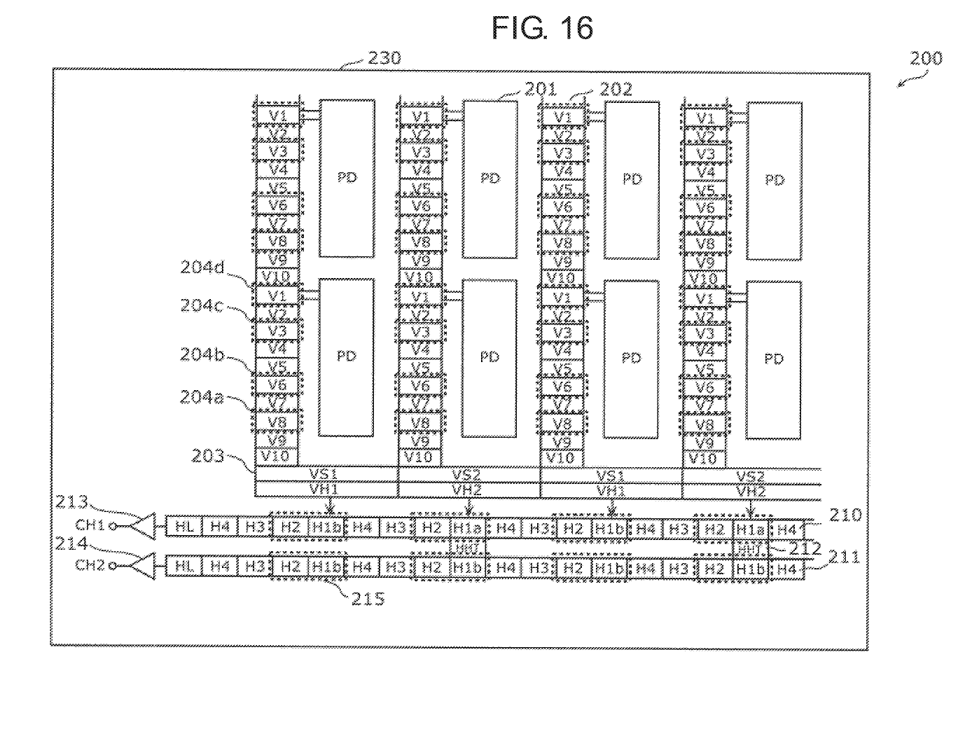

FIG. 16 is a configuration diagram of a solid-state imaging device according to the second exemplary embodiment. Here, only components of two pixels in a vertical direction and of four pixels in a horizontal direction are shown for simplification.

Compared to solid-state imaging device 100 according to the first exemplary embodiment, solid-state imaging device 200 according to the second exemplary embodiment is different in the configurations of first horizontal transfer unit 210 and second horizontal transfer unit 211, and due to it, is different in a driving method in a horizontal scanning period. However, solid-state imaging device 200 is the same as solid-state imaging device 100 according to the first exemplary embodiment in that solid-state imaging device 200 is aimed at providing a configuration and a driving method that allow a plurality of signal charges read from one photoelectric converter to be output from the same charge detector. Hereinafter, differences from the first exemplary embodiment will be mainly described, and the same points will not be described.

Compared to solid-state imaging device 100 shown in FIG. 13B, solid-state imaging device 200 shown in FIG. 16 is of a four-phase drive system with four electrodes provided per pixel in first horizontal transfer unit 210 and second horizontal transfer unit 211. First horizontal transfer unit 210 and second horizontal transfer unit 211 are each provided with one packet 215 per vertical transfer unit 202.

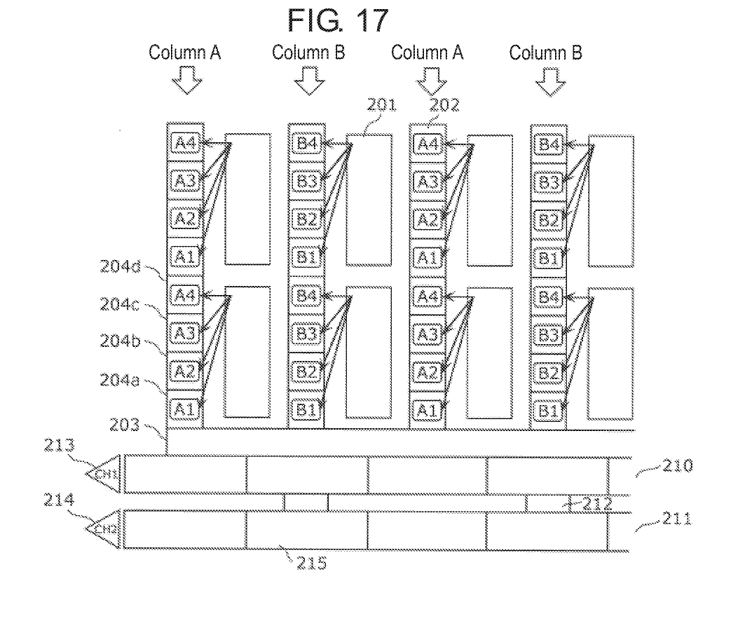

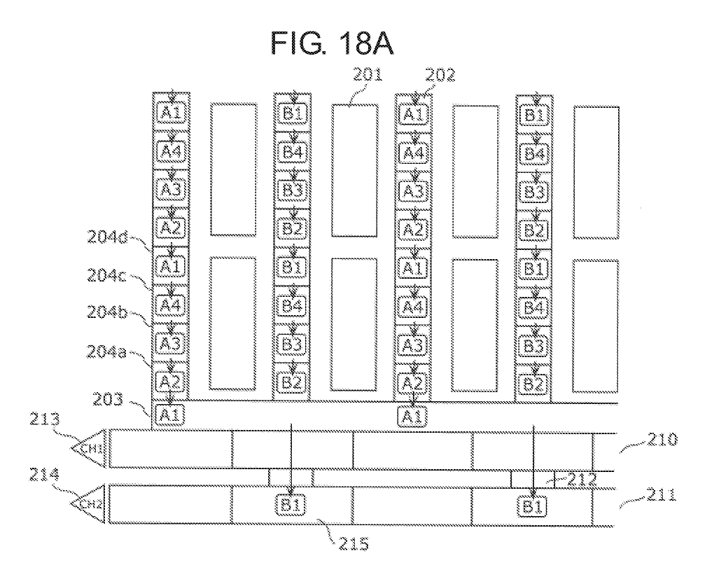

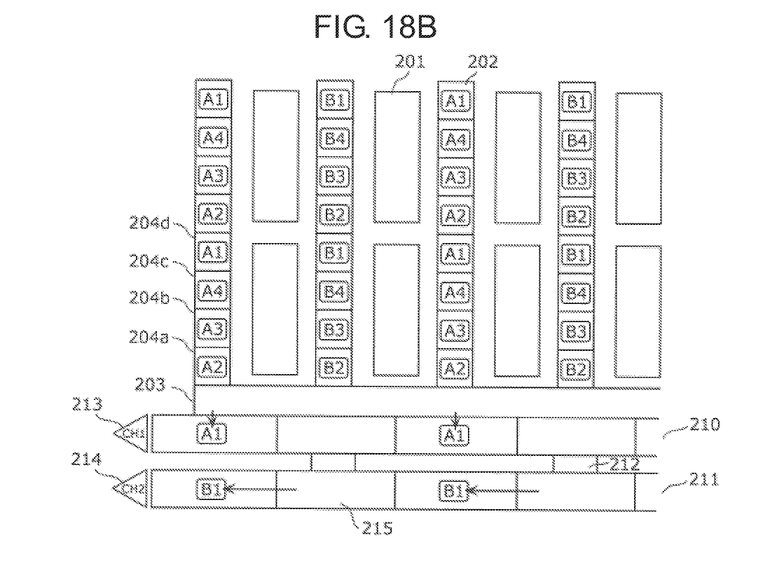

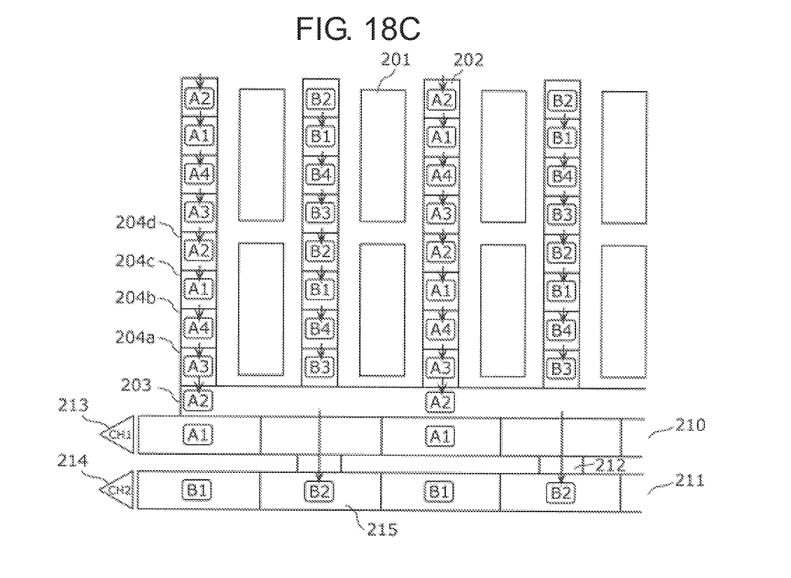

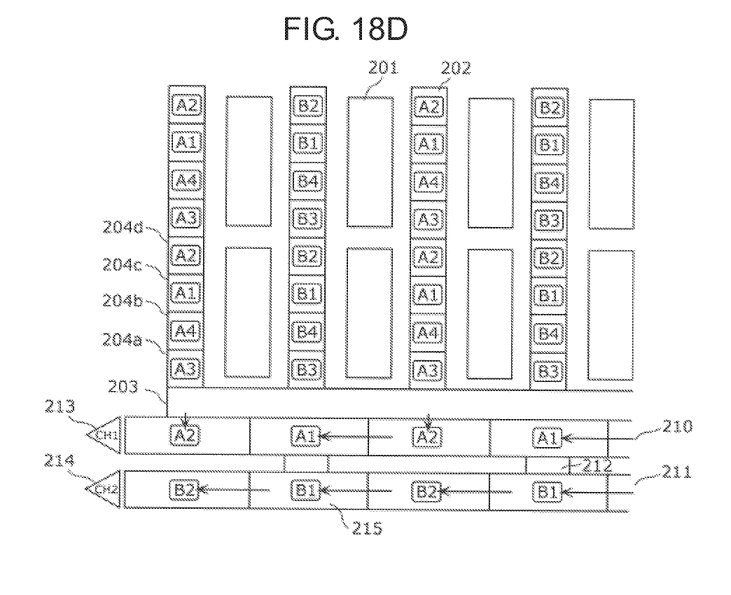

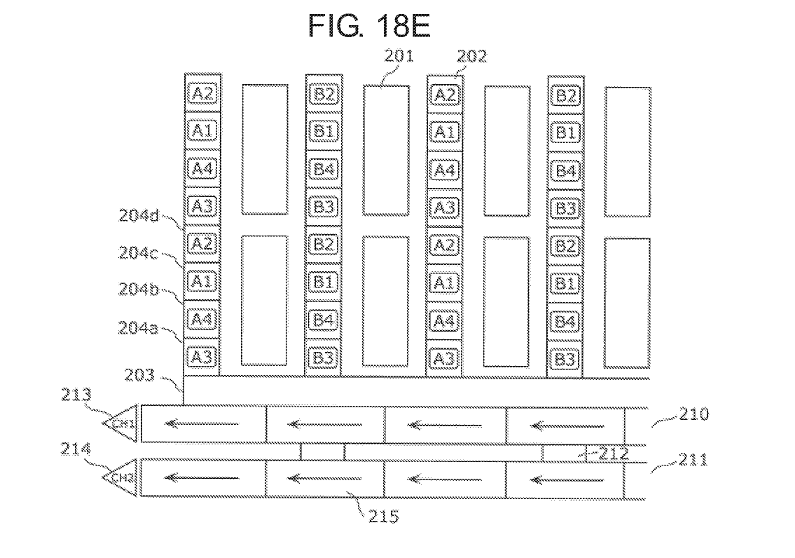

FIG. 17 and FIGS. 18A to 18E are diagrams showing an operation of solid-state imaging device 200 shown in FIG. 16, which uses the first TOF method. FIG. 17 shows an operation of solid-state imaging device in a signal readout period, and FIGS. 18A to 18E show an operation of solid-state imaging device 200 in one cycle of a horizontal scanning period.

First, as shown in FIG. 17, signal charges are read from photoelectric converters 201 into packets 204a, 204b, 204c, 204d and stored, to complete the readout period. Here, in the figure, A1, A2, A3, A4 are signal charges stored in vertical transfer units 202 in rows A, and B1, B2, B3, B4 are signal charges stored in vertical transfer units 202 in rows B.

In a horizontal transfer period, first, as shown in FIG. 18A, all signal charges stored in vertical transfer units 202 are transferred one stage in a column direction. At this time, signal charges A1 and B1 stored in packets in vertical transfer units 202 adjacent to charge controller 203 are transferred from vertical transfer units 202 to charge controller 203. Thereafter, only signal charges B1 of the signal charges stored in charge controller 203 are transferred through inter-horizontal transfer unit 212 to second horizontal transfer unit 211.

Next, as shown in FIG. 18B, signal charges B1 stored in second horizontal transfer unit 211 are transferred one stage in a row direction. Thereafter, signal charges A1 stored in charge controller 203 are transferred to first horizontal transfer unit 210.

Next, as shown in FIG. 18C, all signal charges stored in vertical transfer units 202 are transferred one stage in the column direction. At this time, signal charges A2 and B2 stored in packets in vertical transfer units 202 adjacent to charge controller 203 are transferred from vertical transfer units 202 to charge controller 203. Thereafter, only signal charges B2 of the signal charges stored in charge controller 203 are transferred through inter-horizontal transfer unit 212 to second horizontal transfer unit 211.

Next, as shown in FIG. 18D, all the signal charges stored in first horizontal transfer unit 210 and second horizontal transfer unit 211 are transferred one stage in the row direction. Thereafter, signal charges A2 stored in charge controller 203 are transferred to first horizontal transfer unit 210. Thereafter, as shown in FIG. 18E, the signal charges stored in first horizontal transfer unit 210 and second horizontal transfer unit 211 are sequentially transferred to first charge detector 213 and second charge detector 214.

Here, when attention is paid to signal charges A1 to A4, as shown in FIG. 18D, signal charges A1, A2 are output together from first charge detector 213. Likewise, signal charges A3, A4 output sequentially from a subsequent horizontal scanning period are all output from first charge detector 213. In solid-state imaging device 200 according to this exemplary embodiment including horizontal transfer units (first horizontal transfer unit 210 and second horizontal transfer unit 211) each including one packet 215 for one vertical transfer unit 202, and one inter-horizontal transfer unit 212, four signal charges read from one photoelectric converter 201 are output separately in two horizontal scanning periods without being added horizontally. That is, a horizontal transfer unit (first horizontal transfer unit 210 or second horizontal transfer unit 211) including (1/K) packet for one vertical transfer unit 202, and (L−1) inter-horizontal transfer unit 212 are provided, and M signal charges read from one photoelectric converter 201 are horizontally added in Ns, and are output separately in [(K·M)/(L·N)] horizontal scanning periods. When there is no horizontal addition of signal charges, N=1.

Signal charges output from solid-state imaging device 200 are converted into a image for measuring a distance by signal processor 207 (see FIG. 12), and may also be converted into a visible image depending on a use.

As above, solid-state imaging device 200 according to the second exemplary embodiment allows a plurality of signal charges read from one photoelectric converter 201 to be output from the same charge detector (first charge detector 213 and second charge detector 214) even when first horizontal transfer unit 210 and second horizontal transfer unit 211 each include one packet 215 per vertical transfer unit 202. This halves a number of repetitions of the horizontal scanning period, compared to solid-state imaging device according to the first exemplary embodiment, and thus can further increase a frame rate of a distance measurement camera without degrading ranging precision.

### Third Exemplary Embodiment

Next, a third exemplary embodiment will be described.

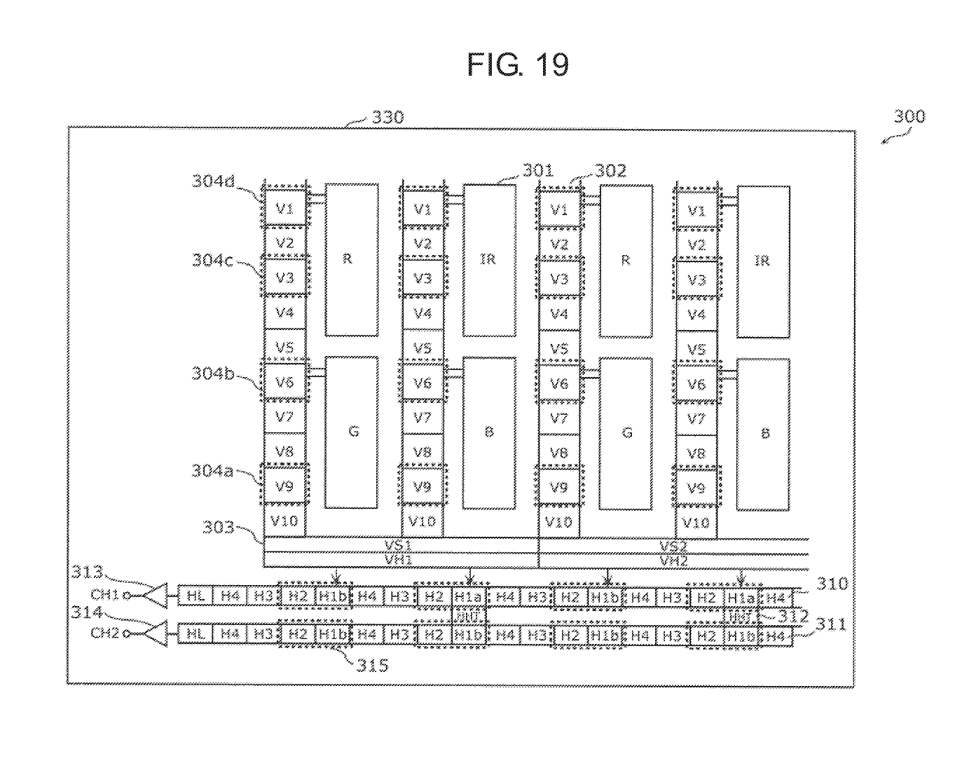

FIG. 19 is a configuration diagram of a solid-state imaging device according to the third exemplary embodiment. Here, only components of two pixels in a vertical direction and of four pixels in a horizontal direction are shown for simplification.

Compared to solid-state imaging device 200 according to the second exemplary embodiment, solid-state imaging device 300 according to the third exemplary embodiment is different in a filter array of photoelectric converters 301. Compared to solid-state imaging device 200, solid-state imaging device 300 is also different in configurations of vertical transfer units 302 and charge controller 303, and due to it, is different in a driving method in a readout period and in a horizontal scanning period. However, solid-state imaging device 300 is the same as solid-state imaging device 200 according to the second exemplary embodiment in that solid-state imaging device 300 is aimed at providing a configuration and a driving method that allow a plurality of signal charges read from one photoelectric converter to be output from the same charge detector. Hereinafter, differences from the second exemplary embodiment will be mainly described, and the same points will not be described.

Compared to solid-state imaging device 200 in FIG. 16, solid-state imaging device 300 shown in FIG. 19 includes filters that transmit visible light, for example, R (Red), G (Green), B (Blue) filters, in photoelectric converters 301 of three pixels in a 2×2 pixel array, and includes a filter that intercepts visible light and transmits only near-infrared light in photoelectric converter 301 of remaining one pixel. With this, a visible image and a image for measuring a distance can be acquired separately. Solid-state imaging device 300 is of a ten-phase drive system with ten electrodes provided per two pixels in vertical transfer unit 302. Four packets 304a to 304d are provided per two photoelectric converters 301. Charge controller 303 is provided with electrodes to control signal charges every two rows.

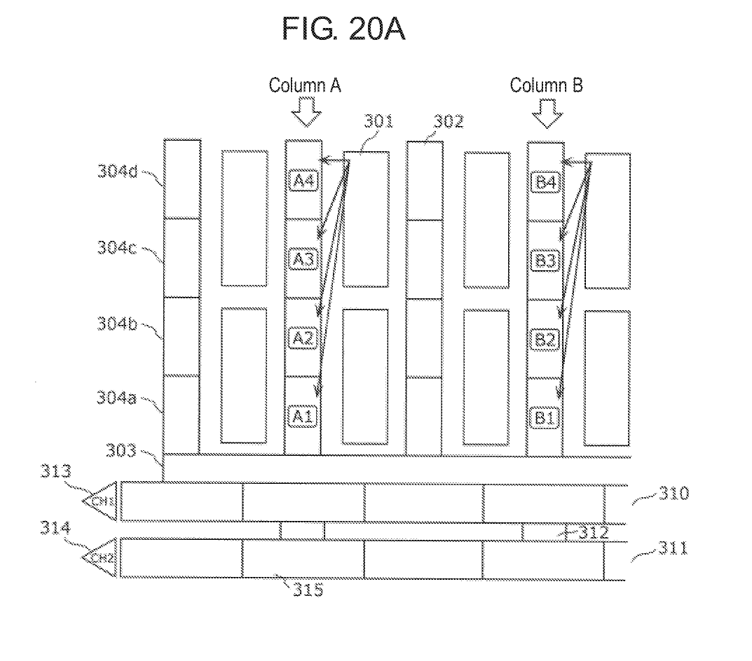

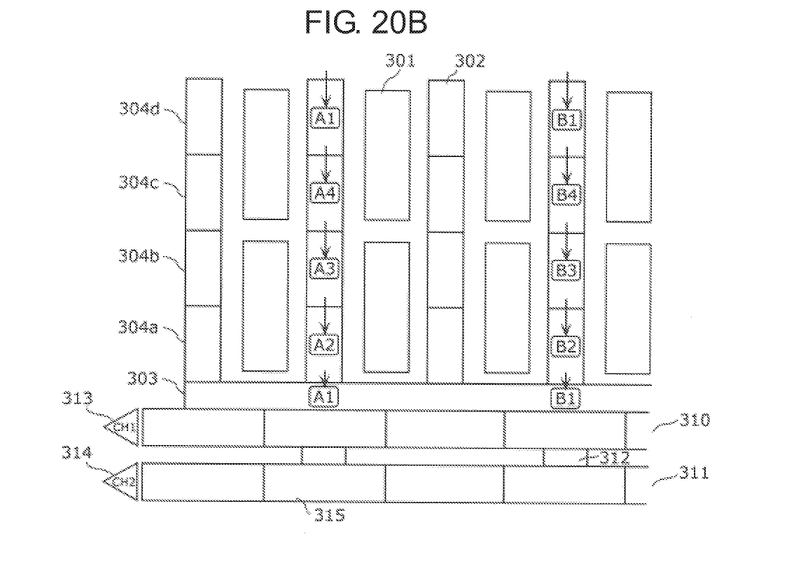

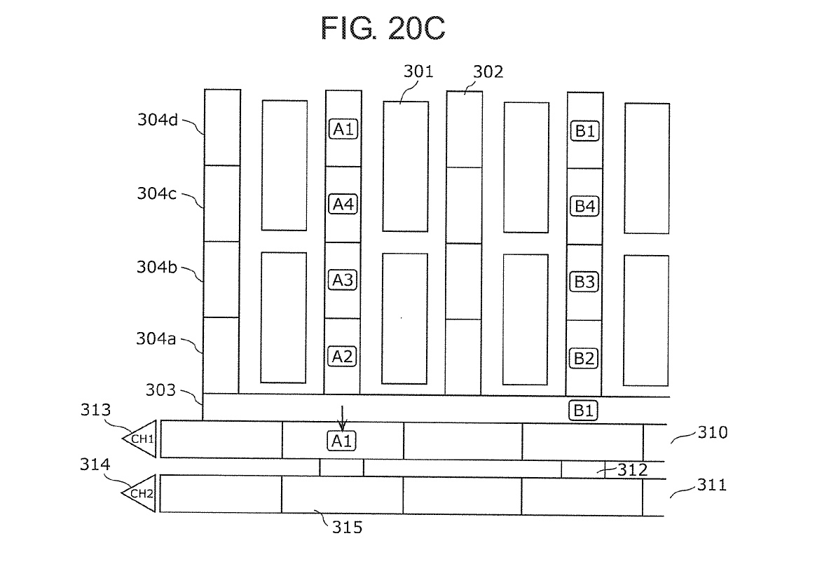

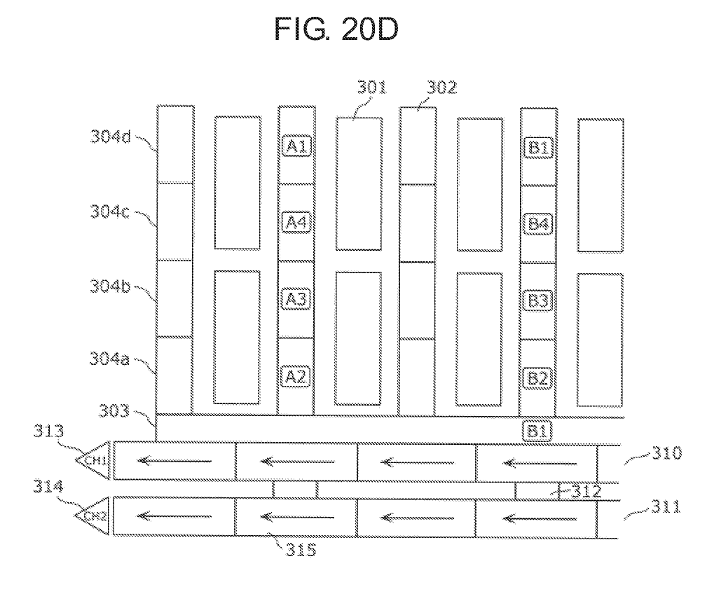

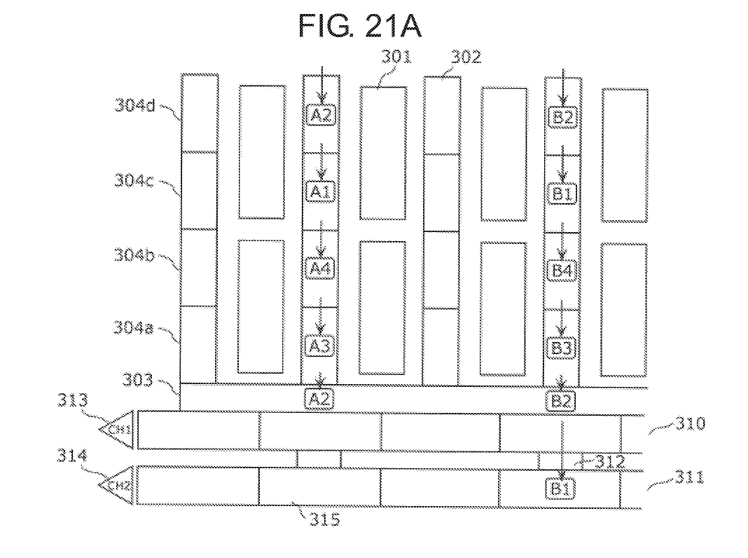

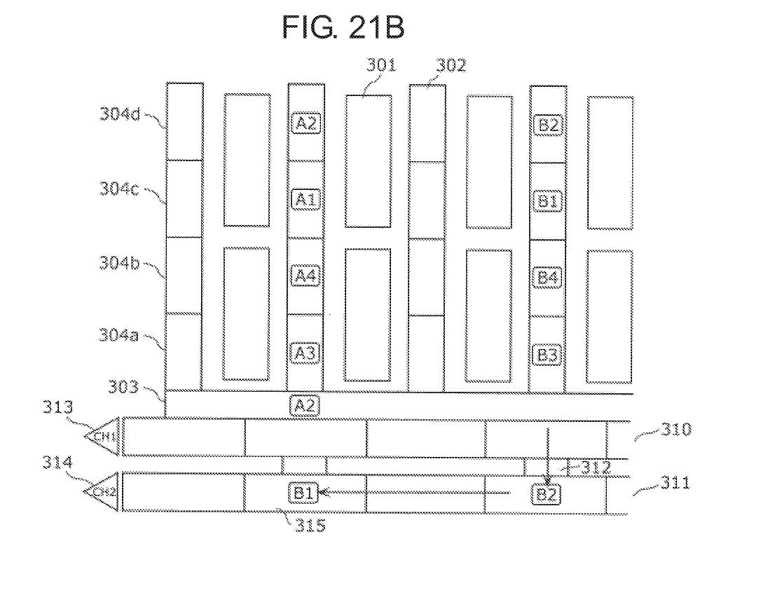

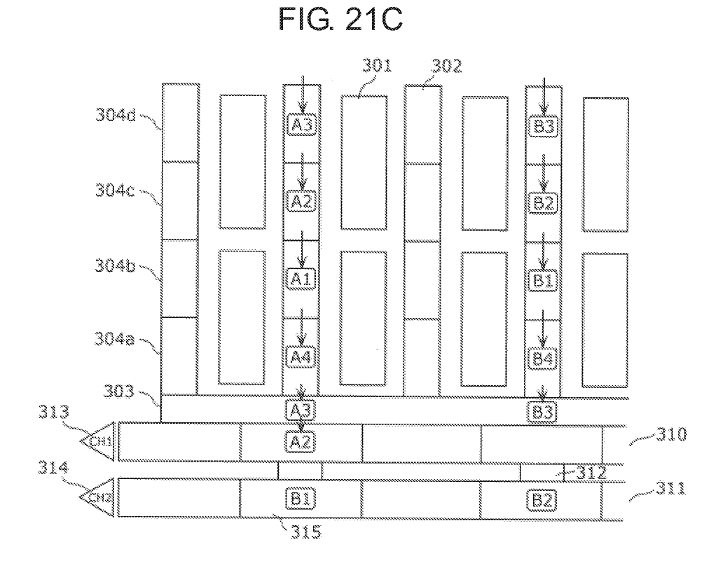

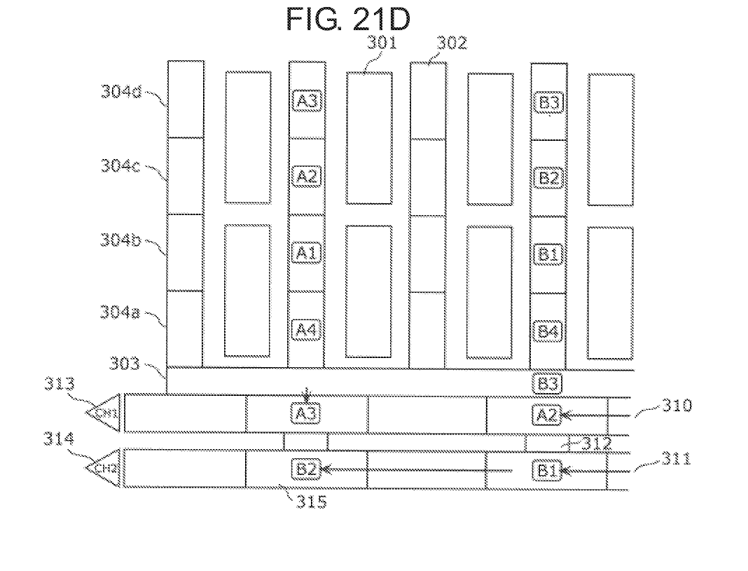

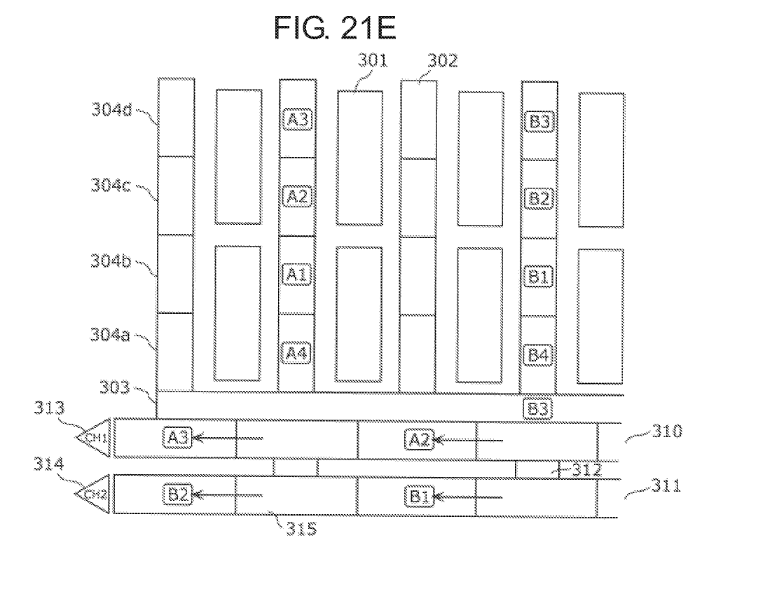

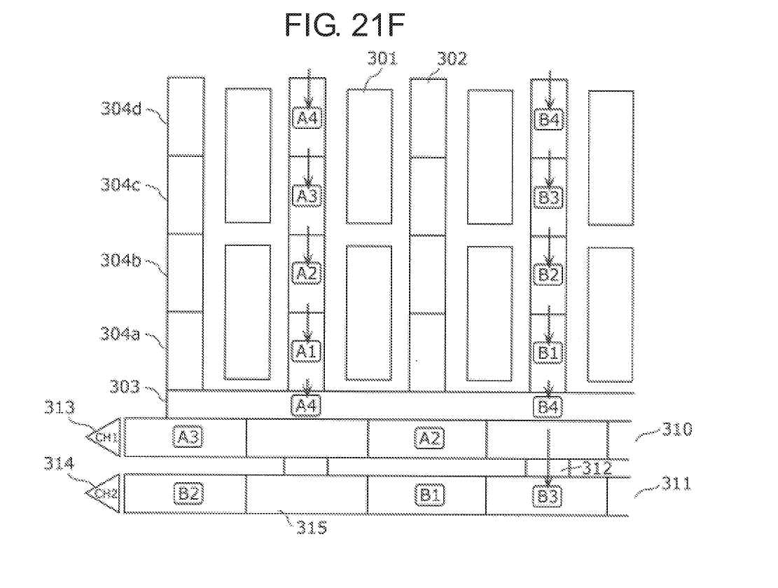

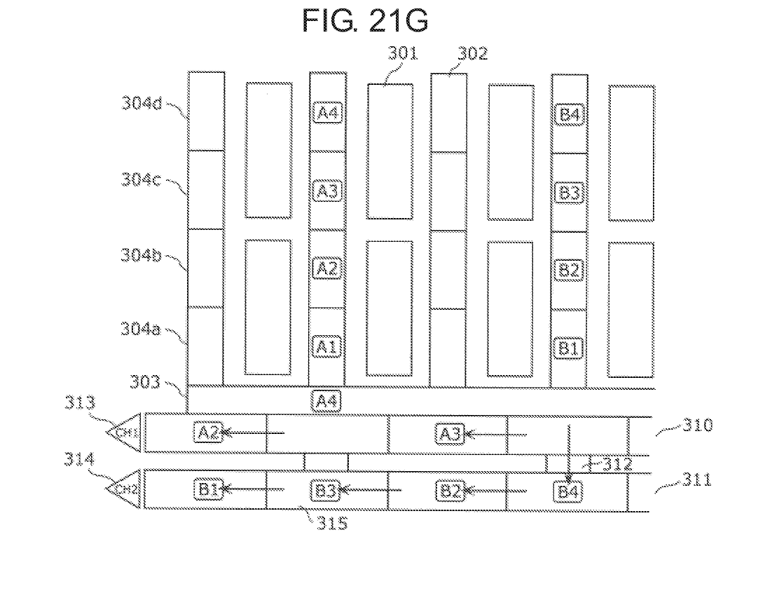

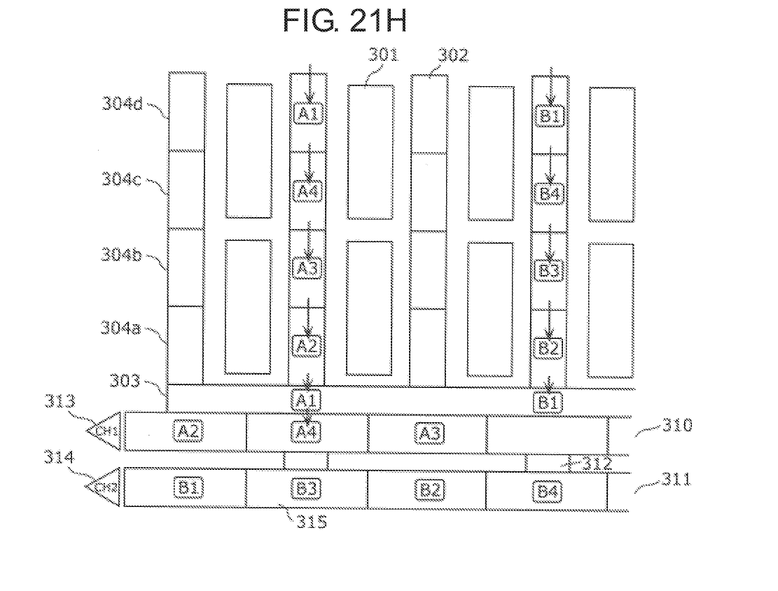

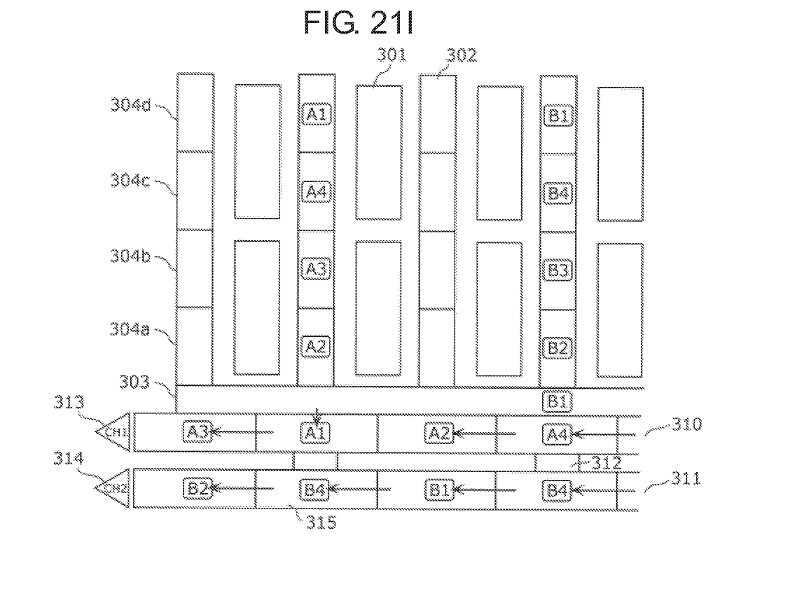

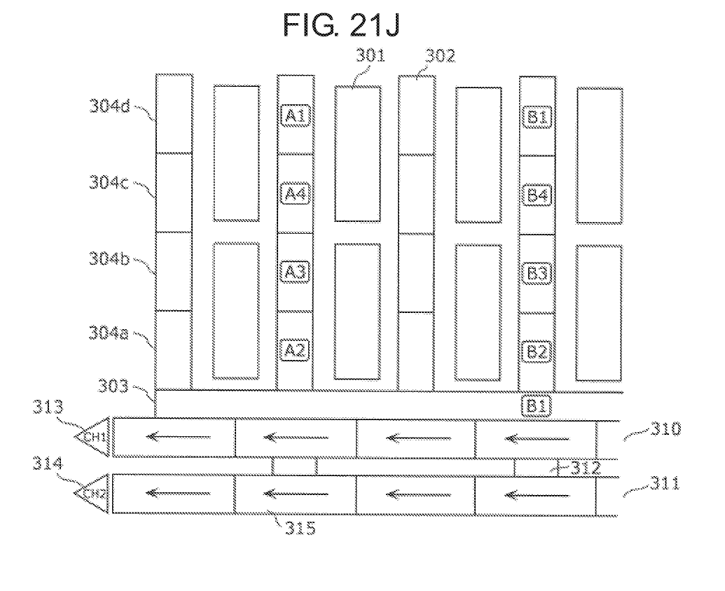

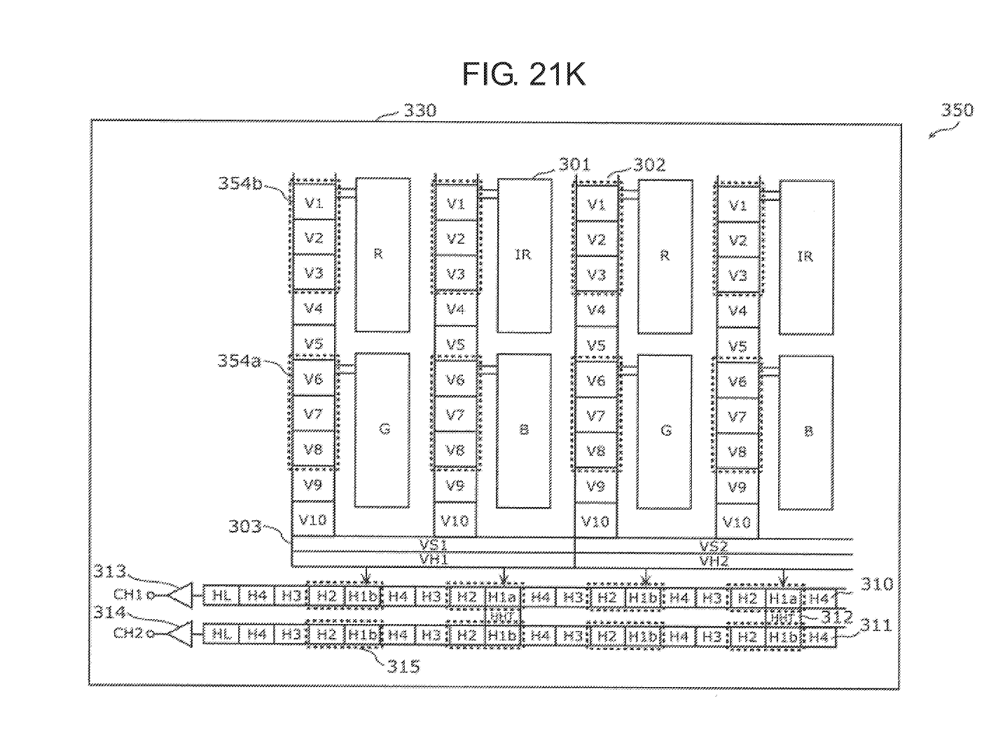

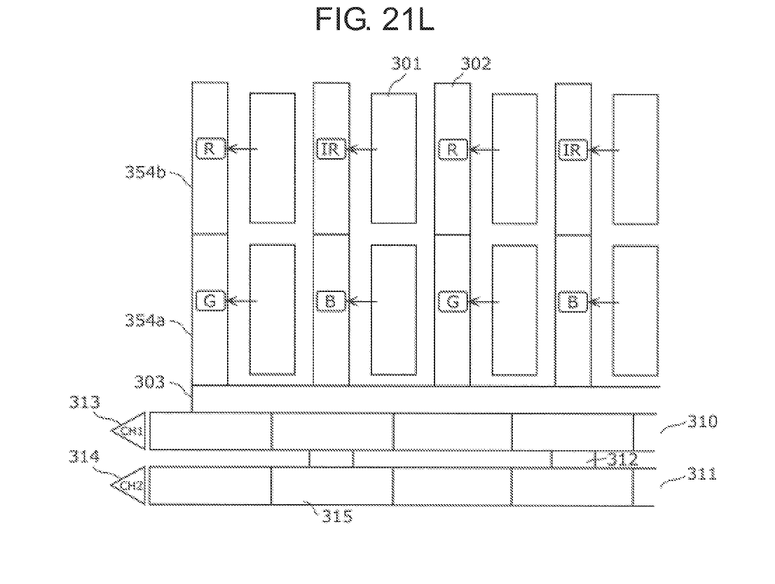

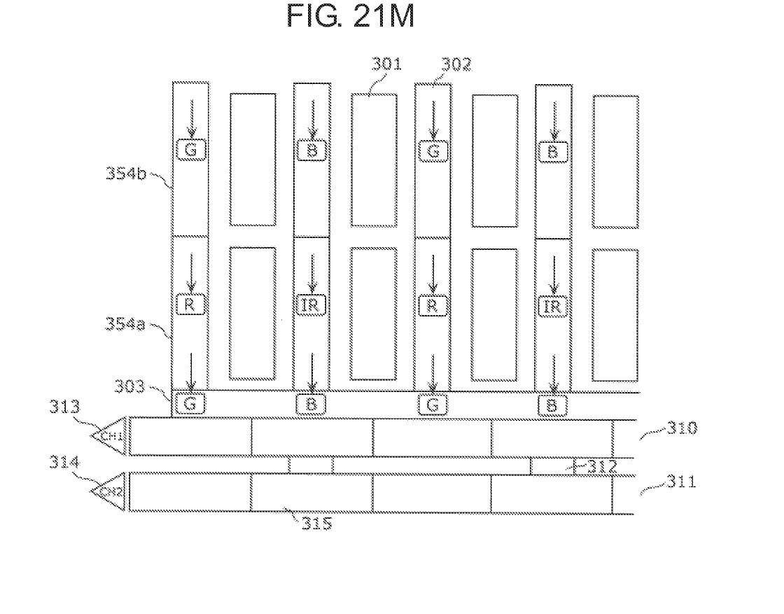

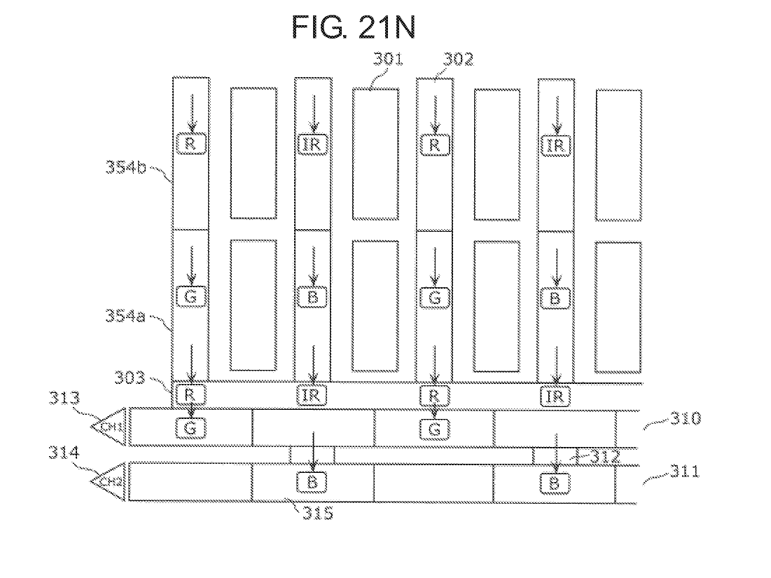

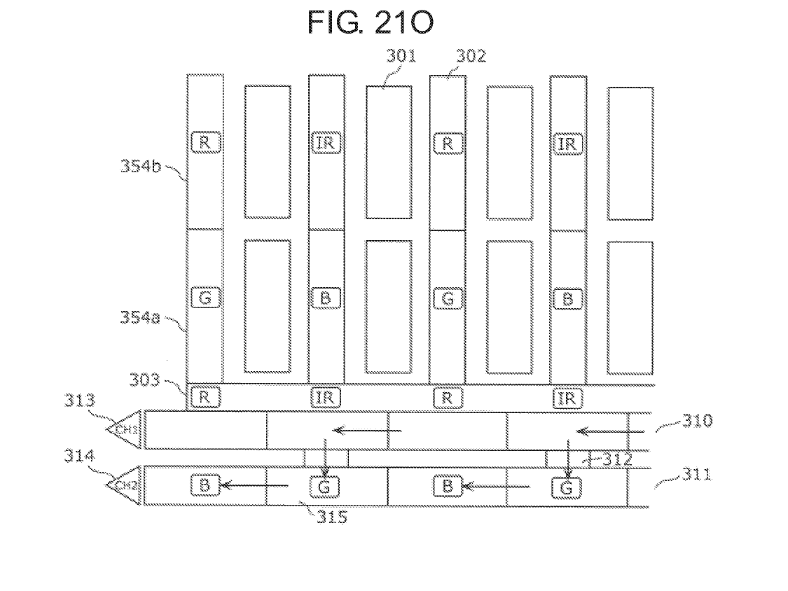

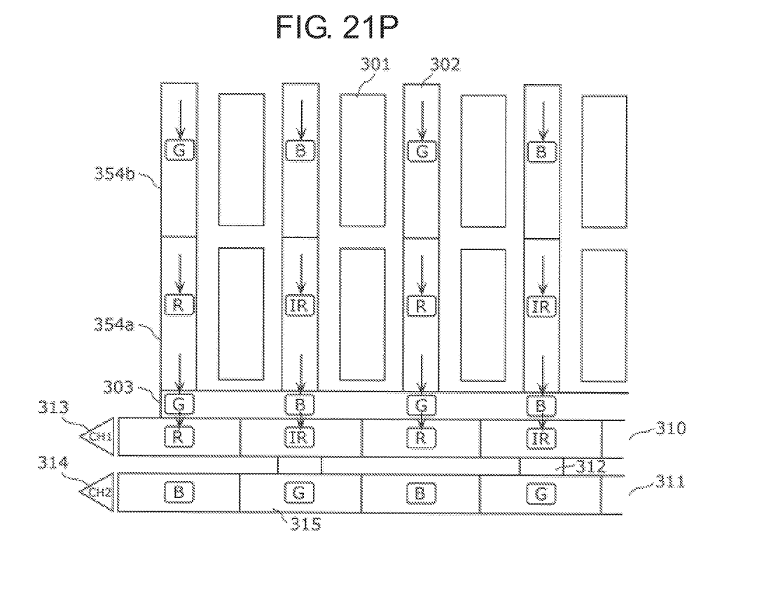

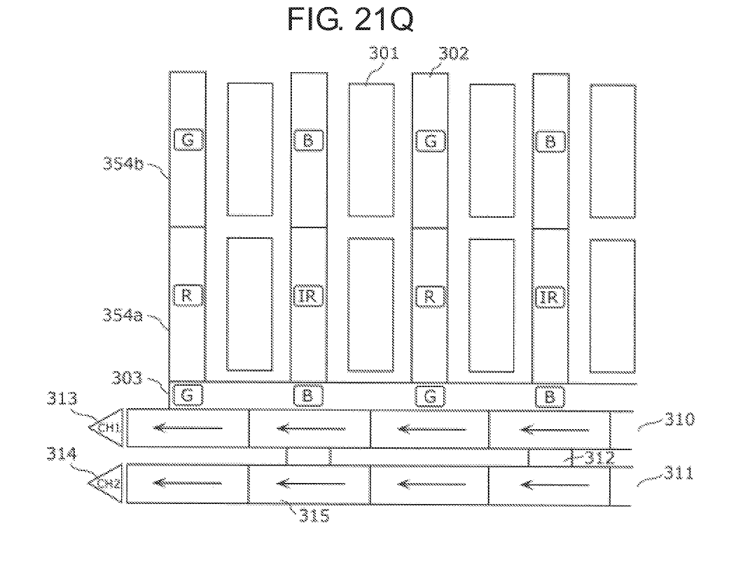

FIGS. 20A to 20D and FIGS. 21A to 21J are diagrams showing an operation of solid-state imaging device shown in FIG. 19 in a first frame scanning period to acquire a image for measuring a distance, in which the first TOF method is used. FIGS. 20A to 20D show an operation of solid-state imaging device in a signal readout period, and FIGS. 21A to 21J show an operation of solid-state imaging device in one cycle of a horizontal scanning period.

In the readout period, first, as shown in FIG. 20A, signal charges are read only from one photoelectric converter 301 of a 2×2 pixel array into packets 304a, 304b, 304c, 304d, and stored. Here, in the figure, A1, A2, A3, A4 are signal charges stored in vertical transfer unit 302 in row A, and B1, B2, B3, B4 are signal charges stored in vertical transfer unit 302 in row B.

Next, as shown in FIG. 20B, all signal charges stored in vertical transfer units 302 are transferred one stage in a column direction. At this time, signal charges A1 and B1 stored in packets in vertical transfer units 302 adjacent to charge controller 303 are transferred from vertical transfer units 302 to charge controller 303.

Next, as shown in FIG. 20C, only signal charge A1 of the signal charges stored in charge controller 303 is transferred to first horizontal transfer unit 310.

Thereafter, as shown in FIG. 20D, signal charges stored in first horizontal transfer unit 310 and second horizontal transfer unit 311 are sequentially transferred to first charge detector 313 and second charge detector 314, to complete the readout period.

In a horizontal transfer period, first, as shown in FIG. 21A, signal charge B1 stored in charge controller 303 is transferred through inter-horizontal transfer unit 312 to second horizontal transfer unit 311. Thereafter, all signal charges stored in vertical transfer units 302 are transferred one stage in the column direction. At this time, signal charges A2 and B2 stored in packets in vertical transfer units 302 adjacent to charge controller 303 are transferred from vertical transfer units 302 to charge controller 303.

Next, as shown in FIG. 21B, signal charge B1 stored in second horizontal transfer unit 311 is transferred two stages in a row direction. Thereafter, only signal charge B2 of the signal charges stored in charge controller 303 is transferred through inter-horizontal transfer unit 312 to second horizontal transfer unit 311.

Next, as shown in FIG. 21C, signal charge A2 stored in charge controller 303 is transferred to first horizontal transfer unit 310. Thereafter, all signal charges stored in vertical transfer units 302 are transferred one stage in the column direction. At this time, signal charges A3 and B3 stored in packets in vertical transfer units 302 adjacent to charge controller 303 are transferred from vertical transfer units 302 to charge controller 303.

Next, as shown in FIG. 21D, all the signal charges stored in first horizontal transfer unit 310 and second horizontal transfer unit 311 are transferred two stages in the row direction. Thereafter, only signal charge A3 of the signal charges stored in charge controller 303 is transferred to first horizontal transfer unit 310.

Next, as shown in FIG. 21E, all the signal charges stored in first horizontal transfer unit 310 and second horizontal transfer unit 311 are transferred two stages in the row direction.

Next, as shown in FIG. 21F, signal charge B3 stored in charge controller 303 is transferred through inter-horizontal transfer unit 312 to second horizontal transfer unit 311. Thereafter, all signal charges stored in vertical transfer units 302 are transferred one stage in the column direction. At this time, signal charges A4 and B4 stored in packets in vertical transfer units 302 adjacent to charge controller 303 are transferred from vertical transfer units 302 to charge controller 303.

Next, as shown in FIG. 21G, all the signal charges stored in first horizontal transfer unit 310 and second horizontal transfer unit 311 are transferred two stages in the row direction. Thereafter, only signal charge B4 of the signal charges stored in charge controller 303 is transferred through inter-horizontal transfer unit 312 to second horizontal transfer unit 311.

Next, as shown in FIG. 21H, signal charge A4 stored in charge controller 303 is transferred to first horizontal transfer unit 310. Thereafter, all signal charges stored in vertical transfer units 302 are transferred one stage in the column direction. At this time, signal charges A1 and B1 stored in packets in vertical transfer units 302 adjacent to charge controller 303 are transferred from vertical transfer units 302 to charge controller 303.

Next, as shown in FIG. 21I, all the signal charges stored in first horizontal transfer unit 310 and second horizontal transfer unit 311 are transferred two stages in the row direction. Thereafter, only signal charge A1 of the signal charges stored in charge controller 303 is transferred to first horizontal transfer unit 310.

Thereafter, as shown in FIG. 21J, the signal charges stored in first horizontal transfer unit 310 and second horizontal transfer unit 311 are sequentially transferred to first charge detector 313 and second charge detector 314.

Here, when attention is paid to signal charges A1 to A4, as shown in FIG. 21I, signal charges A1 to A4 are all output from first charge detector 313. Likewise, signal charges A1 to A4 output sequentially from a subsequent horizontal scanning period are all output from first charge detector 313. In the solid-state imaging device according to this exemplary embodiment including horizontal transfer units (first horizontal transfer unit 310 and second horizontal transfer unit 311) each including one packet 315 for one vertical transfer unit 302, and one inter-horizontal transfer unit, four signal charges read from one photoelectric converter 301 are output separately in one horizontal scanning period without being added horizontally. That is, horizontal transfer units (first horizontal transfer unit 310 and second horizontal transfer unit 311) including (1/K) packet for one vertical transfer unit 302, and (L−1) inter-horizontal transfer unit 312 are provided, and M signal charges read from one photoelectric converter 301 are horizontally added in Ns, and are output separately in [(K·M)/(2·L·N)] horizontal scanning periods. When there is no horizontal addition of signal charges, N=1.

When the first frame scanning period is completed, a second frame scanning period is started. Compared to solid-state imaging device 300 in FIG. 19, solid-state imaging device 350 shown in FIG. 21K is different in a number of packets, and two packets 354a and 354b are provided per two photoelectric converters 301. FIGS. 21L to 21Q are diagrams showing an operation of solid-state imaging device in FIG. 21K in the second frame scanning period to acquire a visible image. FIGS. 21L and 21M show an operation of solid-state imaging device in a signal readout period, and FIGS. 21N to 21Q show an operation of solid-state imaging device 350 in one cycle of a horizontal scanning period.

In the readout period, first, as shown in FIG. 21L, signal charges are read from all photoelectric converters 301 into packets 354a and 354b, and stored. Here, R is a signal charge read from an R pixel, G is a signal charge read from a G pixel, B is a signal charge read from a B pixel, and IR is a signal charge read from an IR pixel.

Next, as shown in FIG. 21M, all the signal charges stored in vertical transfer units 302 are transferred one stage in a column direction. At this time, signal charges G and B stored in packets in vertical transfer units 302 adjacent to charge controller 303 are transferred from vertical transfer units 302 to charge controller 303, to complete the readout period.

In a horizontal transfer period, first, as shown in FIG. 21N, signal charges B stored in charge controller 303 are transferred through inter-horizontal transfer unit 312 to second horizontal transfer unit 311. Thereafter, all signal charges stored in vertical transfer units 302 are transferred one stage in the column direction. At this time, signal charges G stored in packets in vertical transfer units 302 adjacent to charge controller 303 are transferred from vertical transfer units 302 to charge controller 303.

Next, as shown in FIG. 21O, signal charges B stored in second horizontal transfer unit 311 are transferred one stage in a row direction. Thereafter, signal charges G stored in charge controller 303 are transferred through inter-horizontal transfer unit 312 to second horizontal transfer unit 311.

Next, as shown in FIG. 21P, signal charges R and IR stored in charge controller 303 are transferred to first horizontal transfer unit 310. Thereafter, all signal charges stored in vertical transfer units 302 are transferred one stage in the column direction. At this time, signal charges B and G stored in packets in vertical transfer units 302 adjacent to charge controller 303 are transferred from vertical transfer units 302 to charge controller 303.

Next, as shown in FIG. 21Q, the signal charges stored in first horizontal transfer unit 310 and second horizontal transfer unit 311 are sequentially transferred to first charge detector 313 and second charge detector 314, and a visible image is acquired.

Thereafter, the process returns to the first frame scanning period, and from then on, acquisition of a image for measuring a distance and a visible image is repeated. This can provide not only flat images but also images of depth such as 3D displays.

Signal charges output from solid-state imaging device 300 are converted into a image for measuring a distance and a visible image separately by signal processor 207 (see FIG. 12).

As above, solid-state imaging device 300 according to the third exemplary embodiment allows a plurality of signal charges read from one photoelectric converter 301 to be output from the same charge detector (first charge detector 313 and second charge detector 314) even when signal charges are read only from one photoelectric converter 301 in a 2×2 pixel array. With this, a frame rate of a distance measurement camera can be increased without degrading ranging precision. Further, compared to solid-state imaging device 200 according to the second exemplary embodiment, acquisition of visible images is possible, thus expanding the application of the distance measurement camera to segmentation of a specific subject (background separation), creation of 3D avatars, and so on.

### Fourth Exemplary Embodiment

Next, a fourth exemplary embodiment will be described.

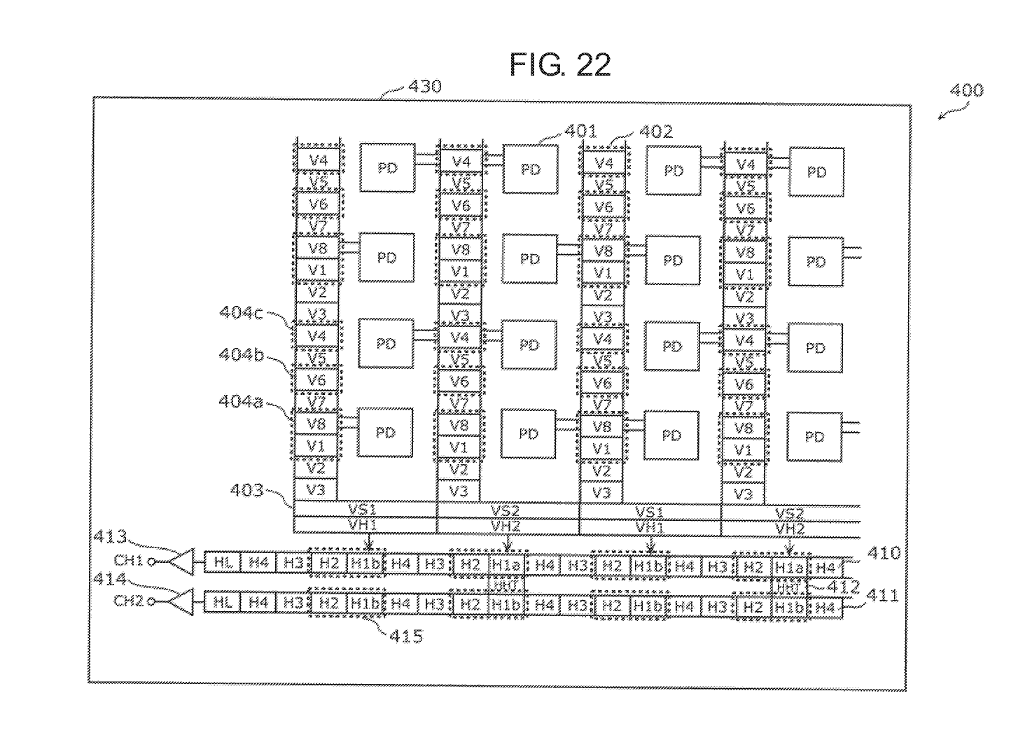

FIG. 22 is a configuration diagram of a solid-state imaging device according to the fourth exemplary embodiment. Here, only components of four pixels in a vertical direction and of four pixels in a horizontal direction are shown for simplification.

Compared to solid-state imaging device 200 according to the second exemplary embodiment, solid-state imaging device 400 according to the fourth exemplary embodiment is different in a TOF method. Compared to solid-state imaging device 200, solid-state imaging device 400 is also different in a configuration of vertical transfer units 202, and due to it, is different in a driving method in a readout period and in a horizontal scanning period. However, solid-state imaging device 400 is the same as solid-state imaging device 200 according to the second exemplary embodiment in that solid-state imaging device 400 is aimed at providing a configuration and a driving method that allow a plurality of signal charges read from one photoelectric converter to be output from the same charge detector. Hereinafter, differences from the second exemplary embodiment will be mainly described, and the same points will not be described.

Compared to solid-state imaging device 200 in FIG. 16, solid-state imaging device 400 shown in FIG. 22 is of an eight-phase drive system with eight electrodes provided per two pixels in vertical transfer units 402. Three packets 404a to 404c are provided per two photoelectric converters 401.

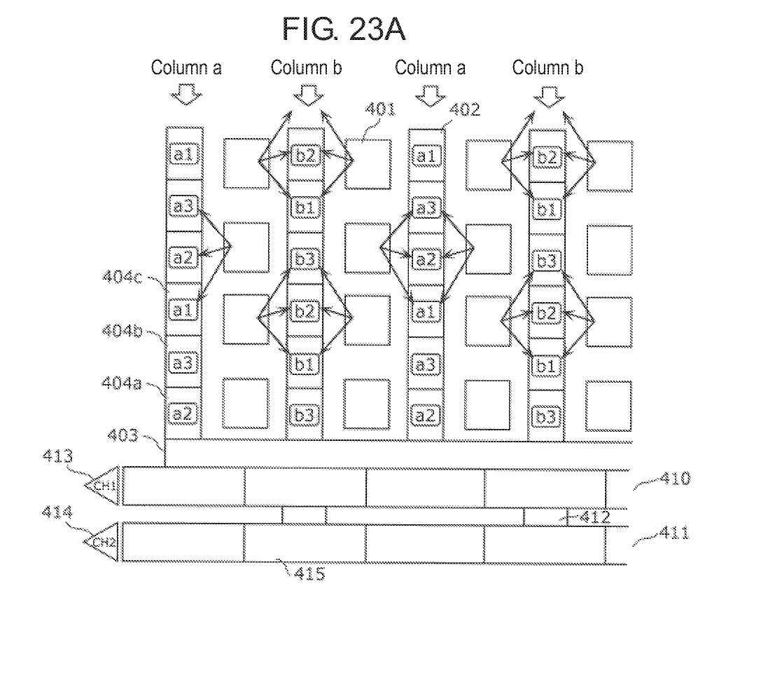

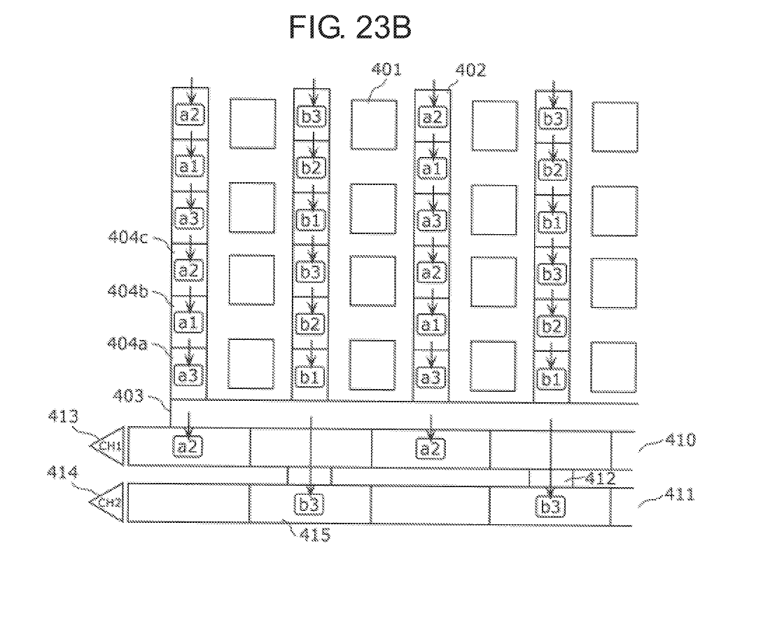

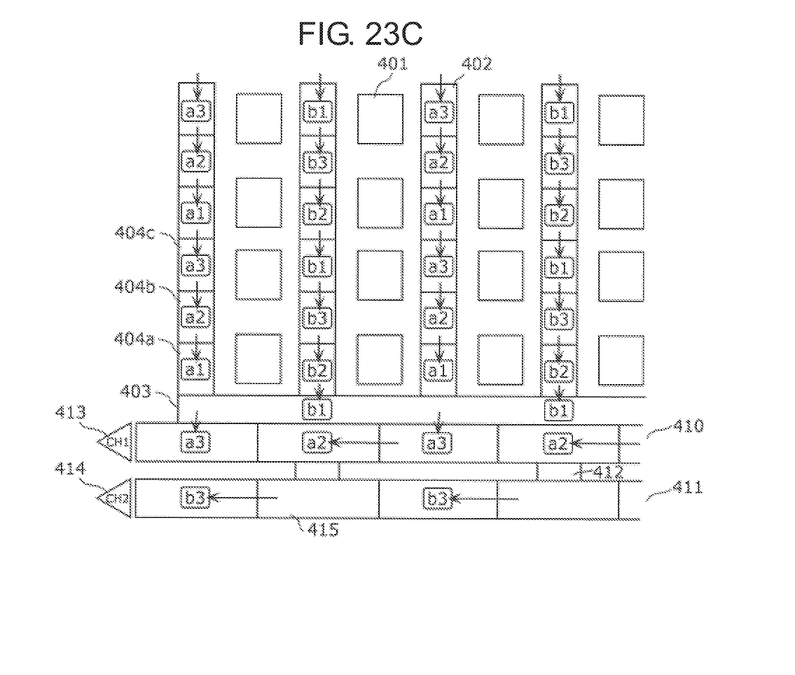

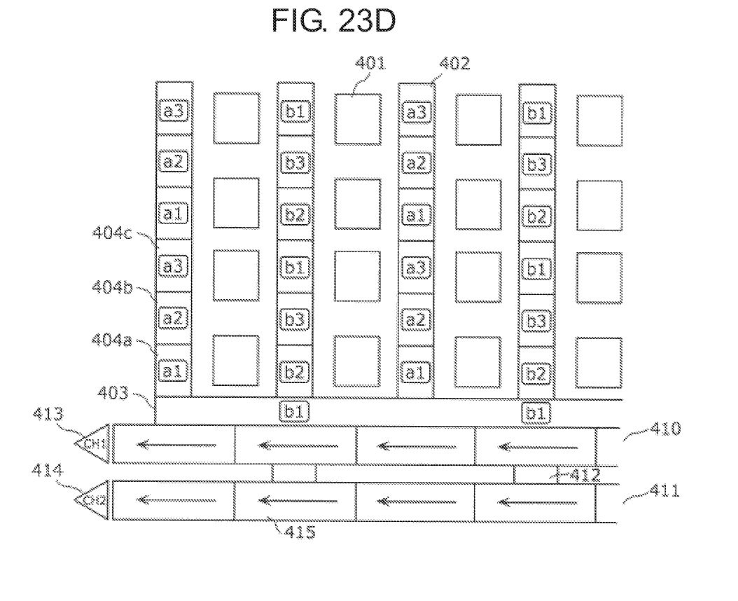

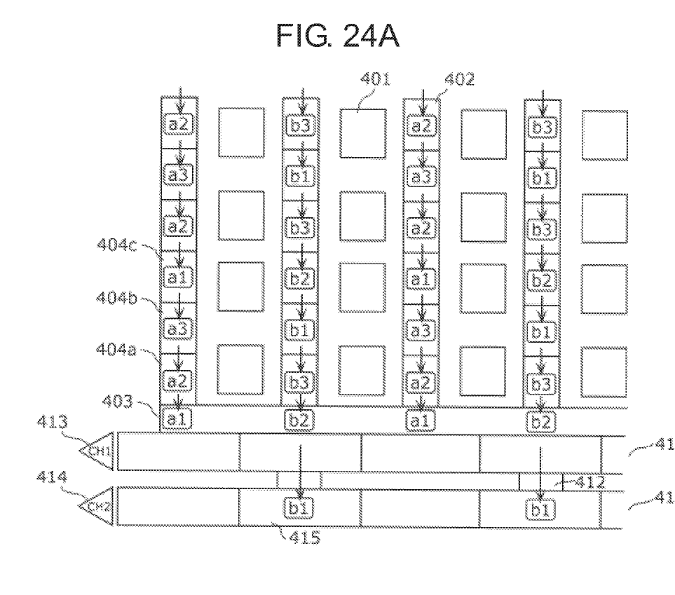

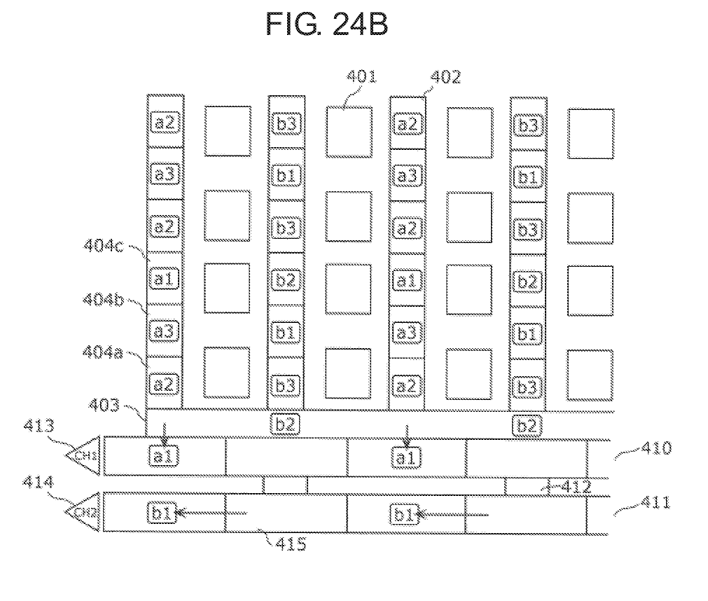

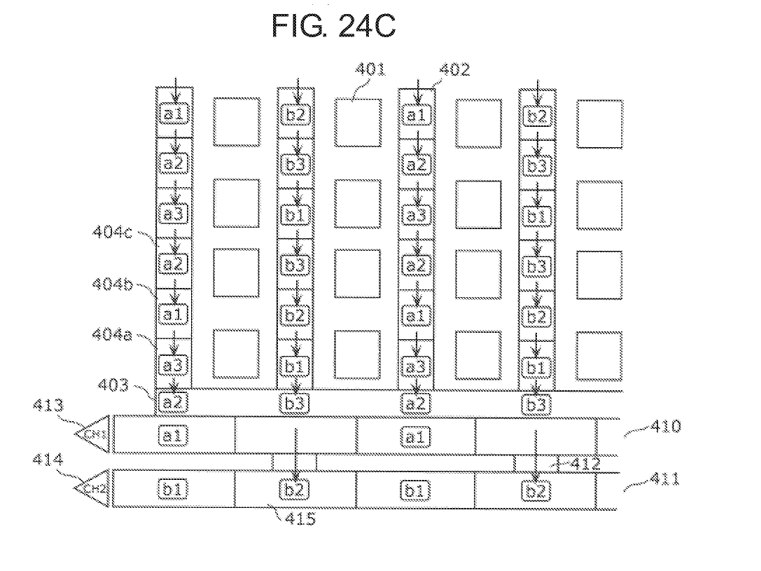

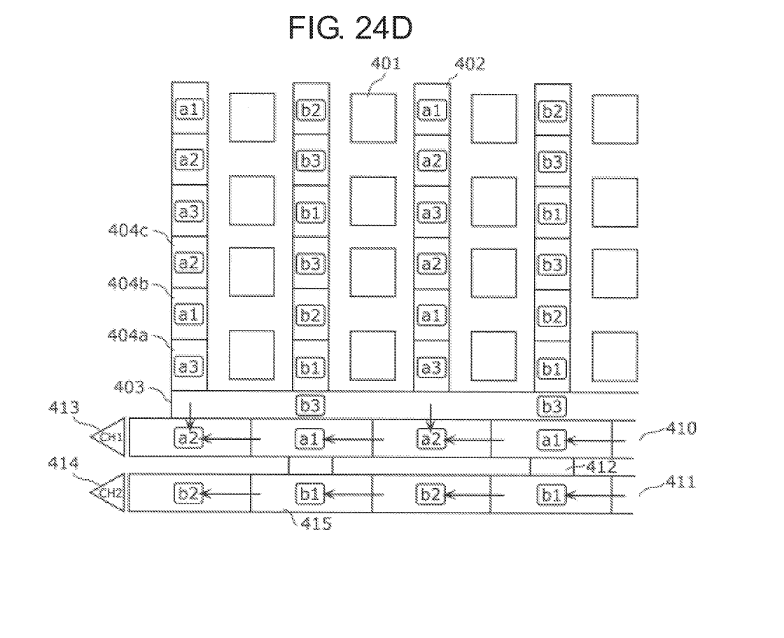

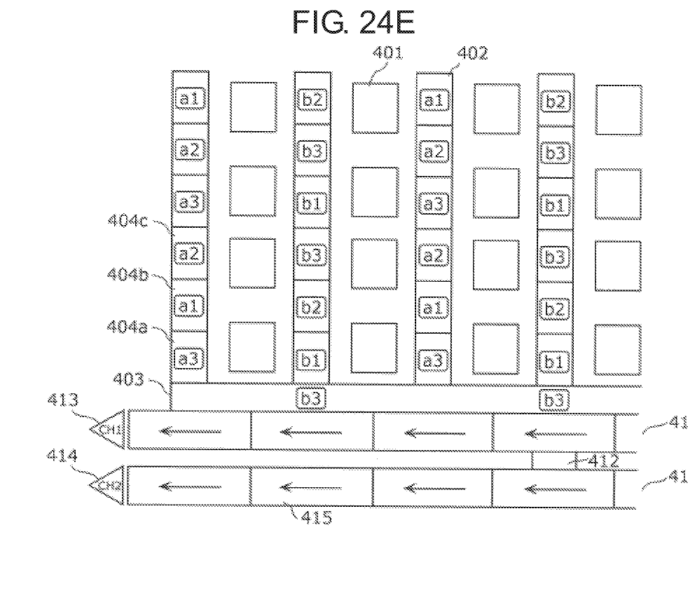

FIGS. 23A to 23D and FIGS. 24A to 24E are diagrams showing an operation of solid-state imaging device 400 in FIG. 22, which uses the second TOF method or the third TOF method. FIGS. 23A to 23D show an operation of solid-state imaging device in a signal readout period, and FIGS. 24A to 24E show an operation of solid-state imaging device in one cycle of a horizontal scanning period.

In the readout period, first, as shown in FIG. 23A, signal charges are read checkerwise from photoelectric converters 401 into packets 404a, 404b, 404c, and stored with the signal charges of horizontally adjacent two pixels added. Here, in the figure, a1, a2, a3 are signal charges stored in vertical transfer units 402 in rows a, and b1, b2, b3 are signal charges stored in vertical transfer units 402 in rows b.

Next, as shown in FIG. 23B, all signal charges stored in vertical transfer units 402 are transferred one stage in a column direction. At this time, signal charges stored in packets in vertical transfer units 402 adjacent to charge controller 403 are transferred from vertical transfer units 402 to charge controller 403. Thereafter, of the signal charges stored in charge controller 403, signal charges a2 are transferred to first horizontal transfer unit 410, and signal charges b3 are transferred through inter-horizontal transfer unit 412 to second horizontal transfer unit 411.

Next, as shown in FIG. 23C, all the signal charges stored in first horizontal transfer unit 410 and second horizontal transfer unit 411 are transferred one stage in a row direction. Thereafter, all signal charges stored in vertical transfer units 402 are transferred one stage in the column direction. At this time, signal charges stored in packets in vertical transfer units 402 adjacent to charge controller 403 are transferred from vertical transfer units 402 to charge controller 403. Thereafter, only signal charges a3 of the signal charges stored in charge controller 403 are transferred to first horizontal transfer unit 410.

Thereafter, as shown in FIG. 23D, the signal charges stored in first horizontal transfer unit and second horizontal transfer unit are sequentially transferred to first charge detector 413 and second charge detector 414, to complete the readout period.

In a horizontal transfer period, first, as shown in FIG. 24A, signal charges b1 stored in charge controller 403 are transferred through inter-horizontal transfer unit 412 to second horizontal transfer unit 411. Thereafter, all signal charges stored in vertical transfer units 402 are transferred one stage in the column direction. At this time, signal charges stored in packets in vertical transfer units 402 adjacent to charge controller 403 are transferred from vertical transfer units 402 to charge controller 403.

Next, as shown in FIG. 24B, signal charges b1 stored in second horizontal transfer unit 411 are transferred one stage in the row direction. Thereafter, only signal charges a1 of the signal charges stored in charge controller 403 are transferred to first horizontal transfer unit 410.

Next, as shown in FIG. 24C, signal charges b2 stored in charge controller 403 are transferred through inter-horizontal transfer unit 412 to second horizontal transfer unit 411. Thereafter, all signal charges stored in vertical transfer units 402 are transferred one stage in the column direction. At this time, signal charges stored in packets in vertical transfer units 402 adjacent to charge controller 403 are transferred from vertical transfer units 402 to charge controller 403.

Next, as shown in FIG. 24D, all the signal charges stored in first horizontal transfer unit 410 and second horizontal transfer unit 411 are transferred one stage in the row direction. Thereafter, only signal charges a2 of the signal charges stored in charge controller 403 are transferred to first horizontal transfer unit 410. Thereafter, as shown in FIG. 24E, the signal charges stored in first horizontal transfer unit 410 and second horizontal transfer unit 411 are sequentially transferred to first charge detector 413 and second charge detector 414.

Here, when attention is paid to signal charges a1 to a3, as shown in FIG. 24D, signal charges a1, a2 are output from first charge detector 413 together. Likewise, signal charges a3 output from a subsequent horizontal scanning period are output from first charge detector 413. In solid-state imaging device according to this exemplary embodiment including horizontal transfer units (first horizontal transfer unit 410 and second horizontal transfer unit 411) each including one packet 415 for one vertical transfer unit 402, and one inter-horizontal transfer unit 412, three signal charges read from one photoelectric converter 401 are output separately in 1.5 horizontal scanning periods without being added horizontally. That is, a horizontal transfer unit (first horizontal transfer unit 410 or second horizontal transfer unit 411) including (1/K) packet for one vertical transfer unit 402, and (L−1) inter-horizontal transfer unit 412 are provided, and M signal charges read from one photoelectric converter 401 are horizontally added in Ns, and are output separately in [(K·M)/(L·N)] horizontal scanning periods. When there is no horizontal addition of signal charges, N=1.

When attention is paid to signal charges a1 and b1 of the same exposure period, as shown in FIG. 23D, in a period when signal charges a1 and b1 are stored in vertical transfer units 402, packets in which signal charges a1 and b1 are stored are out of alignment by one stage in the column direction, but as shown in FIG. 24D, in first horizontal transfer unit 410 and second horizontal transfer unit 411, signal charges a1 and b1 are aligned in the row direction, and output from first charge detector 413 and second charge detector 414 in the same period.

Signal charges output from solid-state imaging device 400 are converted into a image for measuring a distance by signal processor 207 (see FIG. 12), and may also be converted into a visible image depending on a use.

As above, solid-state imaging device 400 according to the fourth exemplary embodiment allows a plurality of signal charges read from one photoelectric converter 401 to be output from the same charge detector (first charge detector 413 and second charge detector 414) even when the second TOF method or the third TOF method is used. With this, a frame rate of a distance measurement camera can be increased without degrading ranging precision. Further, even when signal charges are read checkerwise, and storage positions of signal charges of the same exposure period are out of alignment column by column, those signal charges can be output in the same period. With this, since signals of close signal amplitudes are output in the same period, crosstalk between two charge detectors can be prevented to prevent degradation of ranging precision.

### Fifth Exemplary Embodiment

Next, a fifth exemplary embodiment will be described.

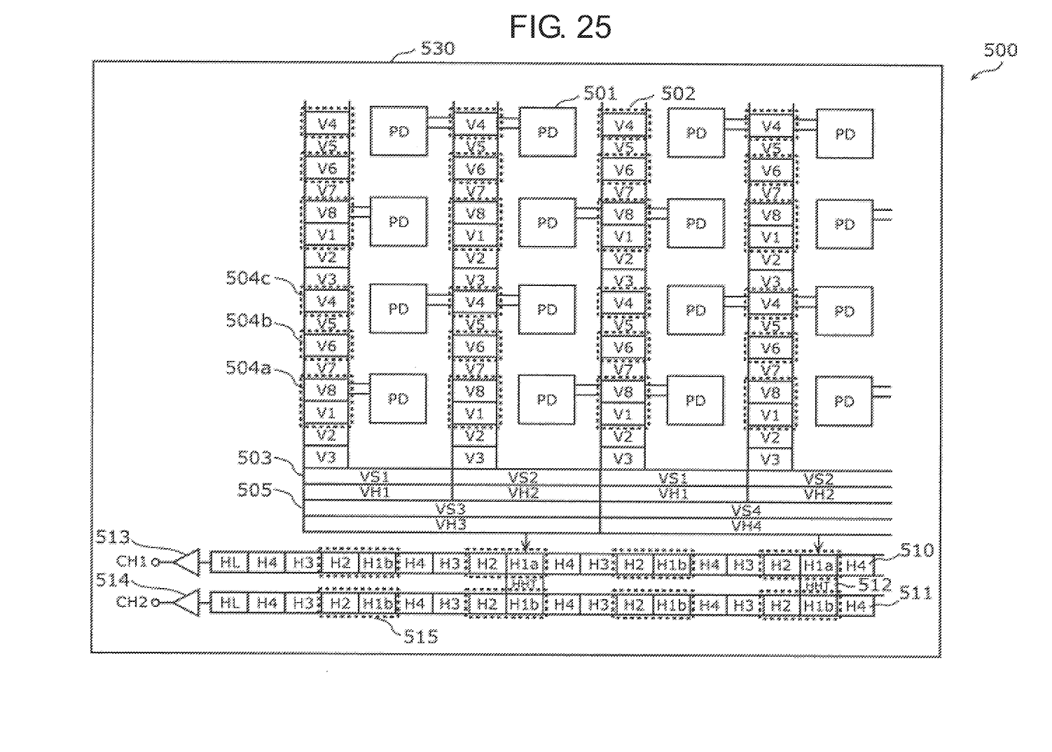

FIG. 25 is a configuration diagram of a solid-state imaging device according to the fifth exemplary embodiment. Here, only components of four pixels in a vertical direction and of four pixels in a horizontal direction are shown for simplification.

Compared to solid-state imaging device 400 according to the fourth exemplary embodiment, solid-state imaging device 500 according to the fifth exemplary embodiment includes additional charge controller 505, and due to it, is different in a driving method in a readout period and in a horizontal scanning period. However, solid-state imaging device 500 is the same as solid-state imaging device 400 according to the fourth exemplary embodiment in that solid-state imaging device 500 is aimed at providing a configuration and a driving method that allow a plurality of signal charges read from one photoelectric converter to be output from the same charge detector. Hereinafter, differences from the fourth exemplary embodiment will be mainly described, and the same points will not be described.

Compared to solid-state imaging device 400 in FIG. 22, solid-state imaging device 500 shown in FIG. 25 is provided with charge controller 505 between charge controller and first horizontal transfer unit, and is provided with electrodes to control signal charges every two rows. Charge controller 505 adds two signal charges that are horizontally adjacent to each other and are of the same exposure period.

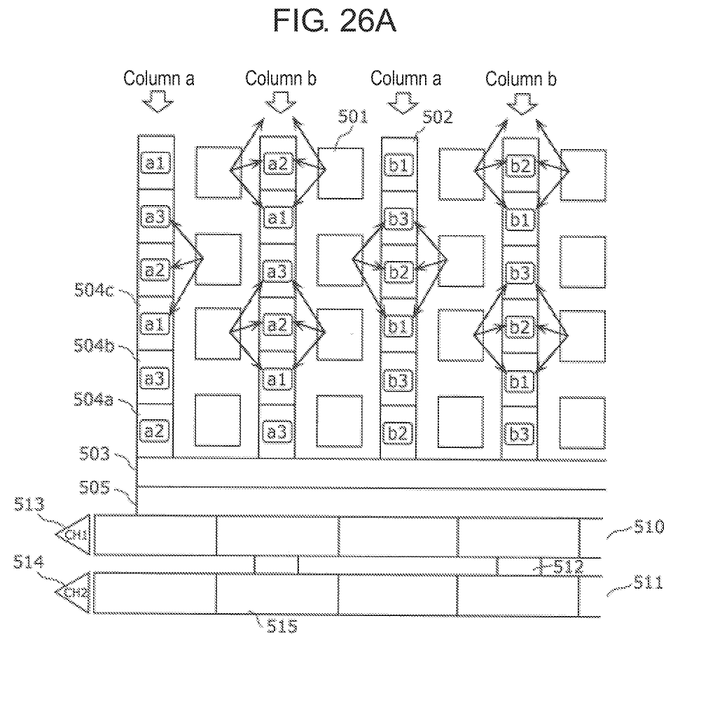

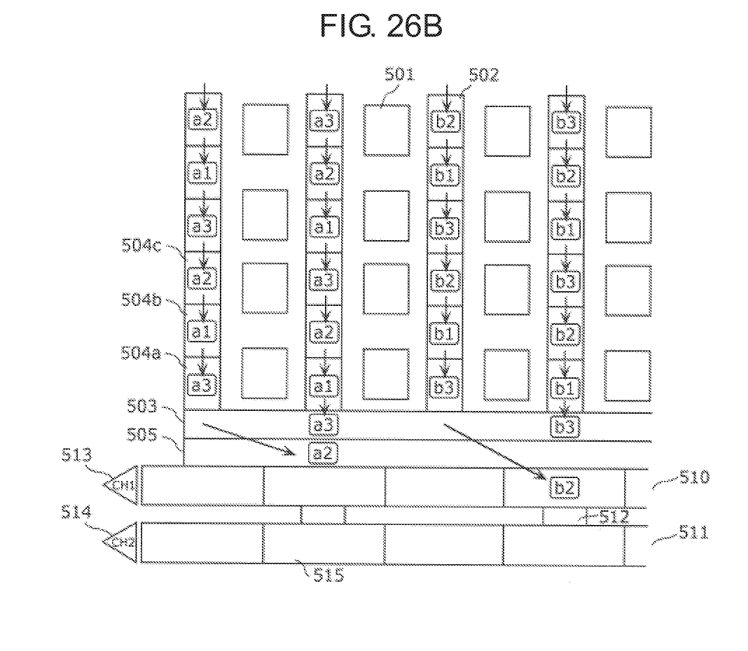

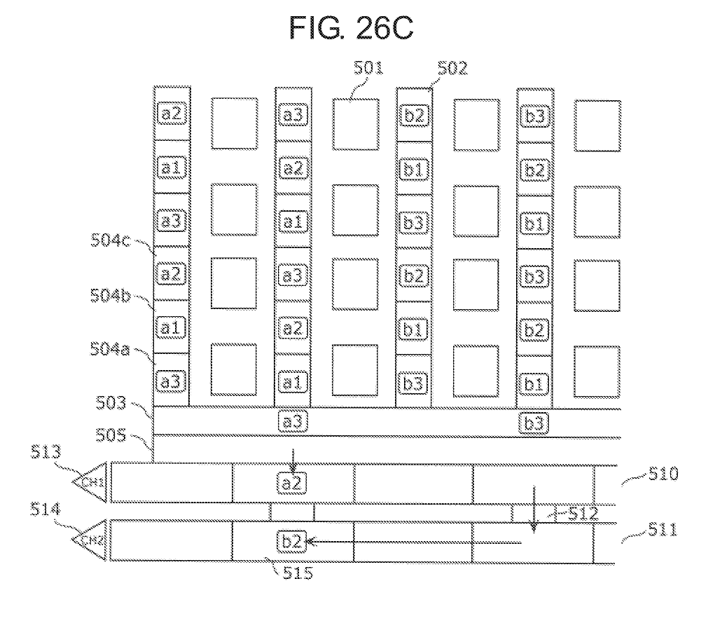

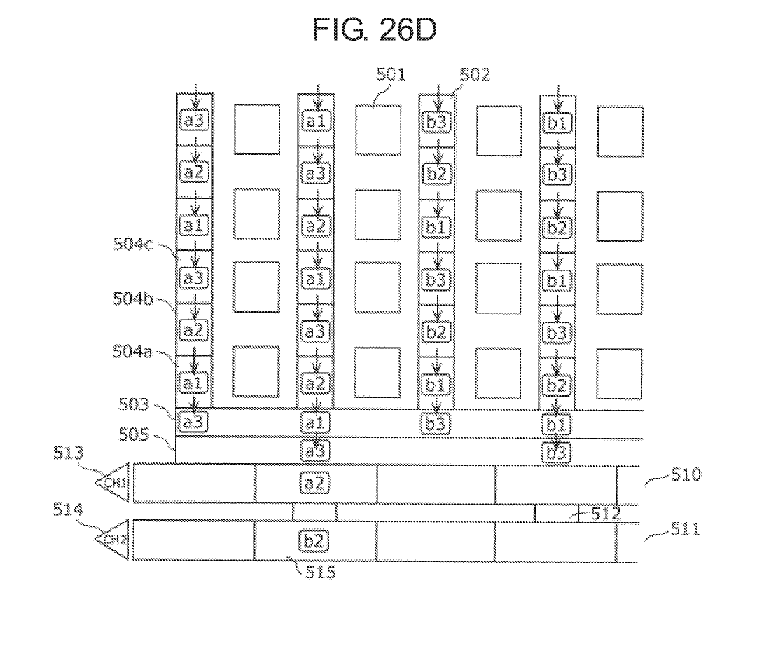

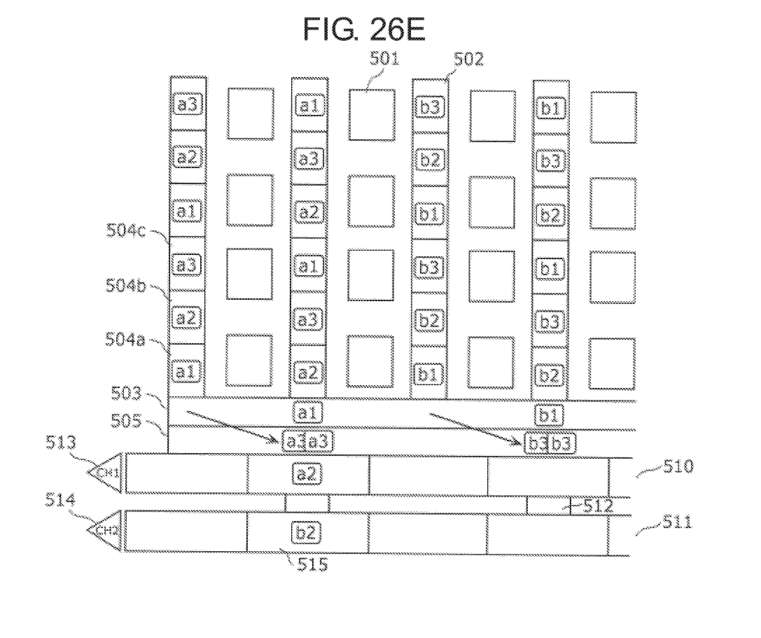

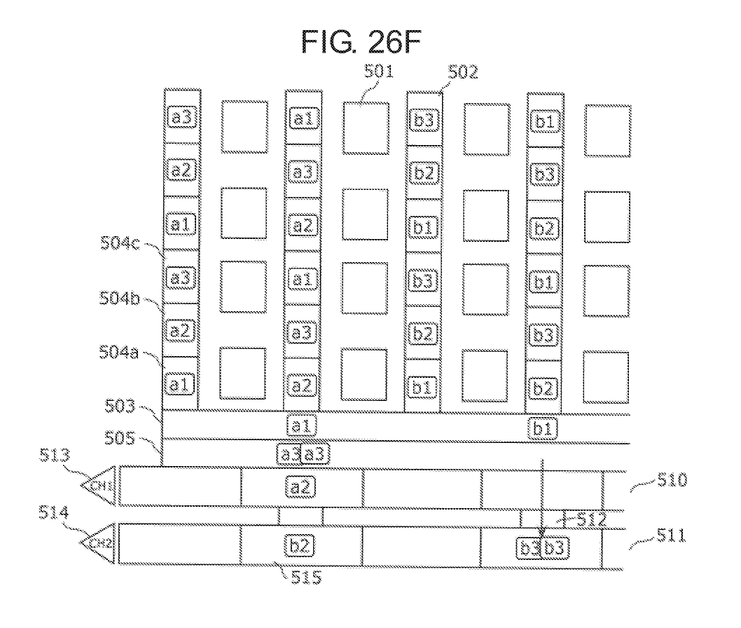

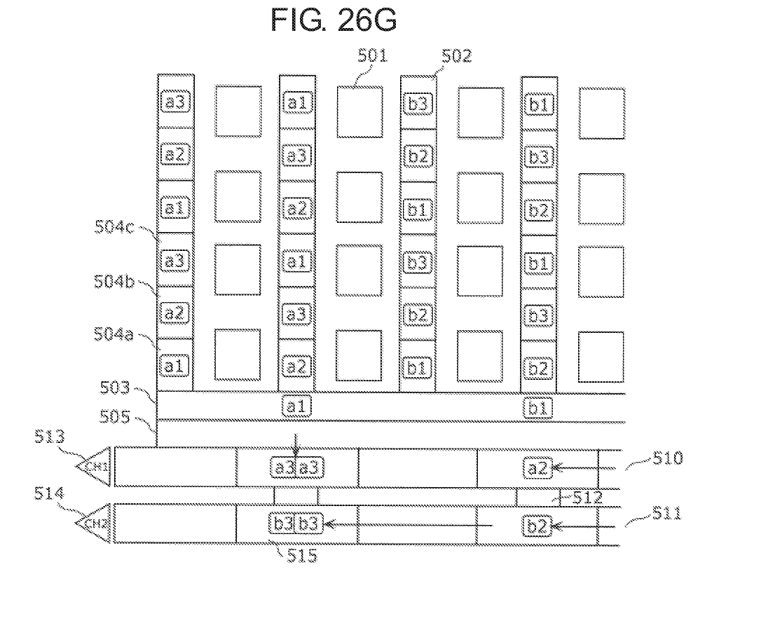

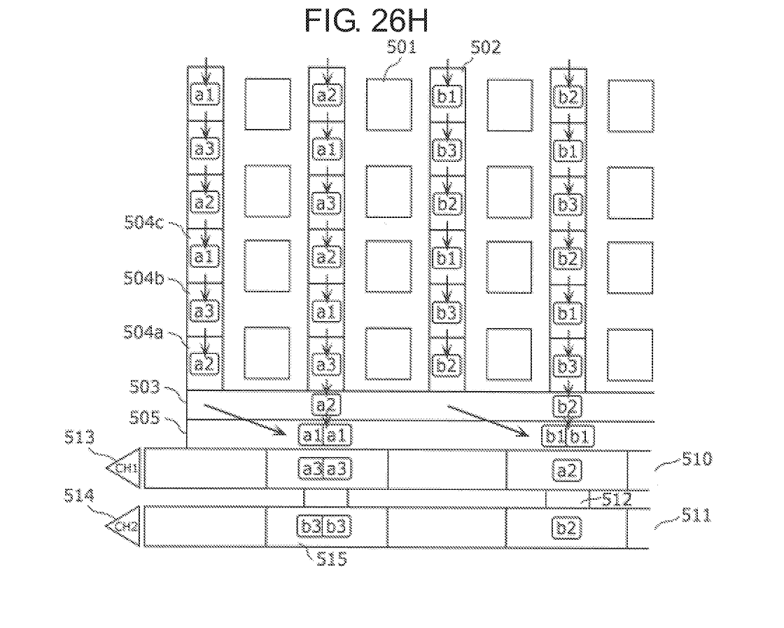

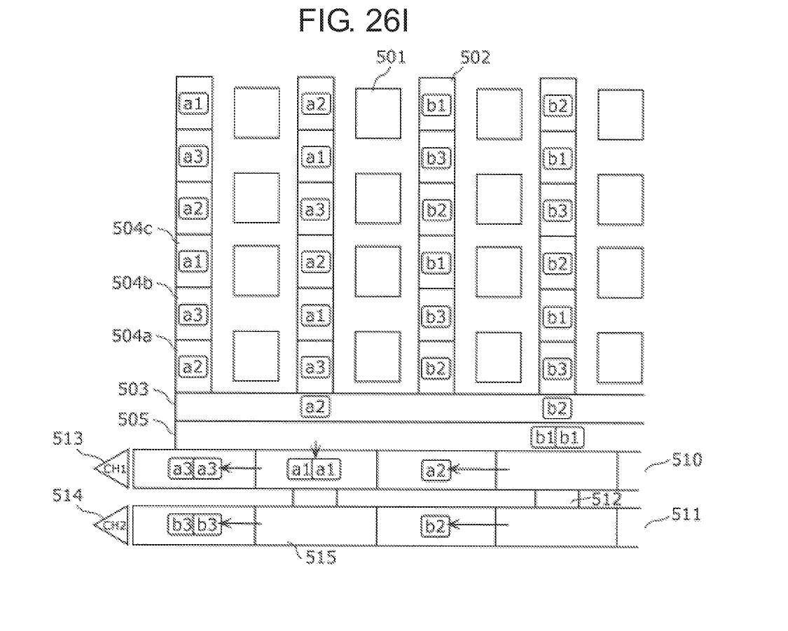

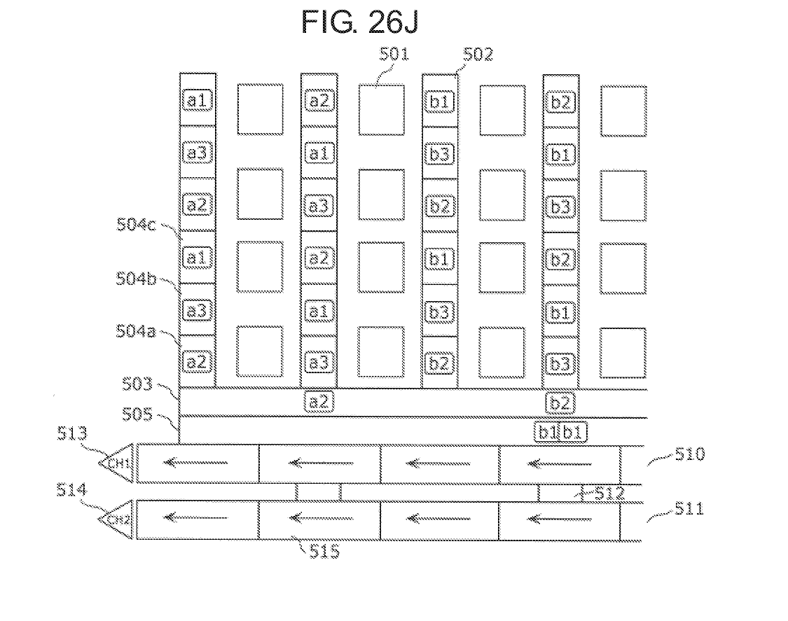

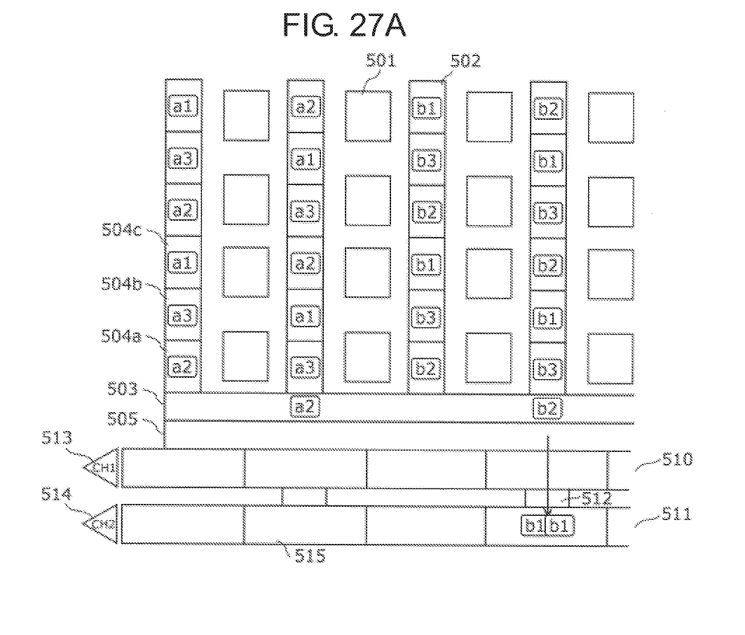

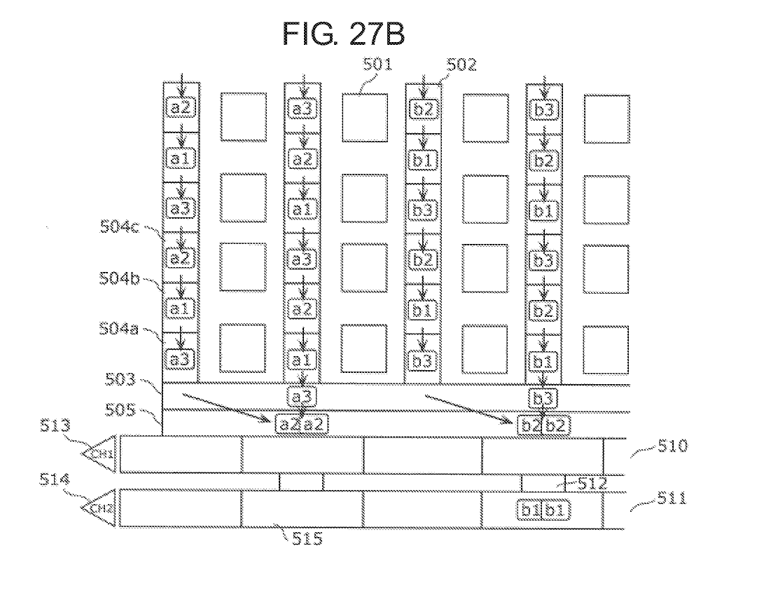

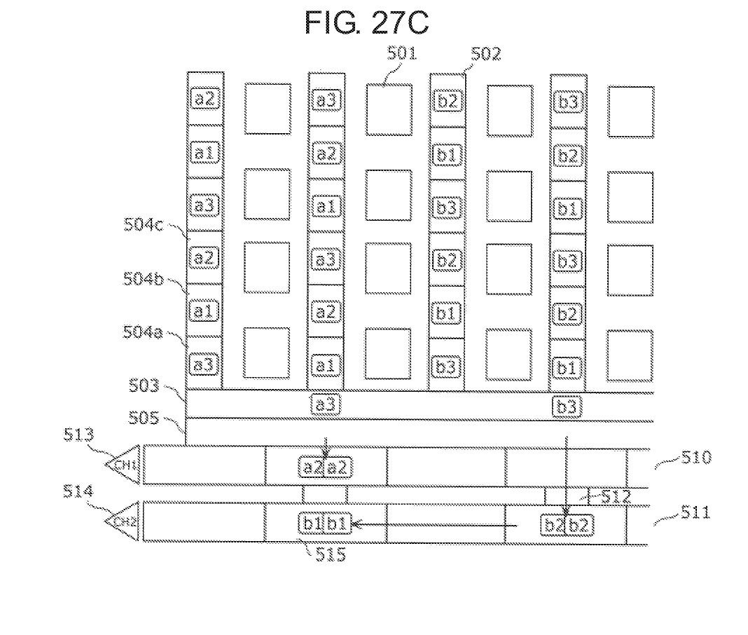

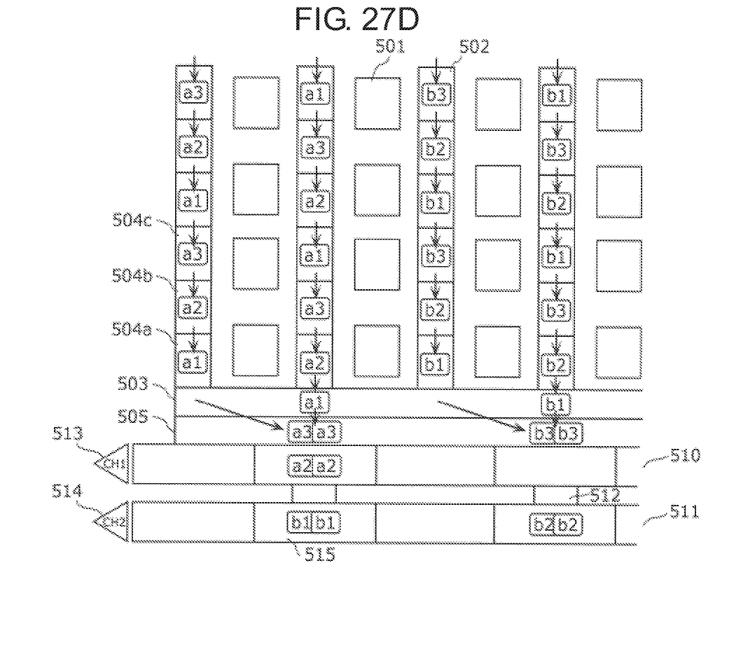

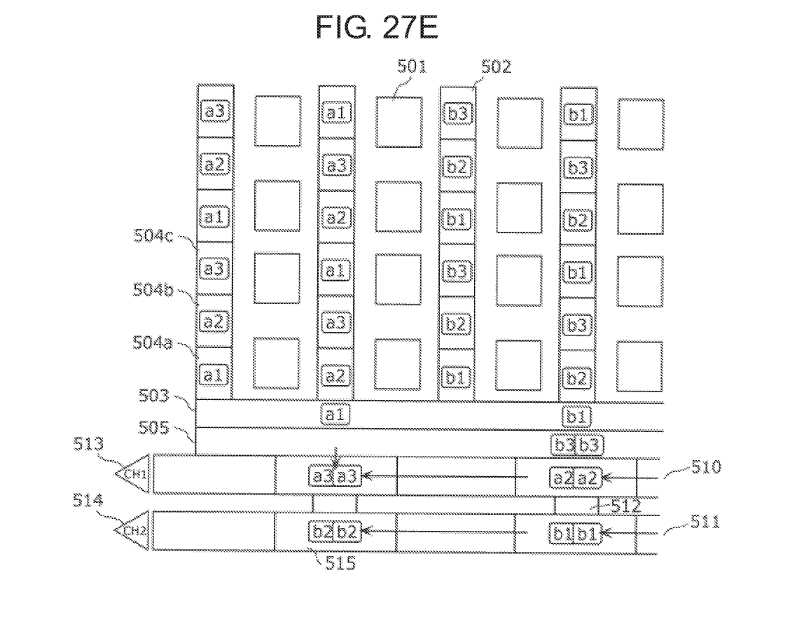

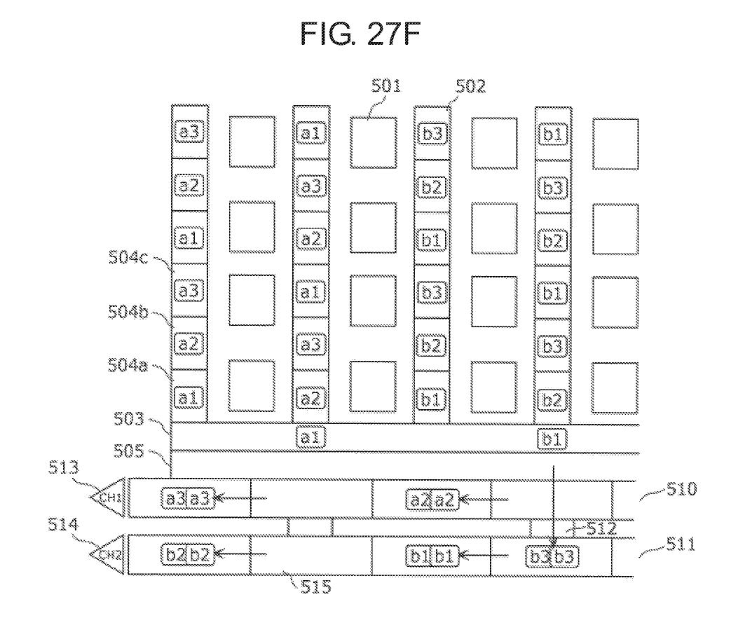

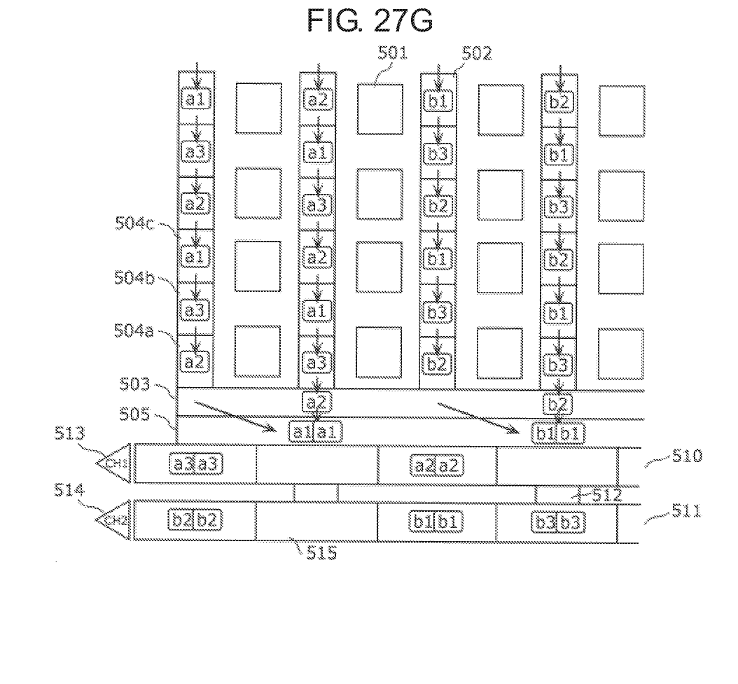

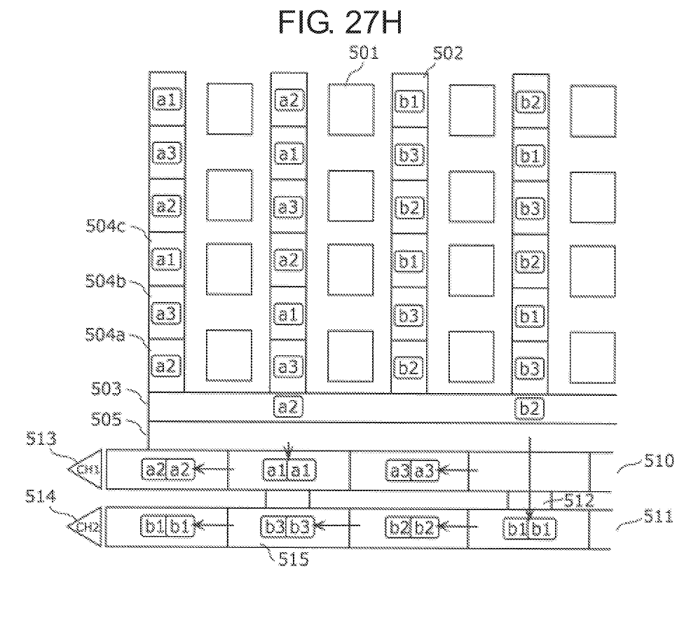

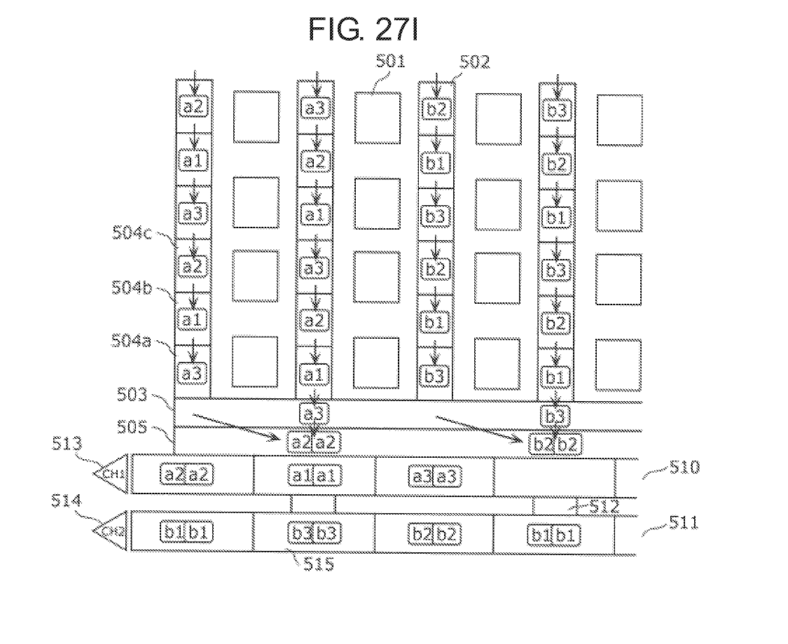

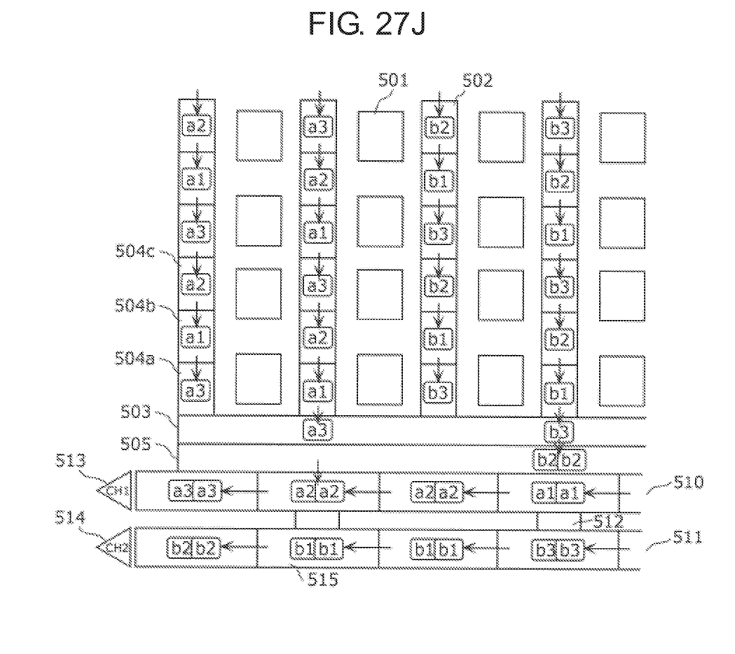

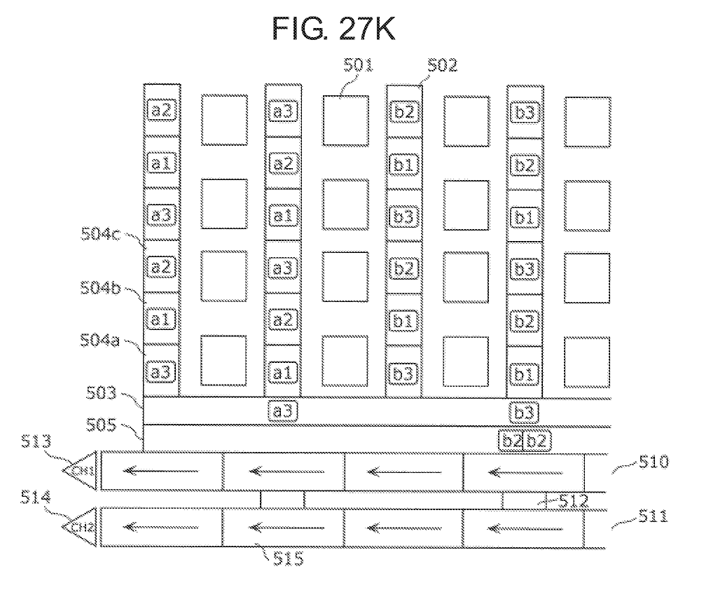

FIGS. 26A to 26J and FIGS. 27A to 27K are diagrams showing an operation of solid-state imaging device 500 in FIG. 25, which uses the second TOF method or the third TOF method. FIGS. 26A to 26J show an operation of solid-state imaging device in a signal readout period, and FIGS. 27A to 27K show an operation of solid-state imaging device 500 in one cycle of a horizontal scanning period.

In the readout period, first, as shown in FIG. 26A, signal charges are read checkerwise from photoelectric converters 501 into packets 504a, 504b, 504c, and stored with the signal charges of horizontally adjacent two pixels added. Here, in the figure, a1, a2, a3 are signal charges stored in vertical transfer units 502 in rows a, and b1, b2, b3 are signal charges stored in vertical transfer units 502 in rows b.

Next, as shown in FIG. 26B, all signal charges stored in vertical transfer units 502 are transferred one stage in a column direction. At this time, signal charges stored in packets in vertical transfer units 502 adjacent to charge controller 503 are transferred from vertical transfer units 502 to charge controller 503. Thereafter, of the signal charges stored in charge controller 503, signal charge a2 is transferred to charge controller 505, and signal charge b3 is transferred through charge controller 505 to first horizontal transfer unit 510.

Next, as shown in FIG. 26C, signal charge b2 stored in first horizontal transfer unit 510 is transferred through inter-horizontal transfer unit 512 to second horizontal transfer unit 511. Thereafter, signal charge b2 stored in second horizontal transfer unit 511 is transferred two stages in a row direction. Thereafter, signal charge a2 stored in charge controller 505 is transferred to first horizontal transfer unit 510.

Next, as shown FIG. 26D, all signal charges stored in vertical transfer units 502 are transferred one stage in the column direction. At this time, the signal charges stored in charge controller 503 are transferred to charge controller 505, and signal charges stored in packets in vertical transfer units 502 adjacent to charge controller 503 are transferred from vertical transfer units 502 to charge controller 503.

Next, as shown in FIG. 26E, signal charges a3 and b3 of the signal charges stored in charge controller 503 are transferred to charge controller 505, and signal charges a3 and a3 and signal charges b3 and b3 that have been stored in horizontally adjacent vertical transfer units 502 are mixed separately.

Next, as shown in FIG. 26F, only signal charges b3 of the signal charges stored in charge controller 505 are transferred through inter-horizontal transfer unit 512 to second horizontal transfer unit 511.

Next, as shown in FIG. 26G, all signal charges stored in first horizontal transfer unit 510 and second horizontal transfer unit 511 are transferred two stages in the row direction. Thereafter, signal charges a3 stored in charge controller 505 are transferred to first horizontal transfer unit 510.

Next, as shown in FIG. 26H, all signal charges stored in vertical transfer units 502 are transferred one stage in the column direction. At this time, the signal charges stored in charge controller 503 are transferred to charge controller 505, and signal charges stored in packets in vertical transfer units 502 adjacent to charge controller 503 are transferred from vertical transfer units 502 to charge controller 503. Thereafter, signal charges a1 and b1 of the signal charges stored in charge controller 503 are transferred to charge controller 505, and signal charges a1 and a1 and signal charges b1 and b1 that have been stored in horizontally adjacent vertical transfer units 502 are mixed, separately.

Next, as shown in FIG. 26I, all the signal charges stored in first horizontal transfer unit 510 and second horizontal transfer unit 511 are transferred one stage in the row direction. Thereafter, only signal charges a1 of the signal charges stored in charge controller 505 are transferred to first horizontal transfer unit 510.

Thereafter, as shown in FIG. 26J, the signal charges stored in first horizontal transfer unit 510 and second horizontal transfer unit 511 are sequentially transferred to first charge detector 513 and second charge detector 514, to complete the readout period.

In a horizontal transfer period, first, as shown in FIG. 27A, only signal charges b1 of signal charges stored in charge controller 505 are transferred through inter-horizontal transfer unit 512 to second horizontal transfer unit 511.

Next, as shown in FIG. 27B, all signal charges stored in vertical transfer units 502 are transferred one stage in the column direction. At this time, the signal charges stored in charge controller 503 are transferred to charge controller 505, and signal charges stored in packets in vertical transfer units 502 adjacent to charge controller 503 are transferred from vertical transfer units 502 to charge controller 503. Thereafter, signal charges a2 and b2 of the signal charges stored in charge controller 503 are transferred to charge controller 505, and signal charges a2 and a2 and signal charges b2 and b2 that have been stored in horizontally adjacent vertical transfer units 502 are mixed separately.

Next, as shown in FIG. 27C, signal charges b1 stored in second horizontal transfer unit 511 are transferred two stages in the row direction. Thereafter, of the signal charges stored in charge controller 505, signal charges a2 are transferred to first horizontal transfer unit 510, and signal charges b2 are transferred through inter-horizontal transfer unit 512 to second horizontal transfer unit 511.

Next, as shown in FIG. 27D, all signal charges stored in vertical transfer units 502 are transferred one stage in the column direction. At this time, the signal charges stored in charge controller 503 are transferred to charge controller 505, and signal charges stored in packets in vertical transfer units 502 adjacent to charge controller 503 are transferred from vertical transfer units 502 to charge controller 503. Thereafter, signal charges a3 and b3 of the signal charges stored in charge controller 503 are transferred to charge controller 505, and signal charges a3 and a3 and signal charges b3 and b3 that have been stored in horizontally adjacent vertical transfer units 502 are mixed separately.

Next, as shown in FIG. 27E, all the signal charges stored in first horizontal transfer unit 510 and second horizontal transfer unit 511 are transferred two stages in the row direction. Thereafter, signal charges a3 stored in charge controller 505 are transferred to first horizontal transfer unit 510.

Next, as shown in FIG. 27F, all the signal charges stored in first horizontal transfer unit 510 and second horizontal transfer unit 511 are transferred two stages in the row direction. Thereafter, signal charges b3 stored in charge controller 505 are transferred through inter-horizontal transfer unit 512 to second horizontal transfer unit 511.

Next, as shown in FIG. 27G, all signal charges stored in vertical transfer units 502 are transferred one stage in the column direction. At this time, the signal charges stored in charge controller 503 are transferred to charge controller 505, and signal charges stored in packets in vertical transfer units 502 adjacent to charge controller 503 are transferred from vertical transfer units 502 to charge controller 503. Thereafter, signal charges a1 and b1 of the signal charges stored in charge controller 503 are transferred to charge controller 505, and signal charges a1 and a1 and signal charges b1 and b1 that have been stored in horizontally adjacent vertical transfer units 502 are mixed separately.

Next, as shown in FIG. 27H, all the signal charges stored in first horizontal transfer unit 510 and second horizontal transfer unit 511 are transferred two stages in the row direction. Thereafter, of the signal charges stored in charge controller 505, signal charges a1 are transferred to first horizontal transfer unit 510, and signal charges b1 are transferred through inter-horizontal transfer unit 512 to second horizontal transfer unit 511.

Next, as shown in FIG. 27I, all signal charges stored in vertical transfer units 502 are transferred one stage in the column direction. At this time, the signal charges stored in charge controller 503 are transferred to charge controller 505, and signal charges stored in packets in vertical transfer units 502 adjacent to charge controller 503 are transferred from vertical transfer units 502 to charge controller 503. Thereafter, signal charges a2 and b2 of the signal charges stored in charge controller 503 are transferred to charge controller 505, and signal charges a2 and a2 and signal charges b2 and b2 that have been stored in horizontally adjacent vertical transfer units 502 are mixed separately.

Next, as shown in FIG. 27J, all the signal charges stored in first horizontal transfer unit 510 and second horizontal transfer unit 511 are transferred two stages in the row direction. Thereafter, only signal charges a2 of the signal charges stored in charge controller 505 are transferred to first horizontal transfer unit 510.

Thereafter, as shown in FIG. 27K, the signal charges stored in first horizontal transfer unit 510 and second horizontal transfer unit 511 are sequentially transferred to first charge detector 513 and second charge detector 514.

Here, when attention is paid to signal charges a1 to a3, as shown in FIG. 27J, signal charges a1 to a3 are all output from first charge detector 513. In solid-state imaging device 500 according to this exemplary embodiment including horizontal transfer units (first horizontal transfer unit 510 and second horizontal transfer unit 511) each including one packet 515 for one vertical transfer unit 502, and one inter-horizontal transfer unit 512, three signal charges read from one photoelectric converter 501 are horizontally added in twos, and output separately in 0.75 horizontal scanning periods. That is, a horizontal transfer unit (first horizontal transfer unit 510 or second horizontal transfer unit 511) including (1/K) packet for one vertical transfer unit 502, and (L−1) inter-horizontal transfer unit 512 are provided, and M signal charges read from one photoelectric converter 501 are horizontally added in Ns, and are output separately in [(K·M)/(L·N)] horizontal scanning period. When there is no horizontal addition of signal charges, N=1.

Signal charges output from solid-state imaging device 500 are converted into a image for measuring a distance by signal processor 207 (see FIG. 12), and may also be converted into a visible image depending on a use.

As above, solid-state imaging device 500 according to the fifth exemplary embodiment allows a plurality of signal charges read from one photoelectric converter to be output from the same charge detector even when two signal charges that are horizontally adjacent to each other and are of the same exposure period are added in charge controller 505. Therefore, solid-state imaging device 500 can further increase a frame rate of a distance measurement camera without degrading ranging precision since a number of signals is halved and signal transfer time is reduced, compared to solid-state imaging device 400 according to the fourth exemplary embodiment.

Although solid-state imaging device 500 according to this exemplary embodiment adds signal charges of horizontally adjacent two pixels in charge controller, these signal charges may be added in first horizontal transfer unit 510.

### Sixth Exemplary Embodiment

Next, a sixth exemplary embodiment will be described.

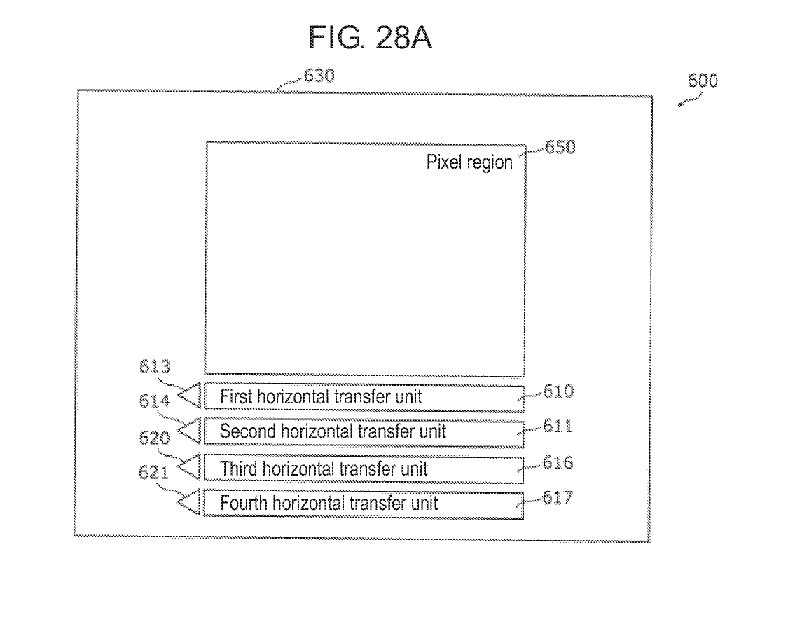

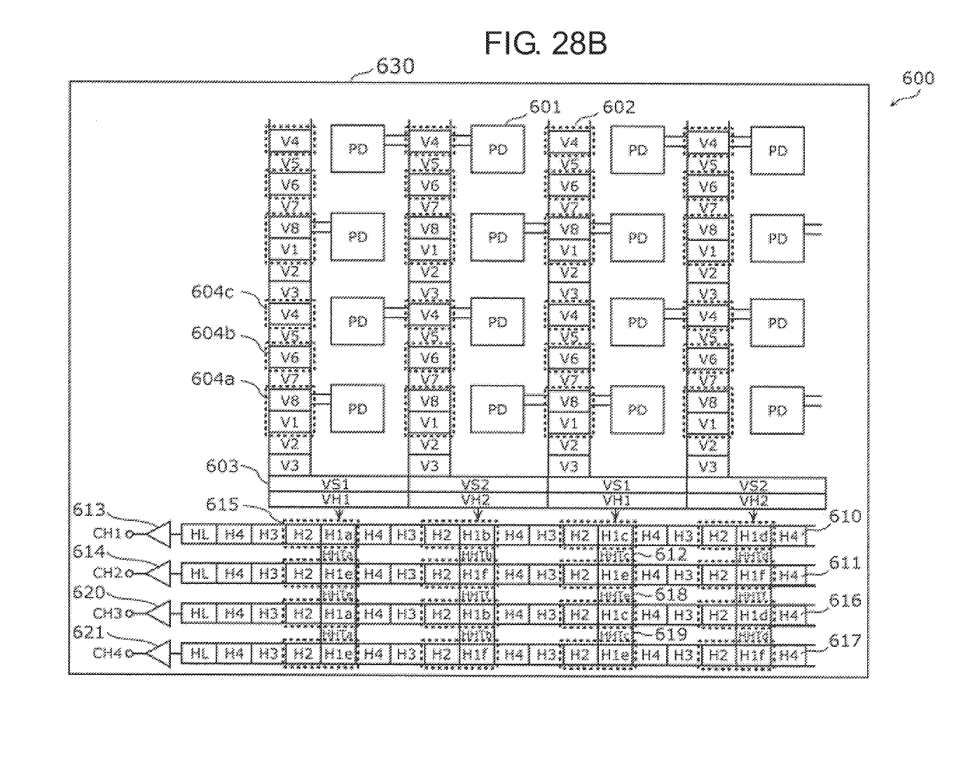

FIG. 28A is a plan view showing a configuration of a solid-state imaging device according to the sixth exemplary embodiment. FIG. 28B is a diagram showing a part of the configuration of the solid-state imaging device according to this exemplary embodiment. In FIG. 28B, only components of four pixels in a vertical direction and of four pixels in a horizontal direction are shown for simplification.

Compared to solid-state imaging device 400 according to the fourth exemplary embodiment, solid-state imaging device 600 according to the sixth exemplary embodiment further includes third horizontal transfer unit 616, fourth horizontal transfer unit 617, second inter-horizontal transfer unit 618, third inter-horizontal transfer unit 619, third charge detector 620, and fourth charge detector 621, and due to it, is different in a driving method in a readout period and in a horizontal scanning period. However, solid-state imaging device 600 is the same as solid-state imaging device 400 according to the fourth exemplary embodiment in that solid-state imaging device 600 is aimed at providing a configuration and a driving method that allow a plurality of signal charges read from one photoelectric converter 601 to be output from the same charge detector. Hereinafter, differences from the fourth exemplary embodiment will be mainly described, and the same points will not be described.

Compared to solid-state imaging device 400 in FIG. 22, in solid-state imaging device 600 shown in FIG. 28B, first inter-horizontal transfer unit 612, second inter-horizontal transfer unit 618, and third inter-horizontal transfer unit 619 are provided with one electrode per pixel.

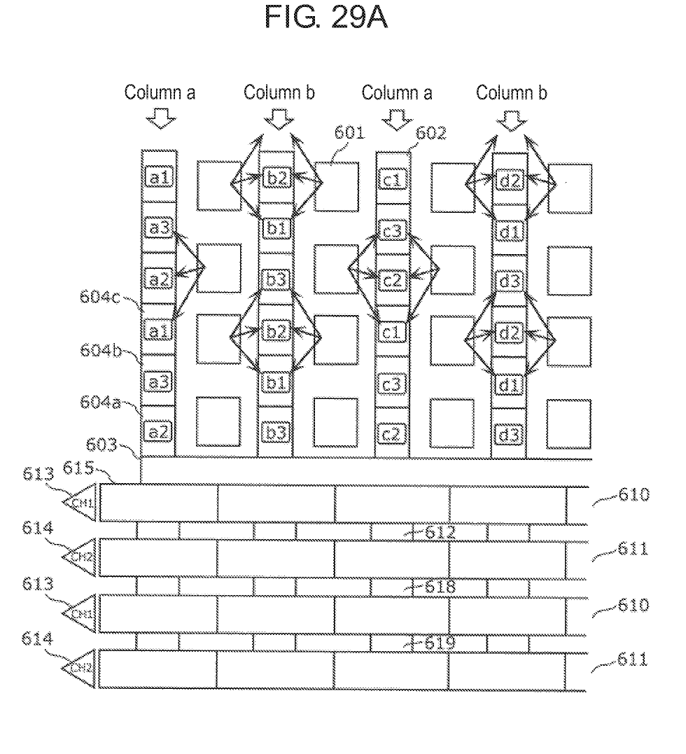

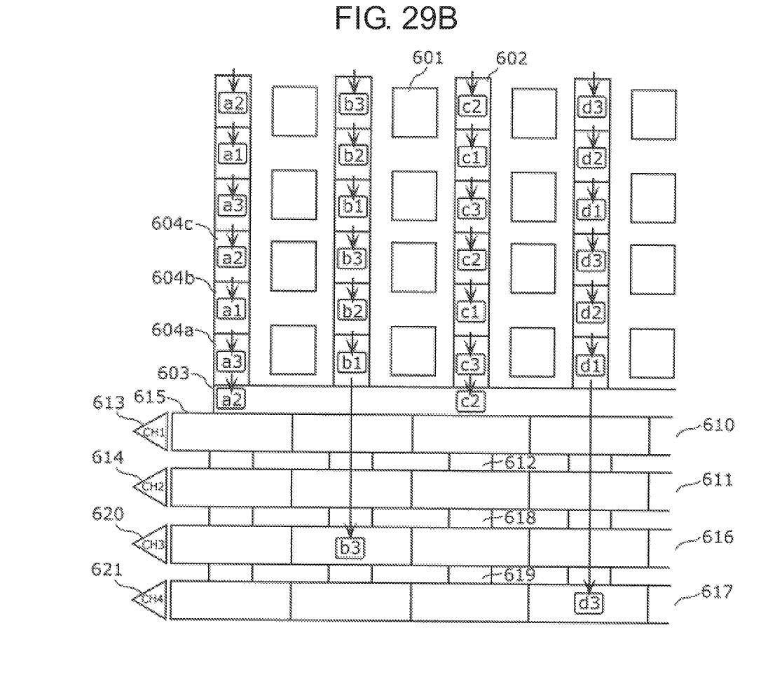

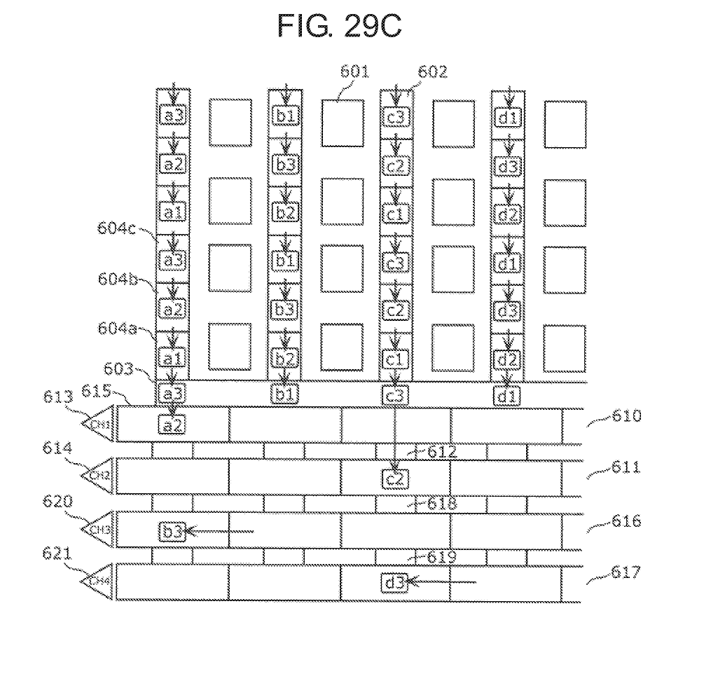

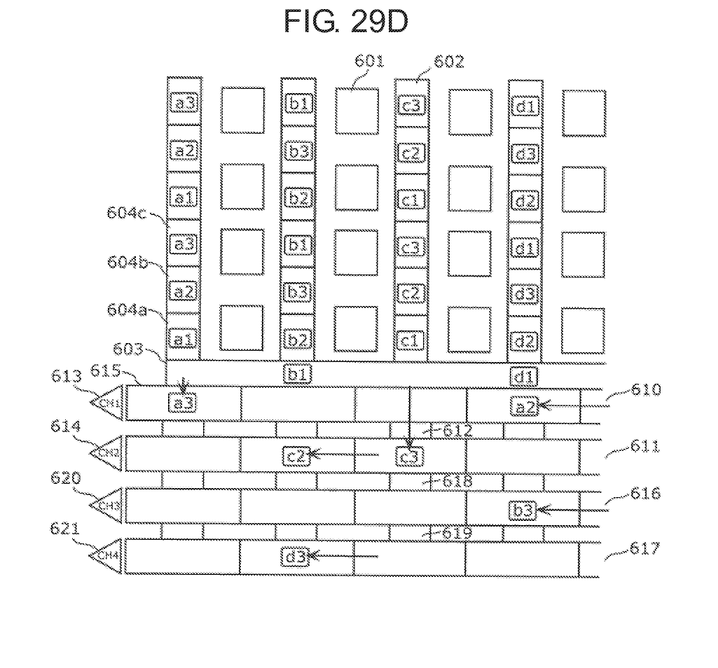

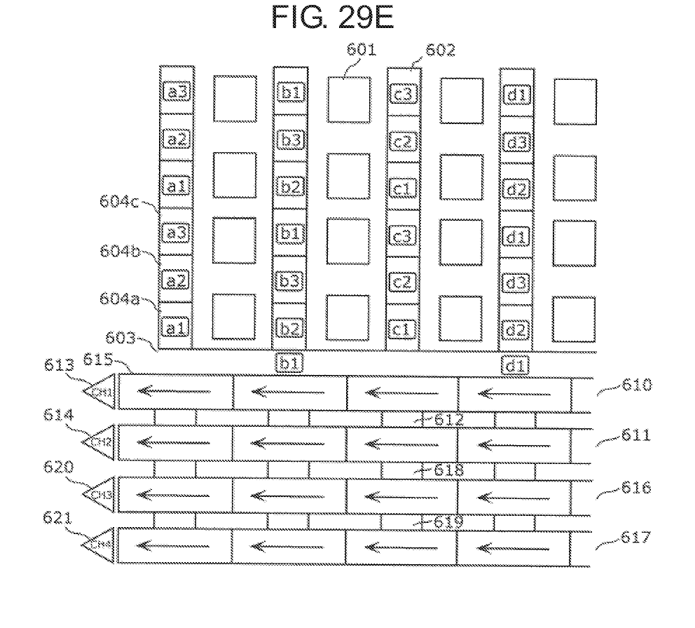

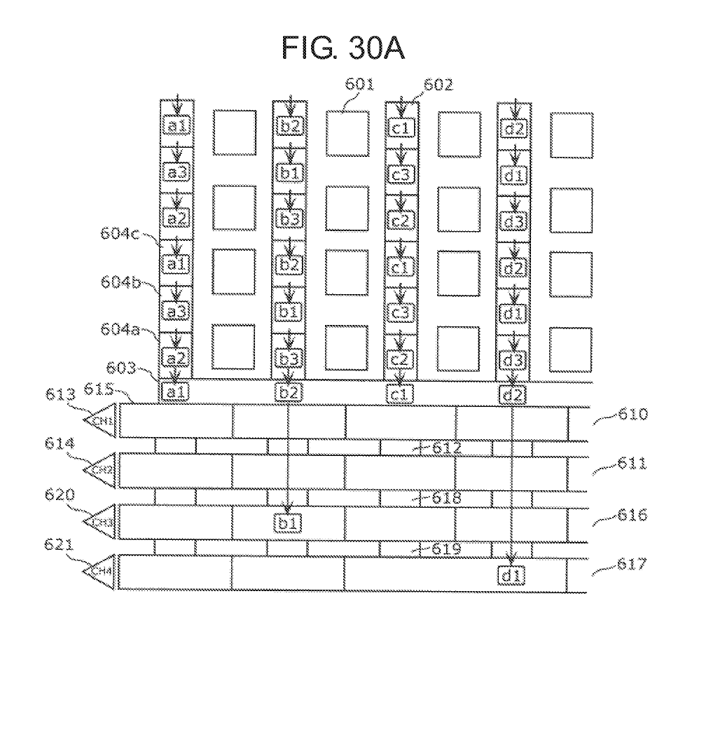

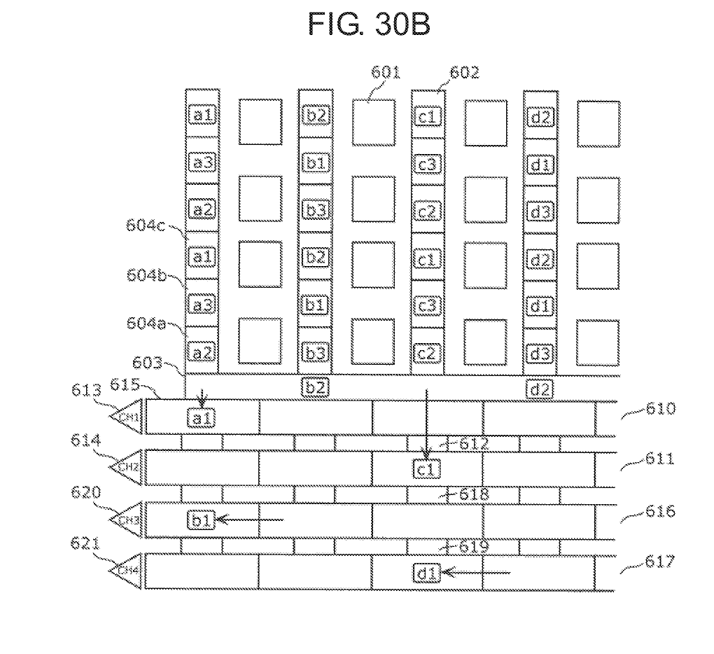

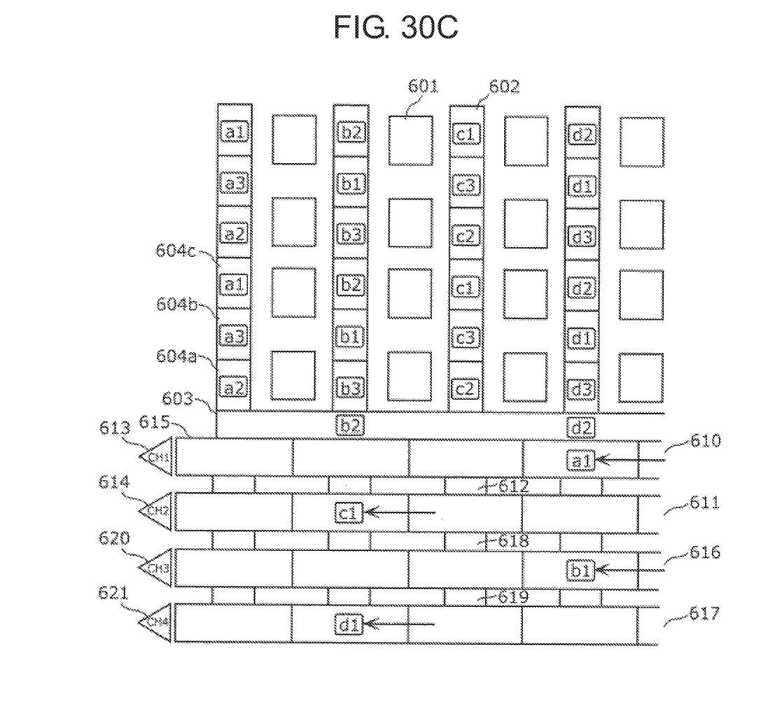

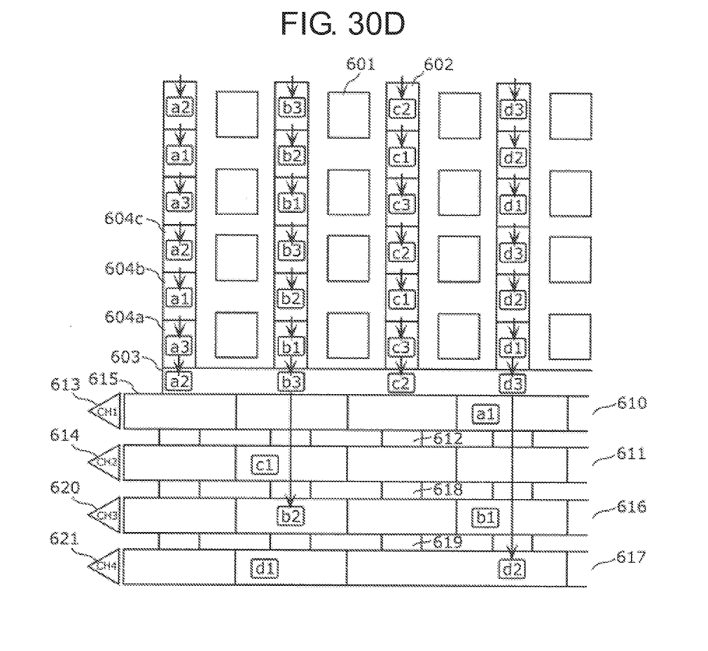

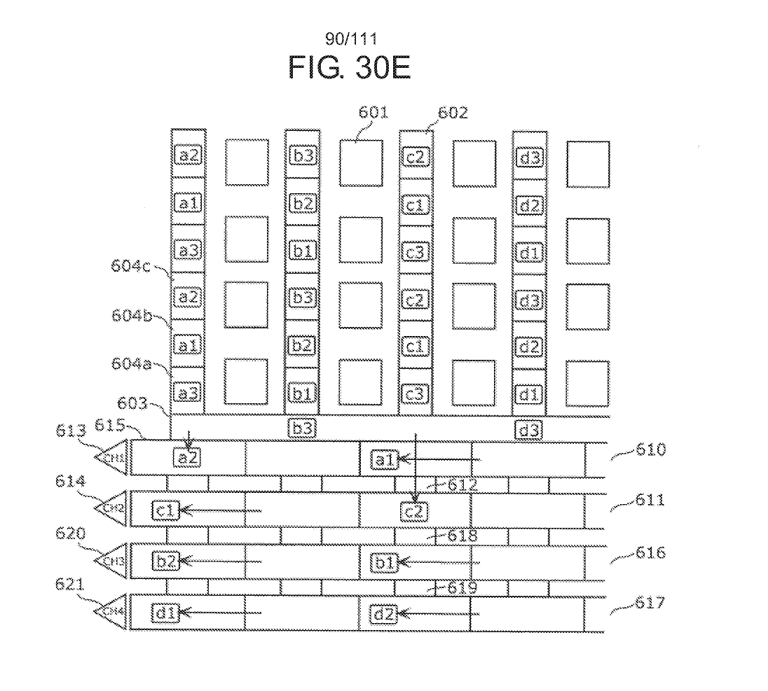

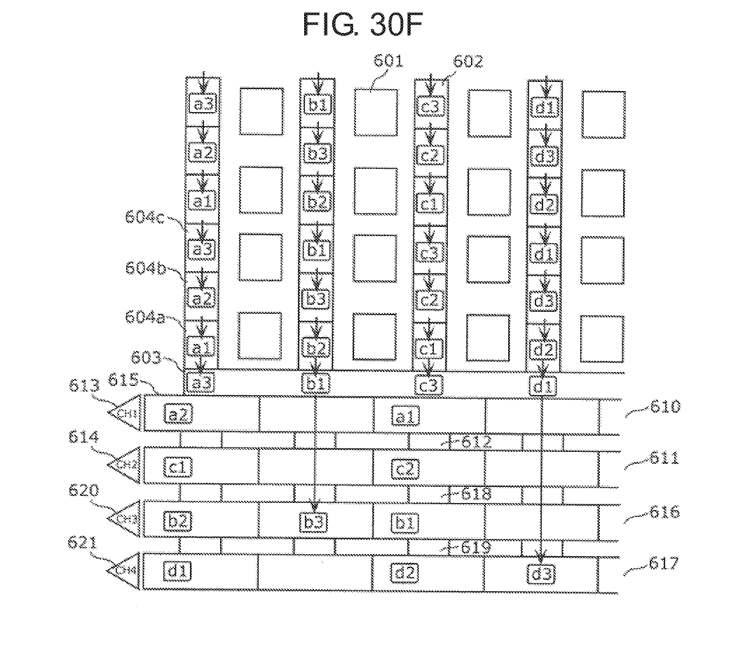

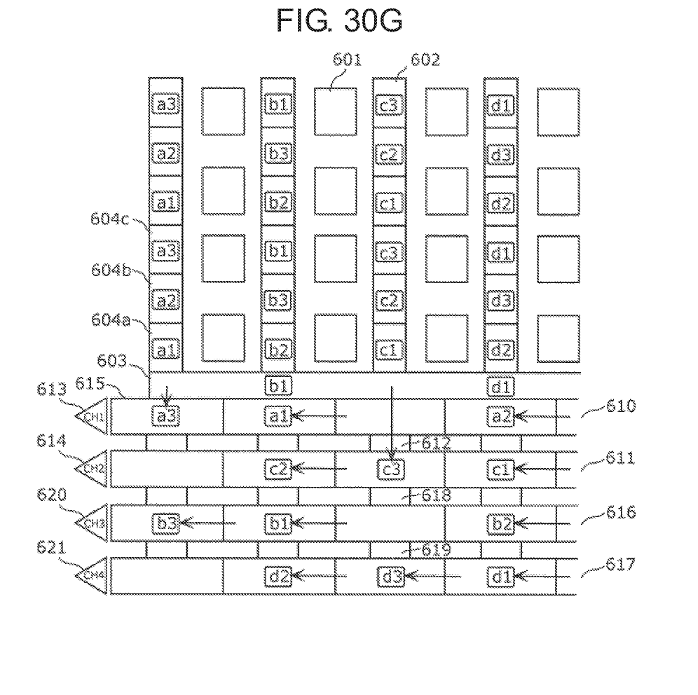

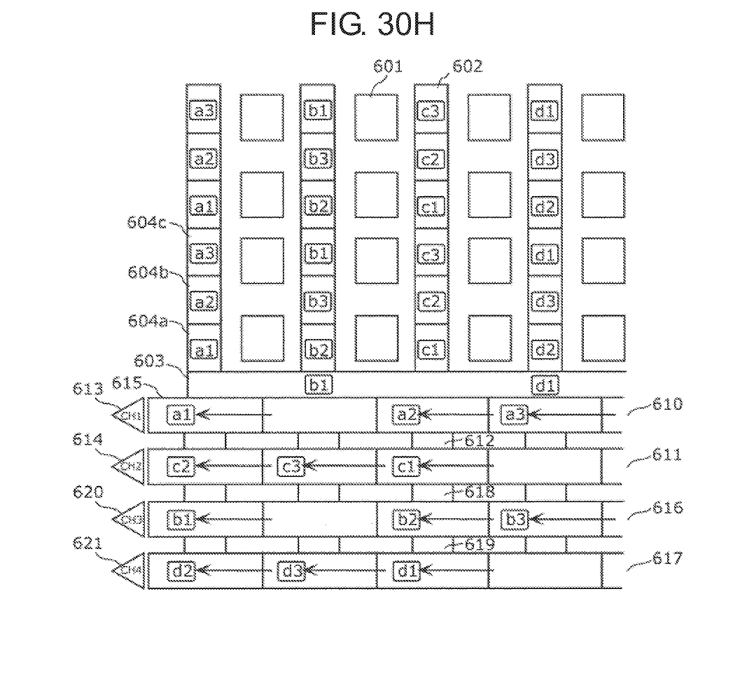

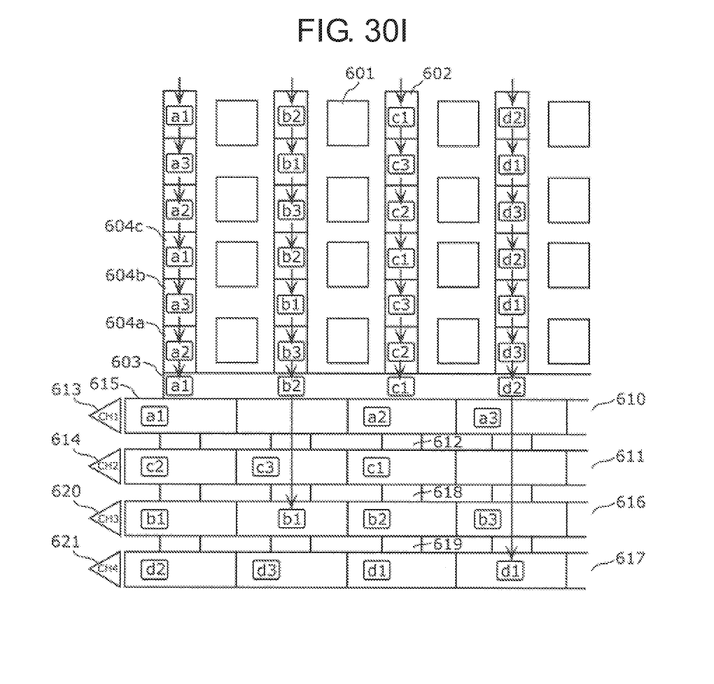

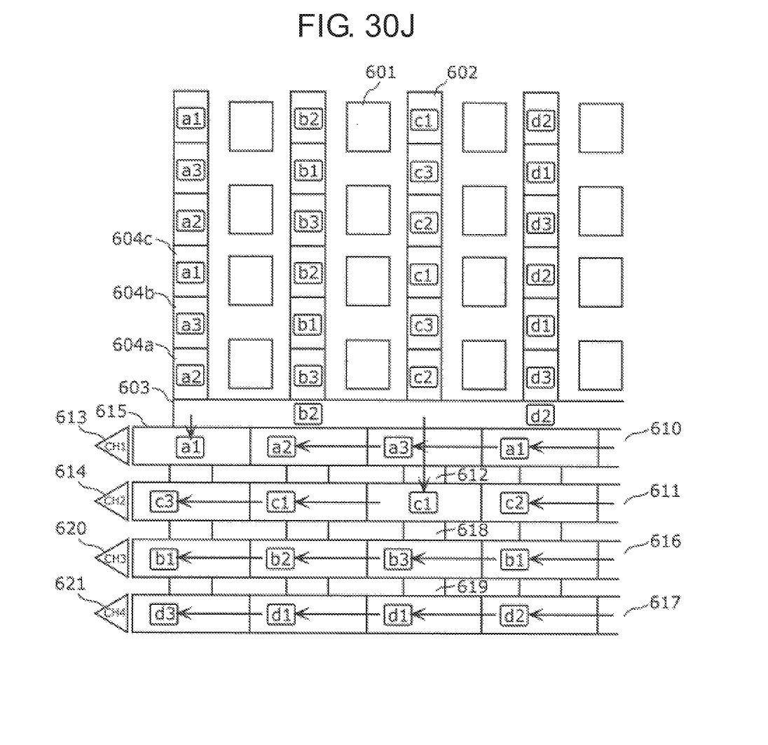

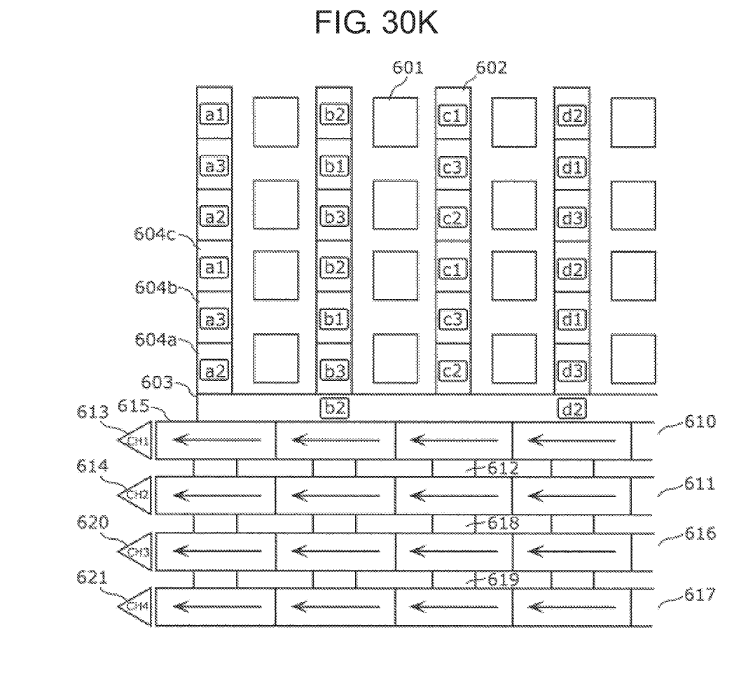

FIGS. 29A to 29E and FIGS. 30A to 30K are diagrams showing an operation of solid-state imaging device 600 in FIG. 28B, which uses the second TOF method or the third TOF method. FIGS. 29A to 29E show an operation of solid-state imaging device in a signal readout period, and FIGS. 30A to 30K show an operation of solid-state imaging device in one cycle of a horizontal scanning period.

In the readout period, first, as shown in FIG. 29A, signal charges are read checkerwise from photoelectric converters 601 into packets 604a, 604b, 604c, and stored with the signal charges of horizontally adjacent two pixels added. Here, in the figure, a1, a2, a3 are signal charges stored in vertical transfer unit 602 in row a, b1, b2, b3 are signal charges stored in vertical transfer unit 602 in row b, c1, c2, c3 are signal charges stored in vertical transfer unit 602 in row c, and d1, d2, d3 are signal charges stored in vertical transfer unit 602 in row d.

Next, as shown in FIG. 29B, all signal charges stored in vertical transfer units 602 are transferred one stage in a column direction. At this time, signal charges stored in packets in vertical transfer units 602 adjacent to charge controller 603 are transferred from vertical transfer units 602 to charge controller 603. Thereafter, of the signal charges stored in charge controller 603, signal charge b3 is transferred to third horizontal transfer unit 616, and signal charge d3 is transferred to fourth horizontal transfer unit 617.

Next, as shown in FIG. 29C, all the signal charges stored in first horizontal transfer unit 610, second horizontal transfer unit 611, third horizontal transfer unit 616, and fourth horizontal transfer unit 617 are transferred one stage in a row direction. Thereafter, of the signal charges stored in charge controller 603, signal charge a2 is transferred to first horizontal transfer unit 610, and signal charge c2 is transferred to second horizontal transfer unit 611. Thereafter, all signal charges stored in vertical transfer units 602 are transferred one stage in the column direction. At this time, signal charges stored in packets in vertical transfer units 602 adjacent to charge controller 603 are transferred from vertical transfer units 602 to charge controller 603.

Next, as shown in FIG. 29D, all the signal charges stored in first horizontal transfer unit 610, second horizontal transfer unit 611, third horizontal transfer unit 616, and fourth horizontal transfer unit 617 are transferred one stage in the row direction. Thereafter, of the signal charges stored in charge controller 603, signal charge a3 is transferred to first horizontal transfer unit 610, and signal charge c3 is transferred to second horizontal transfer unit 611.

Thereafter, as shown in FIG. 29E, the signal charges stored in first horizontal transfer unit 610, second horizontal transfer unit 611, third horizontal transfer unit 616, and fourth horizontal transfer unit 617 are sequentially transferred to first charge detector 613, second charge detector 614, third charge detector 620, and fourth charge detector 621, to complete the readout period.

In a horizontal transfer period, first, as shown in FIG. 30A, of the signal charges stored in charge controller 603, signal charge b1 is transferred to third horizontal transfer unit 616, and signal charge d1 is transferred to fourth horizontal transfer unit 617. Thereafter, all signal charges stored in vertical transfer units 602 are transferred one stage in the column direction. At this time, signal charges stored in packets in vertical transfer units 602 adjacent to charge controller 603 are transferred from vertical transfer units 602 to charge controller 603.

Next, as shown in FIG. 30B, all the signal charges stored in first horizontal transfer unit 610, second horizontal transfer unit 611, third horizontal transfer unit 616, and fourth horizontal transfer unit 617 are transferred one stage in the row direction. Thereafter, of the signal charges stored in charge controller 603, signal charge a1 is transferred to first horizontal transfer unit 610, and signal charge c1 is transferred to second horizontal transfer unit 611.

Next, as shown in FIG. 30C, all the signal charges stored in first horizontal transfer unit 610, second horizontal transfer unit 611, third horizontal transfer unit 616, and fourth horizontal transfer unit 617 are transferred one stage in the row direction.

Next, as shown in FIG. 30D, of the signal charges stored in charge controller 603, signal charge b2 is transferred to third horizontal transfer unit 616, and signal charge d2 is transferred to fourth horizontal transfer unit 617. Thereafter, all signal charges stored in vertical transfer units 602 are transferred one stage in the column direction. At this time, signal charges stored in packets in vertical transfer units 602 adjacent to charge controller 603 are transferred from vertical transfer units 602 to charge controller 603.

Next, as shown in FIG. 30E, all the signal charges stored in first horizontal transfer unit 610, second horizontal transfer unit 611, third horizontal transfer unit 616, and fourth horizontal transfer unit 617 are transferred one stage in the row direction. Thereafter, of the signal charges stored in charge controller 603, signal charge a2 is transferred to first horizontal transfer unit 610, and signal charge c2 is transferred to second horizontal transfer unit 611.

Next, as shown in FIG. 30F, of the signal charges stored in charge controller 603, signal charge b3 is transferred to third horizontal transfer unit 616, and signal charge d3 is transferred to fourth horizontal transfer unit 617. Thereafter, all signal charges stored in vertical transfer units 602 are transferred one stage in the column direction. At this time, signal charges stored in packets in vertical transfer units 602 adjacent to charge controller 603 are transferred from vertical transfer units 602 to charge controller 603.

Next, as shown in FIG. 30G, all the signal charges stored in first horizontal transfer unit 610, second horizontal transfer unit 611, third horizontal transfer unit 616, and fourth horizontal transfer unit 617 are transferred one stage in the row direction. Thereafter, of the signal charges stored in charge controller 603, signal charge a3 is transferred to first horizontal transfer unit 610, and signal charge c3 is transferred to second horizontal transfer unit 611.

Next, as shown in FIG. 30H, all the signal charges stored in first horizontal transfer unit 610, second horizontal transfer unit 611, third horizontal transfer unit 616, and fourth horizontal transfer unit 617 are transferred one stage in the row direction.

Next, as shown in FIG. 30I, of the signal charges stored in charge controller 603, signal charge b1 is transferred to third horizontal transfer unit 616, and signal charge d1 is transferred to fourth horizontal transfer unit 617. Thereafter, all signal charges stored in vertical transfer units 602 are transferred one stage in the column direction. At this time, signal charges stored in packets in vertical transfer units 602 adjacent to charge controller 603 are transferred from vertical transfer units 602 to charge controller 603.

Next, as shown in FIG. 30J, all the signal charges stored in first horizontal transfer unit 610, second horizontal transfer unit 611, third horizontal transfer unit 616, and fourth horizontal transfer unit 617 are transferred one stage in the row direction. Thereafter, of the signal charges stored in charge controller 603, signal charge a1 is transferred to first horizontal transfer unit 610, and signal charge c1 is transferred to second horizontal transfer unit 611.

Thereafter, as shown in FIG. 30K, the signal charges stored in first horizontal transfer unit 610, second horizontal transfer unit 611, third horizontal transfer unit 616, and fourth horizontal transfer unit 617 are sequentially transferred to first charge detector 613, second charge detector 614, third charge detector 620, and fourth charge detector 621.

Here, when attention is paid to signal charges a1 to a3, as shown in FIG. 30J, signal charges a1 to a3 are all output from first charge detector 613. Three signal charges read from horizontal transfer units (first horizontal transfer unit 610, second horizontal transfer unit 611, third horizontal transfer unit 616, and fourth horizontal transfer unit 617) each including one packet 615 for one vertical transfer unit 602, and three inter-horizontal transfer units (first inter-horizontal transfer unit 612, second inter-horizontal transfer unit 618, and third inter-horizontal transfer unit 619) are output separately in 0.75 horizontal scanning periods without being added horizontally. That is, a horizontal transfer unit (first horizontal transfer unit 610 or second horizontal transfer unit 611) including (1/K) packet for one vertical transfer unit 602, and (L−1) inter-horizontal transfer units (first inter-horizontal transfer unit 612, second inter-horizontal transfer unit 618, and third inter-horizontal transfer unit 619) are provided, and M signal charges read from one photoelectric converter 601 are horizontally added in Ns, and are output separately in [(K·M)/(L·N)] horizontal scanning period. When there is no horizontal addition of signal charges, N=1.

Signal charges output from solid-state imaging device 600 are converted into a image for measuring a distance by signal processor 207 (see FIG. 12), and may also be converted into a visible image depending on a use.

As above, solid-state imaging device 600 according to the sixth exemplary embodiment allows a plurality of signal charges read from one photoelectric converter 601 to be output from the same charge detector even when four horizontal transfer units and four charge detectors are provided. This can further increase a frame rate of a distance measurement camera without degrading ranging precision since signal transfer time is reduced, compared to solid-state imaging device 400 according to the fourth exemplary embodiment.

### Seventh Exemplary Embodiment

Next, a seventh exemplary embodiment will be described.

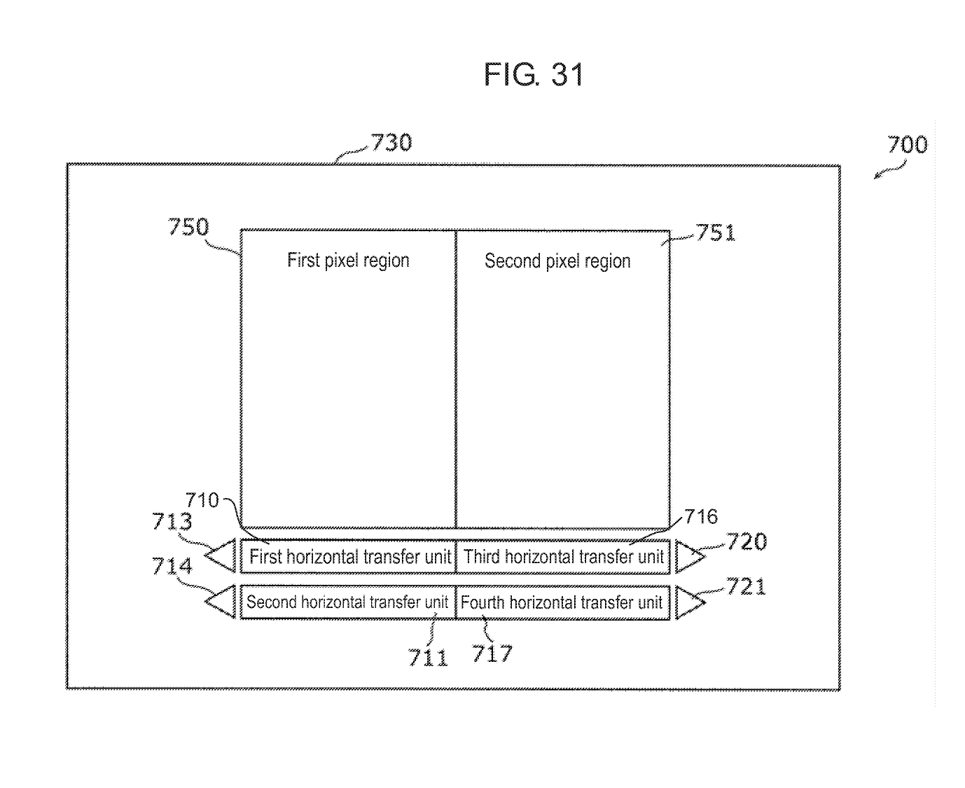

FIG. 31 is a schematic diagram of a solid-state imaging device according to the seventh exemplary embodiment.

Compared to solid-state imaging device 400 according to the fourth exemplary embodiment, in solid-state imaging device 700 according to the seventh exemplary embodiment, a pixel region is divided into first pixel region 750 and second pixel region 751, and due to it, third horizontal transfer unit 716, fourth horizontal transfer unit 717, third charge detector 720, and fourth charge detector 721 are added. However, solid-state imaging device 700 is the same as solid-state imaging device 400 according to the fourth exemplary embodiment in that solid-state imaging device 700 is aimed at providing a configuration and a driving method that allow a plurality of signal charges read from one photoelectric converter to be output from the same charge detector. Hereinafter, differences from the fourth exemplary embodiment will be mainly described, and the same points will not be described.

Solid-state imaging device 700 shown in FIG. 31 includes, for first pixel region 750, first horizontal transfer unit 710, second horizontal transfer unit 711, first charge detector 713, and second charge detector 714. Solid-state imaging device 700 also includes, for second pixel region 751, third horizontal transfer unit 716, fourth horizontal transfer unit 717, third charge detector 720, and fourth charge detector 721.

A configuration of a portion corresponding to first pixel region 750 is the same as the configuration of solid-state imaging device 400 shown in FIG. 22, and a configuration of a portion corresponding to second pixel region 751 is horizontally symmetrical to the configuration of solid-state imaging device 400 shown in FIG. 22.

An operation of solid-state imaging device 700 according to the seventh exemplary embodiment uses the second TOF method or the third TOF method. An operation of the portion corresponding to first pixel region 750 in a signal readout period is the same as the operation in FIGS. 23A to 23D, and an operation of the portion corresponding to first pixel region 750 in one cycle of a horizontal scanning period is the same as the operation in FIGS. 24A to 24D. An operation of the portion corresponding to second pixel region 751 is the same as the operation of the portion corresponding to first pixel region 750.

As above, solid-state imaging device 700 according to the seventh exemplary embodiment allows a plurality of signal charges read from one photoelectric converter 701 to be output from the same charge detector (first charge detector 713, second charge detector 714, third charge detector 720, and fourth charge detector 721) even when the pixel region is divided, and four horizontal transfer units and four charge detectors in total are provided. With this, solid-state imaging device 700 can further increase a frame rate of a distance measurement camera without degrading ranging precision since signal transfer time is reduced, compared to solid-state imaging device 400 according to the fourth exemplary embodiment.

### Eighth Exemplary Embodiment

Next, an eighth exemplary embodiment will be described.

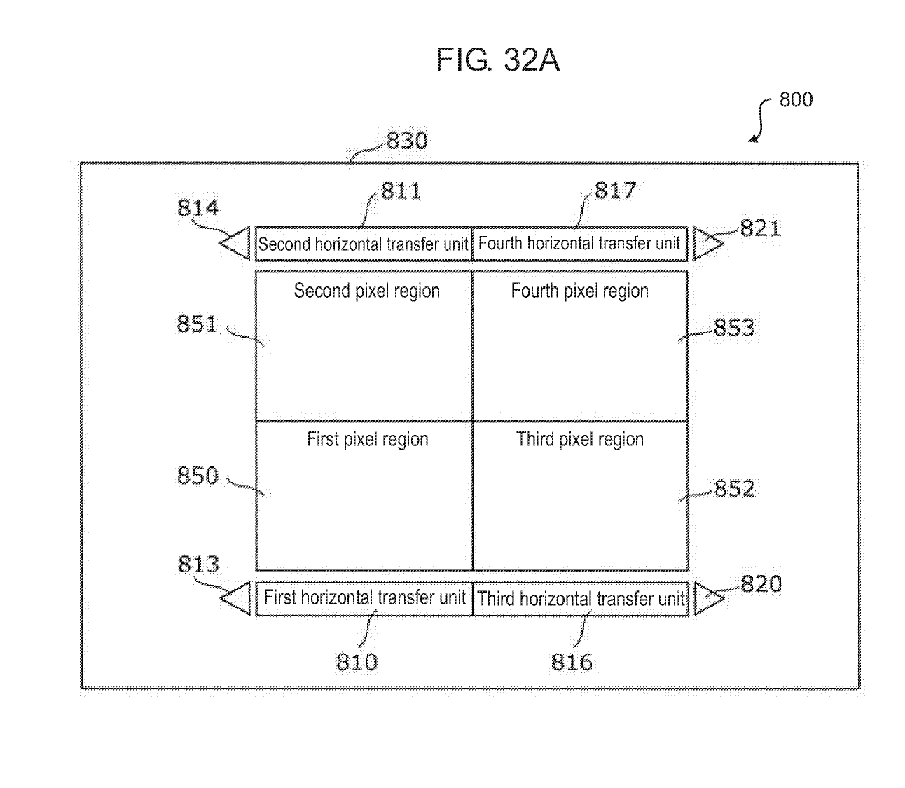

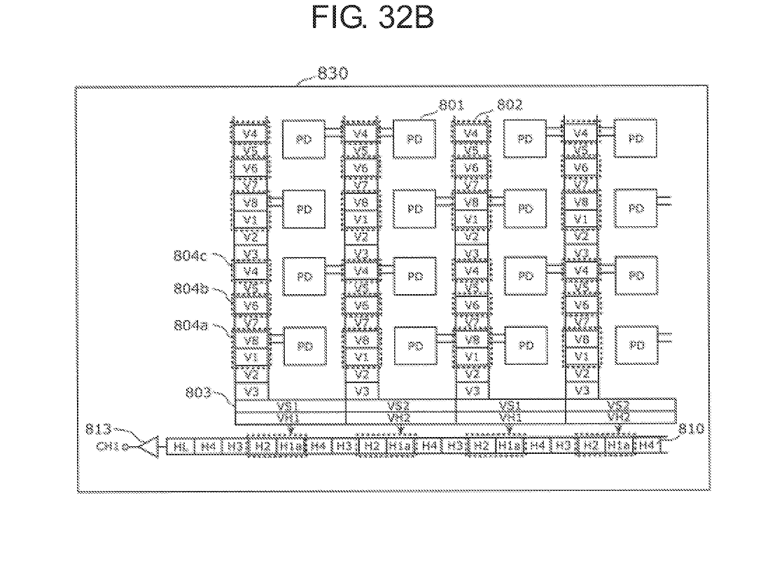

FIG. 32A is a plan view showing a configuration of a solid-state imaging device according to the eighth exemplary embodiment. FIG. 32B is a diagram showing a part of the configuration of the solid-state imaging device according to the eighth exemplary embodiment. In FIG. 32B, only components of four pixels in a vertical direction and of four pixels in a horizontal direction are shown for simplification.

Compared to solid-state imaging device 700 according to the seventh exemplary embodiment, in solid-state imaging device 800 according to the eighth exemplary embodiment, a pixel region is divided into first pixel region 850, second pixel region 851, third pixel region 852, and fourth pixel region 853. Solid-state imaging device 800 omits inter-horizontal transfer units, and due to it, is different in a driving method in a readout period and in a horizontal scanning period. However, solid-state imaging device 800 is the same as solid-state imaging device 400 according to the fourth exemplary embodiment in that solid-state imaging device 800 is aimed at providing a configuration and a driving method that allow a plurality of signal charges read from one photoelectric converter 801 to be output from the same charge detector. Hereinafter, differences from the seventh exemplary embodiment will be mainly described, and the same points will not be described.

Solid-state imaging device 800 shown in FIG. 32B omits second horizontal transfer unit 411 and inter-horizontal transfer unit 412, compared to solid-state imaging device 400 in FIG. 22. A configuration of a portion corresponding to first pixel region 850 is the same as the configuration in FIG. 22, a configuration of a portion corresponding to second pixel region 851 is horizontally symmetrical to the configuration in FIG. 22, a configuration of a portion corresponding to third pixel region 852 is vertically symmetrical to the configuration in FIG. 22, and a configuration of a portion corresponding to fourth pixel region 853 is vertically symmetrical to the configuration of the portion corresponding to second pixel region 851. Therefore, the operation of the portion corresponding to first pixel region 850 will be described below. Operations of the portions corresponding to second pixel region 851, third pixel region 852, and fourth pixel region 853 are the same as the operation of the portion corresponding to first pixel region 850.

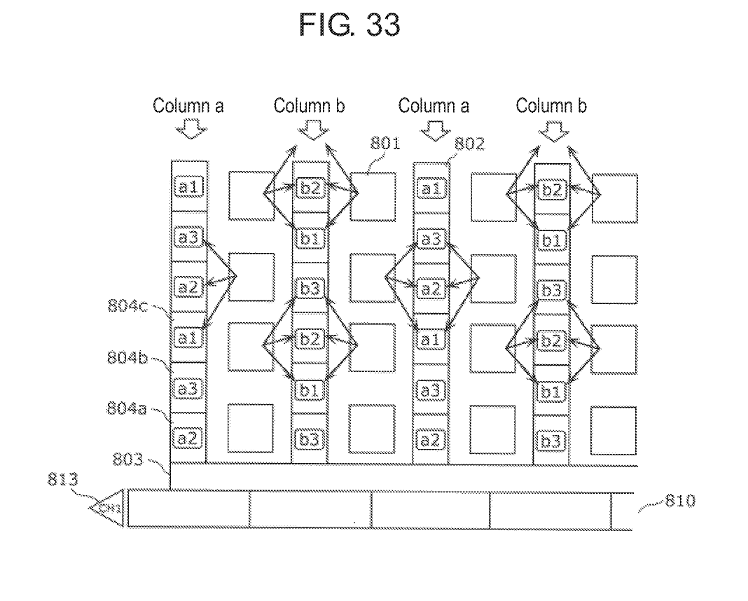

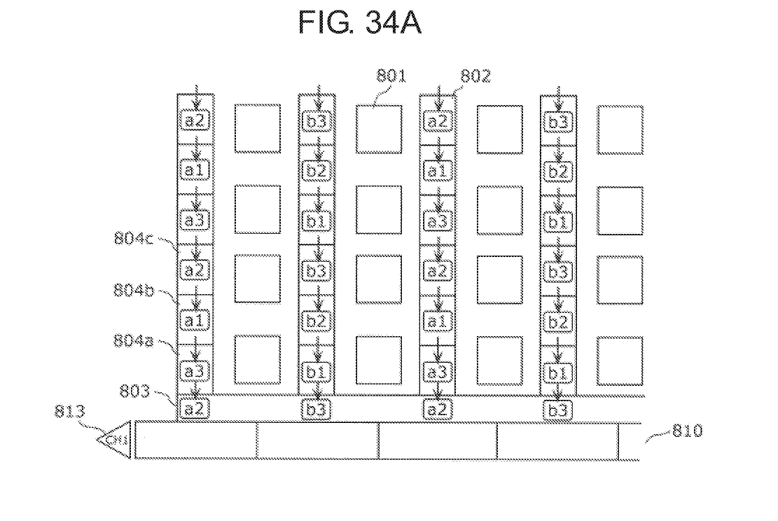

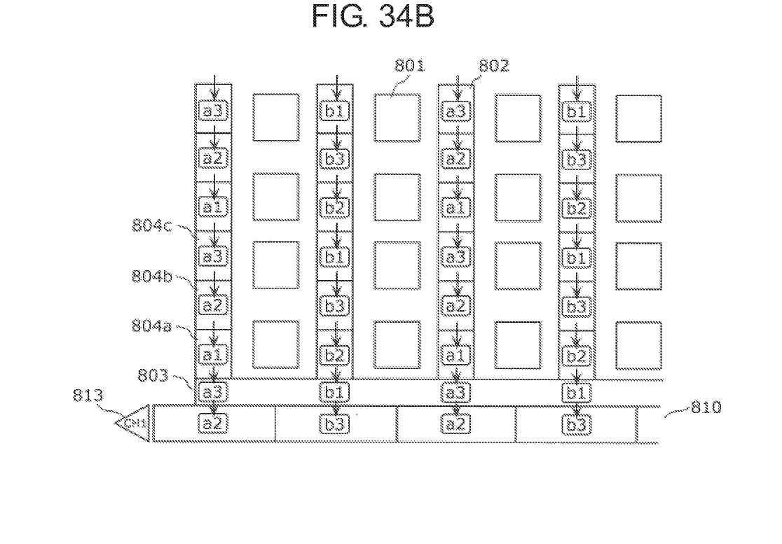

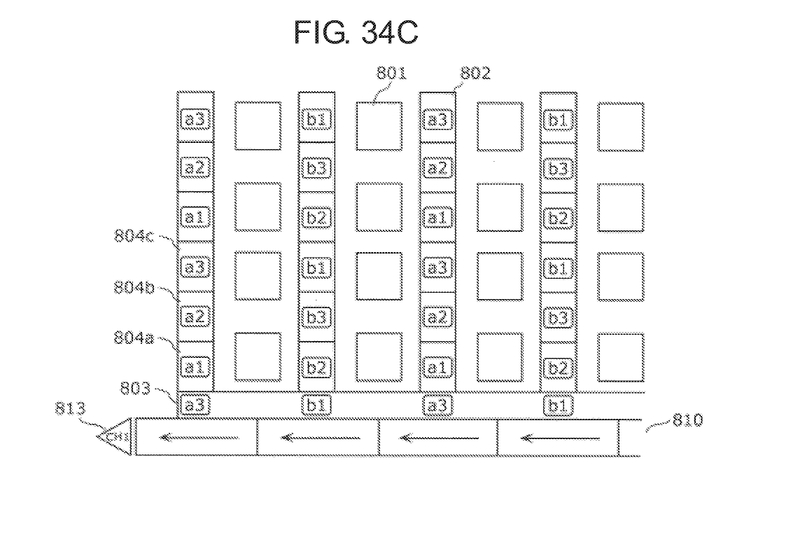

FIG. 33 and FIGS. 34A to 34C are diagrams showing an operation of solid-state imaging device 800 in FIG. 32B, which uses the second TOF method or the third TOF method. FIG. 33 shows an operation of solid-state imaging device in a signal readout period, and FIGS. 34A to 34C show an operation of solid-state imaging device 800 in one cycle of a horizontal scanning period.

First, as shown in FIG. 33, signal charges are read checkerwise from photoelectric converters 801 into packets 804a, 804b, 804c, and stored with the signal charges of horizontally adjacent two pixels added, to complete the readout period. Here, in the figure, a1, a2, a3 are signal charges stored in vertical transfer units 802 in rows a, and b1, b2, b3 are signal charges stored in vertical transfer units 802 in rows b.

In a horizontal transfer period, first, as shown in FIG. 34A, all signal charges stored in vertical transfer units 802 are transferred one stage in a column direction. At this time, signal charges stored in packets in vertical transfer units 802 adjacent to charge controller 803 are transferred from vertical transfer units 802 to charge controller 803.

Next, as shown in FIG. 34B, all the signal charges stored in charge controller 803 are transferred to first horizontal transfer unit 810. Thereafter, all signal charges stored in vertical transfer units 802 are transferred one stage in the column direction. At this time, signal charges stored in packets in vertical transfer units 802 adjacent to charge controller 803 are transferred from vertical transfer units 802 to charge controller 803.

Next, as shown in FIG. 34C, the signal charges stored in first horizontal transfer unit 810 are sequentially transferred to first charge detector 813.

Here, when attention is paid to signal charges a1 to a3, as shown in FIG. 34B, signal charges a1 are output from first charge detector 813. Likewise, signal charges a2, a3 output from a subsequent horizontal scanning period are all output from first charge detector 813. In solid-state imaging device 800 according to this exemplary embodiment including a horizontal transfer unit (first horizontal transfer unit 810) that includes one packet 815 for each vertical transfer unit 802, three signal charges read from one photoelectric converter 801 are output separately in three horizontal scanning periods without being added horizontally. That is, a horizontal transfer unit (first horizontal transfer unit 810 or second horizontal transfer unit 811) including (1/K) packet for each vertical transfer unit 802 is provided, and an inter-horizontal transfer unit is not provided ((L−1)=0), and M signal charges read from one photoelectric converter 801 are horizontally added in Ns, and are output separately in [(K·M)/(L·N)] horizontal scanning periods. When there is no horizontal addition of signal charges, N=1.

Signal charges output from solid-state imaging device 800 are converted into a image for measuring a distance by signal processor 207 (see FIG. 12), and may also be converted into a visible image depending on a use.

Operations of the portions corresponding to second pixel region 851, third pixel region 852, and fourth pixel region 853 are the same as the operation of the portion corresponding to first pixel region 850.

As above, solid-state imaging device 800 according to the eighth exemplary embodiment allows a plurality of signal charges read from one photoelectric converter 801 to be output from the same charge detector even when a pixel region is divided, and four horizontal transfer units and four charge detectors are provided. With this, solid-state imaging device 800 can further increase a frame rate of a distance measurement camera without degrading ranging precision since the horizontal scanning period is reduced, compared to solid-state imaging device 400 according to the fourth exemplary embodiment.

### Ninth Exemplary Embodiment

Next, a ninth exemplary embodiment will be described.

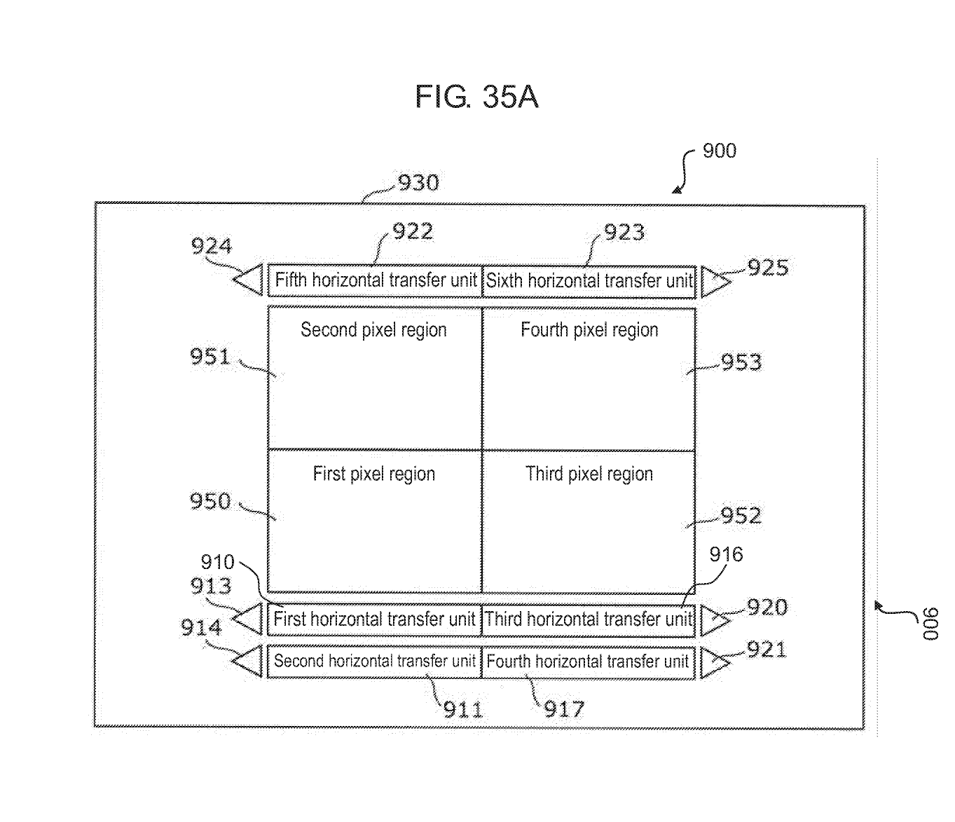

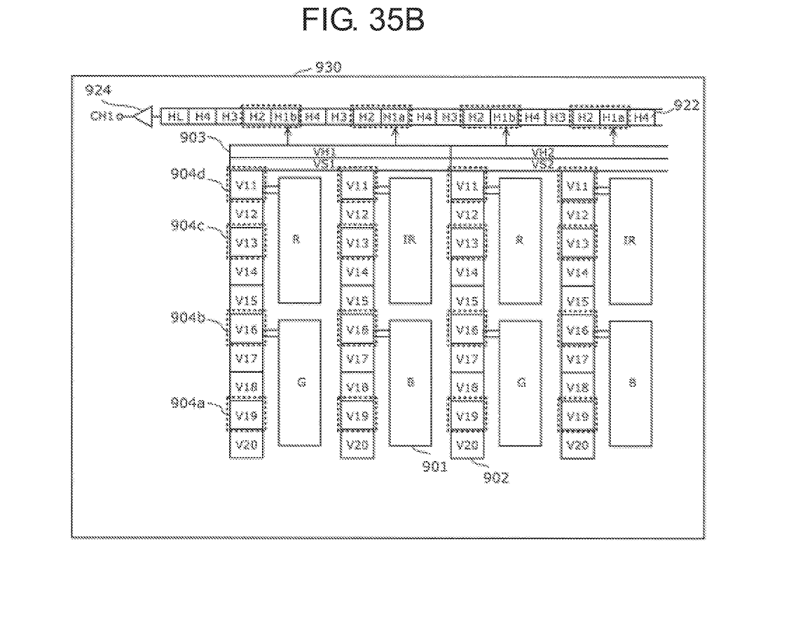

FIGS. 35A and 15B are schematic diagrams of a solid-state imaging device according to the ninth exemplary embodiment.

Compared to solid-state imaging device 300 according to the third exemplary embodiment, in solid-state imaging device 900 according to the ninth exemplary embodiment, a pixel region is divided into first pixel region 950, second pixel region 951, third pixel region 952, and fourth pixel region 953. Compared to solid-state imaging device 300, in solid-state imaging device 900, third horizontal transfer unit 916, fourth horizontal transfer unit 917, fifth horizontal transfer unit 922, sixth horizontal transfer unit 923, third charge detector 920, fourth charge detector 921, fifth charge detector 924, and sixth charge detector 925 are added. However, solid-state imaging device 900 is the same as solid-state imaging device 300 according to the third exemplary embodiment in that solid-state imaging device 900 is aimed at providing a configuration and a driving method that allow a plurality of signal charges read from one photoelectric converter to be output from the same charge detector. Hereinafter, differences from the third exemplary embodiment will be mainly described, and the same points will not be described.

Solid-state imaging device 900 shown in FIG. 35A includes, for first pixel region 950, first horizontal transfer unit 910, second horizontal transfer unit 911, first charge detector 913, and second charge detector 914.

Solid-state imaging device 900 also includes, for third pixel region 952, third horizontal transfer unit 916, fourth horizontal transfer unit 917, third charge detector 920, and fourth charge detector 921. Solid-state imaging device 900 also includes, for second pixel region 951, fifth horizontal transfer unit 922 and fifth charge detector 924, and includes, for fourth pixel region 953, sixth horizontal transfer unit 923 and sixth charge detector 925.

A configuration of a portion corresponding to first pixel region 950 is the same as the configuration in FIG. 19, a configuration of a portion corresponding to third pixel region 952 is horizontally symmetrical to the configuration in FIG. 19, a configuration of a portion corresponding to second pixel region 951 is as shown in FIG. 35B, and a configuration of a portion corresponding to fourth pixel region 953 is horizontally symmetrical to the configuration in FIG. 35B. An operation of the portion corresponding to second pixel region 951 is the same as the operation of the portion corresponding to first pixel region shown in FIG. 32A.

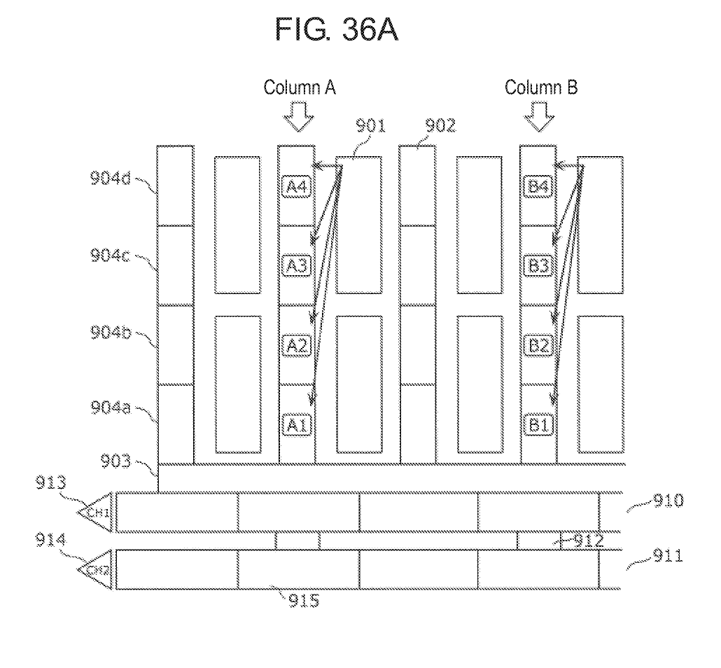

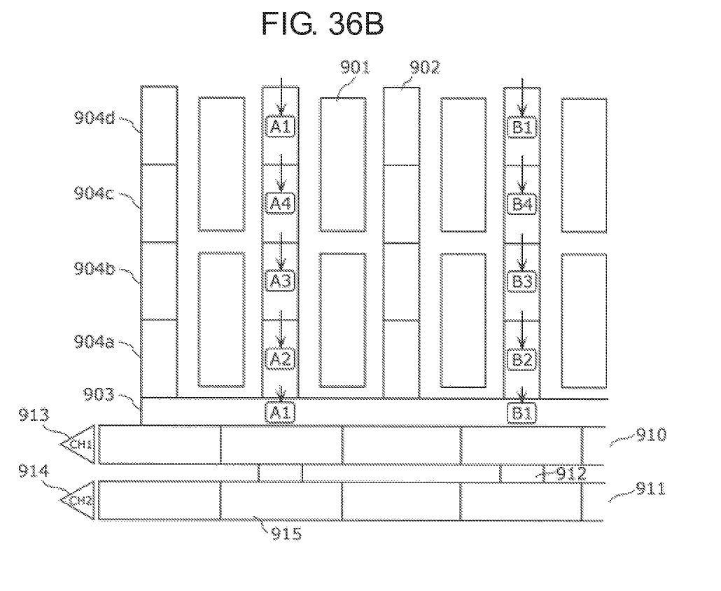

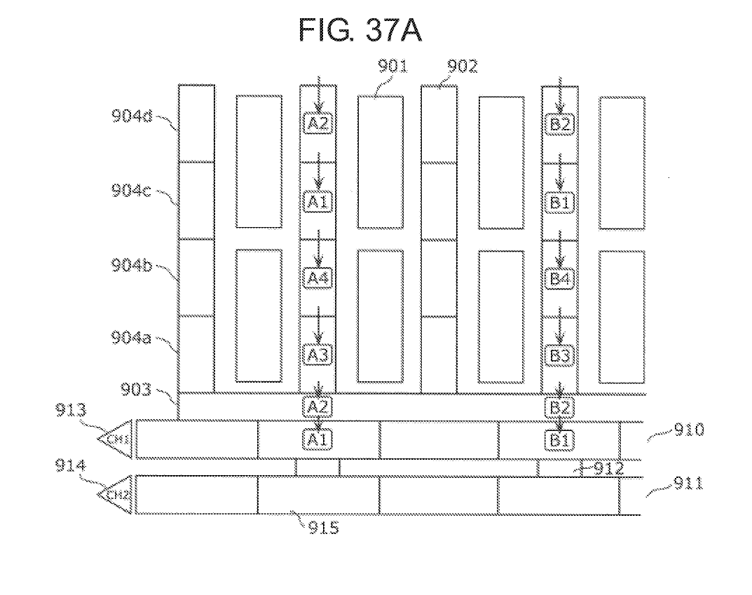

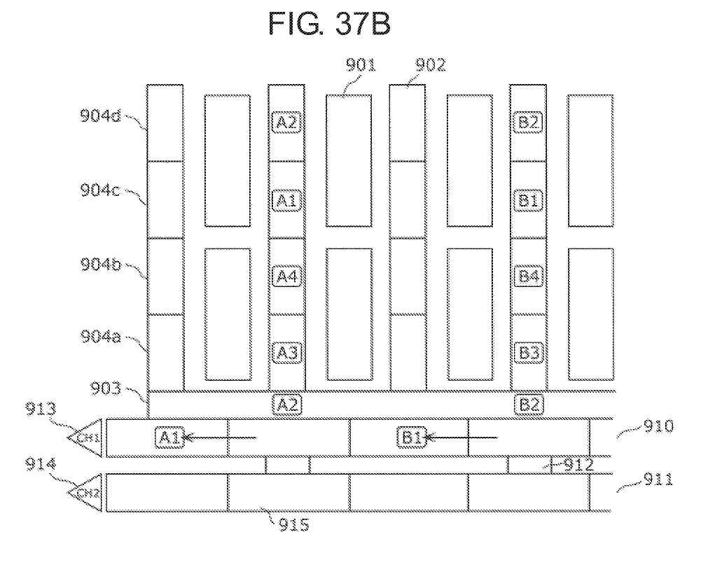

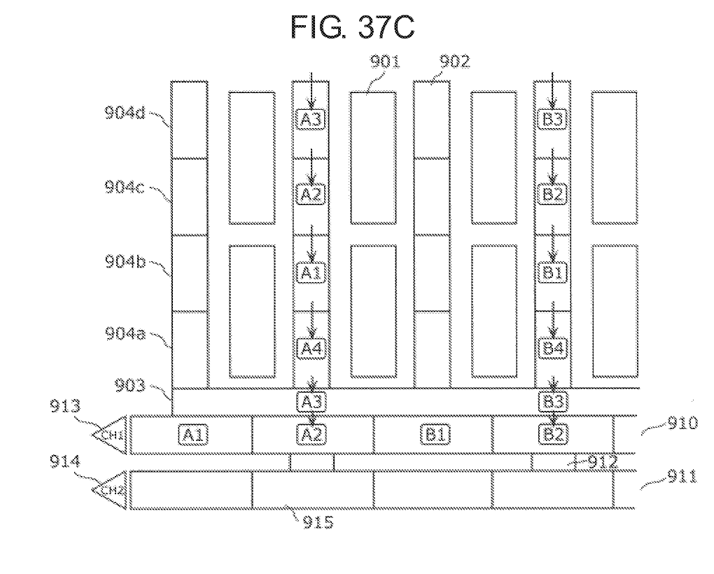

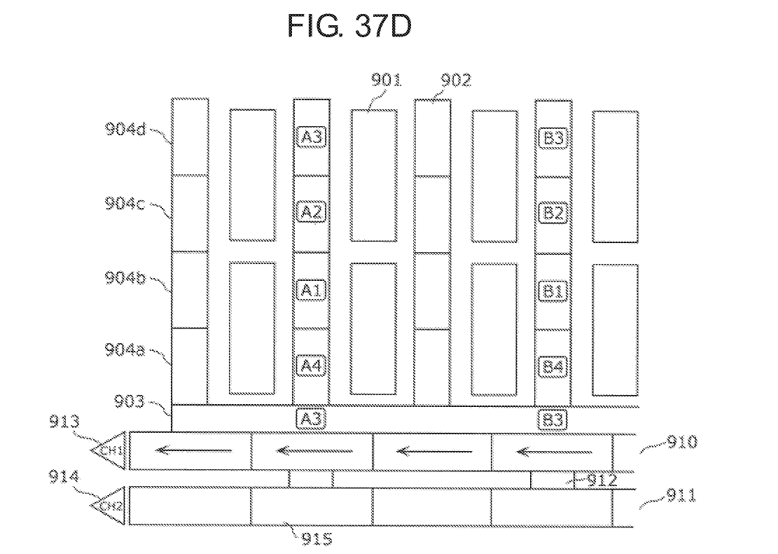

FIGS. 36A and 36B and FIGS. 37A to 37D are diagrams showing an operation of solid-state imaging device 900 in FIG. 35A in a first frame scanning period to acquire a image for measuring a distance, in which the first TOF method is used. FIGS. 36A and 36B show an operation of the portion corresponding to first pixel region 950 in a signal readout period, and FIGS. 37A to 37D show an operation of the portion corresponding to first pixel region 950 in one cycle of a horizontal scanning period.

In the readout period, first, as shown in FIG. 36A, signal charges are read only from one photoelectric converter 901 of a 2×2 pixel array into packets 904a, 904b, 904c, 904d, and stored. Here, in the figure, A1, A2, A3, A4 are signal charges stored in vertical transfer unit 902 in row A, and B1, B2, B3, B4 are signal charges stored in vertical transfer unit 902 in row B.

Thereafter, as shown in FIG. 36B, all signal charges stored in vertical transfer units 902 are transferred one stage in a column direction. At this time, signal charges A1 and B1 stored in packets in vertical transfer units 902 adjacent to charge controller 903 are transferred from vertical transfer units 902 to charge controller 903, to complete the readout period.

In a horizontal transfer period, first, as shown in FIG. 37A, all the signal charges stored in charge controller 903 are transferred to first horizontal transfer unit 910. Thereafter, all signal charges stored in vertical transfer units 902 are transferred one stage in the column direction. At this time, signal charges stored in packets in vertical transfer units 902 adjacent to charge controller 903 are transferred from vertical transfer units 902 to charge controller 903.

Next, as shown in FIG. 37B, all the signal charges stored in first horizontal transfer unit 910 are transferred one stage in a row direction.

Next, as shown in FIG. 37C, all the signal charges stored in charge controller 903 are transferred to first horizontal transfer unit 910. Thereafter, all signal charges stored in vertical transfer units 902 are transferred one stage in the column direction. At this time, signal charges stored in packets in vertical transfer units 902 adjacent to charge controller 903 are transferred from vertical transfer units 902 to charge controller 903.

Thereafter, as shown in FIG. 37D, the signal charges stored in first horizontal transfer unit 910 are sequentially transferred to first charge detector 913.

Here, when attention is paid to signal charges A1 to A4, as shown in FIG. 37C, signal charges A1, A2 are output from first charge detector 913 together. Likewise, signal charges A3, A4 output sequentially from a subsequent horizontal scanning period are output from first charge detector 913. In solid-state imaging device 900 according to this exemplary embodiment including horizontal transfer units (first horizontal transfer unit 910 and second horizontal transfer unit 911) each including one packet 915 for one vertical transfer unit 902, four signal charges read from one photoelectric converter 901 are output separately in two horizontal scanning periods without being added horizontally. That is, horizontal transfer units (first horizontal transfer unit 910 and second horizontal transfer unit 911, or third horizontal transfer unit 916, fourth horizontal transfer unit 917, and fifth horizontal transfer unit 922) including (1/K) packet for one vertical transfer unit 902, and (L−1) inter-horizontal transfer unit 912 are provided, and M signal charges read from one photoelectric converter 901 are horizontally added in Ns, and are output separately in [(K·M)/(2·L·N)] horizontal scanning periods. When there is no horizontal addition of signal charges, N=1.

An operation of the portion corresponding to third pixel region is the same as the operation of the portion corresponding to first pixel region 950.

When the first frame scanning period is completed, a second frame scanning period is started. In the second frame scanning period, as in FIGS. 21L to 21Q, signal outputs are read from all photoelectric converters 901, and a visible image is acquired.

Signal charges output from solid-state imaging device 900 are converted into a image for measuring a distance and a visible image separately by signal processor 207 (see FIG. 12).

As above, solid-state imaging device 900 according to the ninth exemplary embodiment allows a plurality of signal charges read from one photoelectric converter 901 to be output from the same charge detector in one frame scanning period even when signal charges are read only from one photoelectric converter 901 of a 2×2 pixel array, and horizontal transfer units and charge detectors through which the signal charges pass are different between when a image for measuring a distance is generated and when a visible image is generated. This can further increase a frame rate of a distance measurement camera without degrading ranging precision because the horizontal scanning period is reduced. Further, when a visible image is generated, by outputting signal charges from horizontal transfer units and charge detectors provided in parallel without dividing the pixel region, a frame rate can be increased while high image quality is maintained.

The above-described exemplary embodiments are an example, and the present disclosure is not limited to the above-described exemplary embodiments.

For example, a number of horizontal transfer units is not limited to the above-described examples, and may be changed as appropriate.

A number of signal charges for which horizontal mixing is performed is not limited to the above-described example, and may be changed as appropriate.

A positional relationship between a pixel region and a horizontal transfer unit is not limited to the above-described examples, and may be changed as appropriate.

Numbers of packets provided in a vertical transfer unit and in a horizontal transfer unit are not limited to the above-described examples, and may be changed as appropriate.

Although the imaging apparatus has been described above based on the exemplary embodiments, the present disclosure is not limited to these exemplary embodiments. The scope of the present disclosure includes the exemplary embodiments to which various modifications that those skilled in the art can conceive are applied, and includes embodiments obtained by combining components in different exemplary embodiments, as long as they do not depart from the gist of the present disclosure.

The imaging apparatus according to the present disclosure can increase a frame rate without degrading ranging precision, and thus is useful as an imaging apparatus to precisely acquire a image for measuring a distance of a subject moving at high speed. For example, the imaging apparatus according to the present disclosure is useful as an imaging apparatus having an application of a distance measurement camera such as segmentation of a specific subject (background separation) or creation of 3D avatars.

What is claimed is:

1. A solid-state imaging device for use in an imaging apparatus that comprises a near-infrared light source for emitting near-infrared light to a subject, and the solid-state imaging device for receiving incident light from the subject, the solid-state imaging device comprising:
a photoelectric conversion region in which a plurality of photoelectric converters is arranged in a matrix;
a plurality of vertical transfer units for transferring signal charges generated in each of the plurality of photoelectric converters, in a direction perpendicular to a row direction of the photoelectric conversion region;
a plurality of horizontal transfer units for transferring the signal charges in a direction horizontal to the row direction of the photoelectric conversion region; and
a plurality of charge detectors for amplifying and outputting the signal charges,
wherein, in one frame scanning period, a plurality of signal charges generated in one of the plurality of photoelectric converters is output from one and the same one of the plurality of charge detectors.

2. The solid-state imaging device according to claim 1 further comprising an inter-horizontal transfer unit for transferring signal charges from one horizontal transfer unit of the plurality of horizontal transfer units to another horizontal transfer unit,
wherein the plurality of horizontal transfer units are disposed in parallel with the inter-horizontal transfer unit interposed therebetween.

3. The solid-state imaging device according to claim 1, wherein the plurality of horizontal transfer units is disposed for each of divided regions of the photoelectric conversion region.

4. The solid-state imaging device according to claim 1, wherein signal charges output in a predetermined period from the plurality of charge detectors are signal charges having undergone exposure in one and the same period.

5. The solid-state imaging device according to claim 1, wherein signal charges having undergone the exposure in one and the same period are stored in the plurality of vertical transfer units horizontally adjacent to each other are horizontally added in a predetermined number of additions.

6. The solid-state imaging device according to claim 1, wherein
the plurality of photoelectric converters includes a plurality of photoelectric converters for receiving visible light and a plurality of photoelectric converters for receiving near-infrared light,
in a first frame scanning period, a image for measuring a distance is generated from a plurality of signal charges generated from the plurality of photoelectric converters that receives near-infrared light, and
in a second frame scanning period, a visible image is generated from a plurality of signal charges generated from the plurality of photoelectric converters that receives visible light.

7. The solid-state imaging device according to claim 6, wherein
in the first frame scanning period, the signal charges are output from one of the horizontal transfer units disposed for each of divided regions of the photoelectric conversion region, and
in the second frame scanning period, the signal charges are output from the plurality of horizontal transfer units disposed in parallel with the inter-horizontal transfer unit interposed therebetween.

8. An imaging apparatus comprising:
a near-infrared light source for irradiating a subject with near-infrared light; and
a solid-state imaging device for receiving incident light from the subject,
wherein the solid-state imaging device comprises:
a photoelectric conversion region in which a plurality of photoelectric converters is arranged in a matrix;
a plurality of vertical transfer units for transferring signal charges generated in each of the plurality of photoelectric converters, in a direction perpendicular to a row direction of the photoelectric conversion region;
a plurality of horizontal transfer units for transferring the signal charges in a direction horizontal to the row direction of the photoelectric conversion region; and
a plurality of charge detectors for amplifying and outputting the signal charges,
wherein, in one frame scanning period, a plurality of signal charges generated in one of the plurality of photoelectric converters is output from one and the same one of the plurality of charge detectors.

9. The imaging apparatus according to claim 8, wherein
the plurality of photoelectric converters includes a plurality of photoelectric converters for receiving visible light and a plurality of photoelectric converters for receiving near-infrared light,
in a first frame scanning period, a image for measuring a distance is generated from a plurality of signal charges generated from the plurality of photoelectric converters that receives near-infrared light, and
in a second frame scanning period, a visible image is generated from a plurality of signal charges generated from the plurality of photoelectric converters that receives visible light.

10. The imaging apparatus according to claim 9, wherein
in the first frame scanning period, the signal charges are output from one of the horizontal transfer units disposed for each of divided regions of the photoelectric conversion region, and
in the second frame scanning period, the signal charges are output from the plurality of horizontal transfer units disposed in parallel with the inter-horizontal transfer unit interposed therebetween.

11. A method for driving the imaging apparatus according to claim 8 in which the solid-state imaging device comprises horizontal transfer units including (1/K) packet for each of the vertical transfer units, and (L−1) inter-horizontal transfer unit or units, the method comprising horizontally adding M pieces of signal charges read from one of the photoelectric converters in N pieces, and outputting the signal charges separately in [(K·M)/(L·N)] horizontal scanning period or periods.

12. A method for driving, in the first frame scanning period, the imaging apparatus according to claim 9 in which the solid-state imaging device comprises horizontal transfer units including (1/K) packet for each of the vertical transfer units, and (L−1) inter-horizontal transfer unit or units, the method comprising horizontally adding M pieces of signal charges read from one of the photoelectric converters in N pieces, and outputting the signal charges separately in [(K·M)/(2·L·N)] horizontal scanning period or periods.
